(19) United States
(12) Patent Application Publication
(10) Pub. No.: US 2026/0070015 A1
(43) Pub. Date: Mar. 12, 2026

(54) SYSTEMS AND METHODS FOR PRODUCING HIGH-PURITY CARBON DIOXIDE FROM CARBON DIOXIDE-CONTAINING GAS STREAMS

(71) Applicant: EFI USA, LLC, Gaston, SC (US)

(72) Inventors: Jake Charles O’Donnell, Summerville, SC (US); Hector Jorge Cumba, Palm Bay, FL (US); Nitin Kumarlal Thakur, Thane (IN)

(21) Appl. No.: 19/323,036

(22) Filed: Sep. 9, 2025

(30) Foreign Application Priority Data
Sep. 10, 2024 (IN) 202411068367

(51) Int. Cl. B01D 53/14; B01D 1/00; B01D 3/14; B01D 46/00

(52) U.S. Cl. CPC B01D 53/14; B01D 1/00; B01D 3/14; B01D 46/0027; B01D 2256/22; B01D 2257/80; B01D 2258/0283

(57) ABSTRACT

Described systems produce high-purity carbon dioxide from a CO₂-rich gas, such as from CO₂-rich tail gas produced as a waste stream during an upgrading or conditioning stage in a renewable natural gas (RNG) biorefinery. An example method comprises H₂S filtration, compression, and cooling of the CO₂-rich tail gas, subsequent filtration of oil, water, VOCs, and other sulfur-comprising compounds from the CO₂-rich tail gas, and subsequent drying and compression of the CO₂-rich tail gas. The CO₂-rich tail gas is then condensed and a portion of CH₄ is separated from the CO₂-rich tail gas via flash separation and column distillation. The CO₂-rich tail gas is then communicated into a reboiler to further separate CH₄ from the CO₂-rich tail gas. After subsequent further chilling/cooling, if the CO₂-rich tail gas has a sufficiently high CO₂ concentration, the CO₂-rich tail gas is a finished CO₂ product, such as food-grade CO₂ or beverage-grade CO₂.

### CROSS-REFERENCE TO RELATED APPLICATIONS

The present application claims the benefit of priority to Indian Provisional Patent Application No. 202411068367 filed Sep. 10, 2024 and entitled “Systems and Methods for Producing High-Purity Carbon Dioxide from a Tail Gas of a Renewable Natural Gas (RNG) Biorefinery,” the entire disclosure of which is hereby incorporated herein by reference in its entirety for all purposes.

### TECHNICAL FIELD

The present disclosure relates, generally, to systems and methods for extracting and purifying carbon dioxide from a carbon-dioxide-containing stream or flow, and more specifically to systems and methods for high-purity carbon dioxide extraction from a carbon dioxide-containing gas stream, such as a tail gas waste stream.

### BACKGROUND

This section provides background information related to the present disclosure which is not necessarily prior art.

Biogas is a renewable gas often generated from anaerobic digestion processes based upon the anoxic digestion of organic material. It has been estimated that renewable gas from waste biomass including agricultural waste has the potential to add up to 2.5 quadrillion BTU annually, which is estimated to be enough to meet the natural gas needs of about 50% of homes in the United States or up to about 10% of all natural gas used in the United States. Biorefining (the process of biogas production from organic materials/biosolids) of biosolids removed from wastewater in the United States could produce enough biogas to potentially meet up to about 12% of the national electricity demand in the United States.

Biogas production entails the biological or thermochemical transformation of organic material to form raw biogas, which is then upgraded or conditioned to increase the concentration of methane (CH₄) in the biogas to sufficiently high levels (e.g., greater than about 85%-90%) such that the conditioned/upgraded biogas can be added directly to conventional natural gas pipelines, used in conventional natural gas-burning vehicles/equipment, and/or the like. Biogas production can be or comprise anerobic digestion, collected as a byproduct gas from landfills and wastewater treatment, a Sabatier reaction process, thermal gasification, and/or the like.

As part of biogas refining, e.g., during conditioning or upgrading of the raw biogas to increase the concentration of CH₄ and higher alkanes (e.g., ethane, propane, butanes, etc.) in the biogas and reduce or remove contaminants and inert/non-combustible materials and gases from the biogas, a tail gas is generated. However, biogas conditioning/upgrading processes are not 100% efficient in terms of separating all the CH₄ from the raw biogas and/or in terms of removing all inert materials or contaminants from the raw biogas. Instead, tail gas from biogas conditioning/upgrading processes typically comprises some amount of CH₄, as well as inert gases such as carbon dioxide (CO₂), and other materials, contaminants, or waste products extracted from the raw biogas during conditioning/upgrading, such as volatile organic carbons (VOCs), siloxanes, hydrogen sulfide (H₂S), carbonyl sulfide (COS), and/or the like.

### BRIEF SUMMARY

This section provides a general summary of the disclosure and is not a comprehensive disclosure of its full scope or all of its features.

In general, embodiments of the present disclosure provided herein may relate to systems, methods, and apparatuses for extracting CO₂ from tail gas of a biogas generation facility or renewable natural gas (RNG) biorefinery or purifying a CO₂-rich tail gas from a biogas generation facility or RNG biorefinery. Other implementations for content extraction will be, or will become, apparent to one with skill in the art upon examination of the following figures and detailed description. It is intended that all such additional implementations be included within this description, considered to be within the scope of the present disclosure, and be protected by the following claims and any such claims that are supported by the present disclosure.

It should be appreciated that all combinations of the concepts discussed herein and as follows in greater detail (provided such concepts are not mutually inconsistent) are contemplated as being part of the inventive subject matter disclosed herein. In particular, the combinations of claimed subject matter appearing at the end of this disclosure are contemplated as being part of the inventive subject matter disclosed herein. It should be appreciated that terminology explicitly employed herein that also may appear in any disclosure incorporated by reference should be accorded a meaning consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

Reference will now be made to the accompanying drawings, which are not necessarily drawn to scale, and wherein:

FIG. 1 illustrates a block flow diagram of a process for CO₂ purification and separation from a CO₂-containing gas, in accordance with some of the embodiments disclosed herein;

FIG. 2 illustrates a block flow diagram of a process for CO₂ purification and separation from a CO₂-containing gas, in accordance with some of the embodiments disclosed herein;

FIG. 3 illustrates a block flow diagram of a process for CO₂ purification and separation from a CO₂-containing gas, in accordance with some of the embodiments disclosed herein;

FIG. 4 illustrates a block flow diagram of a process for CO₂ purification and separation from a CO₂-containing gas, in accordance with some of the embodiments disclosed herein;

FIG. 5 illustrates a block flow diagram of a process for CO₂ purification and separation from a CO₂-containing gas, in accordance with some of the embodiments disclosed herein;

FIG. 6 illustrates a block flow diagram of a process for CO₂ purification and separation from a CO₂-containing gas, in accordance with some of the embodiments disclosed herein;

FIG. 7 illustrates a block flow diagram of a process for CO₂ purification and separation from a CO₂-containing gas, in accordance with some of the embodiments disclosed herein;

FIG. 8 illustrates a block flow diagram of a process for CO₂ purification and separation from a CO₂-containing gas, in accordance with some of the embodiments disclosed herein;

FIG. 9 illustrates a piping and instrumentation (P&ID) diagram of a portion of a process for CO₂ purification and separation from a CO₂-containing gas, in accordance with some of the embodiments disclosed herein;

FIG. 10 illustrates a P&ID diagram of a portion of a process for CO₂ purification and separation from a CO₂-containing gas, in accordance with some of the embodiments disclosed herein;

FIG. 11 illustrates a P&ID diagram of a portion of a process for CO₂ purification and separation from a CO₂-containing gas, in accordance with some of the embodiments disclosed herein;

FIG. 12 illustrates a P&ID diagram of a portion of a process for CO₂ purification and separation from a CO₂-containing gas, in accordance with some of the embodiments disclosed herein;

FIG. 13 illustrates a P&ID diagram of a portion of a process for CO₂ purification and separation from a CO₂-containing gas, in accordance with some of the embodiments disclosed herein;

FIG. 14 illustrates a P&ID diagram of a portion of a process for CO₂ purification and separation from a CO₂-containing gas, in accordance with some of the embodiments disclosed herein;

FIG. 15 illustrates a P&ID diagram of a portion of a process for CO₂ purification and separation from a CO₂-containing gas, in accordance with some of the embodiments disclosed herein;

FIG. 16 illustrates a P&ID diagram of a portion of a process for CO₂ purification and separation from a CO₂-containing gas, in accordance with some of the embodiments disclosed herein;

FIG. 17 illustrates a P&ID diagram of a portion of a process for CO₂ purification and separation from a CO₂-containing gas, in accordance with some of the embodiments disclosed herein;

FIG. 18 illustrates a P&ID diagram of a portion of a process for CO₂ purification and separation from a CO₂-containing gas, in accordance with some of the embodiments disclosed herein;

FIG. 19 illustrates a P&ID diagram of a portion of a process for CO₂ purification and separation from a CO₂-containing gas, in accordance with some of the embodiments disclosed herein;

FIG. 20 illustrates a P&ID diagram of a portion of a process for CO₂ purification and separation from a CO₂-containing gas, in accordance with some of the embodiments disclosed herein;

FIG. 21 illustrates a process flow diagram of a process for CO₂ purification and separation from a CO₂-containing gas, in accordance with some of the embodiments disclosed herein;

FIG. 22 illustrates a P&ID diagram of a process for CO₂ purification and separation from a CO₂-containing gas, in accordance with some of the embodiments disclosed herein;

FIG. 23 provides a schematic of an exemplary computing device configured to perform at least a portion of a process for CO₂ purification and separation from a CO₂-containing gas, in accordance with some of the embodiments disclosed herein;

FIG. 24 illustrates a block flow diagram of a process for CO₂ purification and separation from a CO₂-containing gas, in accordance with some of the embodiments disclosed herein;

FIG. 25 illustrates a block flow diagram of a process for CO₂ purification and separation from a CO₂-containing gas, in accordance with some of the embodiments disclosed herein;

FIG. 26 illustrates a block flow diagram of a process for CO₂ purification and separation from a CO₂-containing gas, in accordance with some of the embodiments disclosed herein; and

FIG. 27 illustrates a block flow diagram of a process for CO₂ purification and separation from a CO₂-containing gas, in accordance with some of the embodiments disclosed herein.

### DETAILED DESCRIPTION

Various embodiments of the present disclosure will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

It should be understood at the outset that although illustrative implementations of one or more aspects are illustrated below, the disclosed assemblies, systems, and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents. While values for dimensions of various elements are disclosed, the drawings may not be to scale.

The words “example,” or “exemplary,” when used herein, are intended to mean “serving as an example, instance, or illustration.” Any implementation described herein as an “example” or an “exemplary embodiment” is not necessarily preferred or advantageous over other implementations.

Example embodiments will now be described more fully with reference to the accompanying drawings. For purposes of the description hereinafter, it is to be understood that the embodiments described below may assume alternative variations and embodiments. It is also to be understood that the specific articles, compositions, and/or processes described herein are exemplary and should not be considered as limiting. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to +10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

As used herein, the term “computing device” refers to a specialized, centralized device, network, or system, comprising at least a processor and a memory device including computer program code, and configured to provide guidance or direction related to the charge transactions carried out in one or more charging networks.

The words “example,” or “exemplary,” when used herein, are intended to mean “serving as an example, instance, or illustration.” Any implementation described herein as an “example” or “exemplary” embodiment is not necessarily preferred or advantageous over other implementations.

As used herein, directional terms used to describe a component, configuration, device, sub-system, position, direction, and/or the like (e.g., “downward,” “upward,” “above,” “below,” “vertical,” “horizontal,” “axial,” “longitudinal,” and the like) are meant to be interpreted relative to a surface (e.g., slab, plant floor, floor in a trailer-mounted system, etc.) on which the system or elements/components/sub-systems thereof are mounted or supported, but the terms are not to be interpreted as requiring the system or elements/components/sub-systems thereof to be in this orientation at any particular time. For example, a system component such as a tank or heat exchanger which has a height and is normally oriented with its height perpendicular to the surface on which the component is normally mounted or supported may still be described as having a “top” or a “bottom” that are labeled and defined consistently even if the system component is oriented or reoriented in another angle or position relative to the surface on which the system component is normally mounted or supported.

As used herein, terms related to relative location, position, and/or orientation used herein to describe a component, configuration, sub-system, flow direction, component position, action, direction, and/or the like (e.g., “top,” “bottom,” “side,” “distal,” “proximal,” “longitudinal,” “lateral,” “axial,” and the like) are meant to be interpreted relative to the specific other component(s)/sub-system(s) to which the terms are used to describe the comparison or relationship between the components(s)/sub-system(s), but the terms are not to be interpreted as requiring any component(s)/sub-system(s) to be in any particular position or orientation at any particular time.

As used herein, terms related to dimensions and/or form factor for a component, configuration, action, position, direction and/or the like (e.g., “width,” “length,” “diameter,” “radius,” “circumference,” “surface area,” “thickness,” “slope,” “angle,” “distance,” “height,” and the like) are meant to be interpreted as being inclusive of (and referring to embodiments in which) a disclosed value refers to an absolute magnitude of the dimension or measurement as well as a mean magnitude of each dimension or measurement, an average magnitude of each dimension or measurement, a median magnitude of each dimension or measurement, a minimum magnitude of each dimension or measurement, and a maximum magnitude of each dimension or measurement.

As used herein, the terms “about,” “approximately,” “substantially,” “almost,” “nearly,” “circa,” “around,” “near,” “round,” “around,” “roughly,” and the like all generally mean plus or minus 10% of the value stated, e.g., about 250 μm includes all values and ranges between and including values from 225 μm to 275 μm, about 1,000 μm includes all values and ranges between and including values from 900 μm to 1,100 μm, etc. Said otherwise, all values and ranges provided herein are meant to be interpreted as being inclusive of all values and ranges that are ±10% of the disclosed value or range of values, meaning the range extends 10% on either side of the disclosed value or range of values. For example, a material thickness value of 100 μm disclosed herein is meant to include all values and ranges of material thicknesses between 90 μm and 110 μm. Similarly, a quantity of 10 items is meant to also include 9 items and 11 items. Additionally, a duration of 1,000 seconds is meant to include all duration values and ranges of duration values between 900 seconds and 1,100 seconds.

Any provided value, whether or not it is modified by terms such as “about,” “substantially,” or “approximately,” all refer to and hereby disclose associated values or ranges of values thereabout, as described above. As described above, “values” can refer to any values, integers, quantities, units, measurements, dimensions, numbers, amounts, magnitudes, sizes, degrees, sizes, extents, scales, figures, statistics, probabilities, durations, positional ordering, temporal ordering, locational arrangement, numbers of components, frequency or timing or duration of actions, directions, and/or the like.

As used herein, the use of relatively more or less significant figures (the number of digits used to express a value) is not meant to limit the scope of the disclosure with respect to a communicated or interpreted level of accuracy of the expressed value, a communicated or interpreted level of precision of the expressed value, or a communicated or interpreted level of specificity of the expressed value. For example, disclosure herein of a length value of 100 mm is meant to include additional and/or alternative disclosure(s) of length values of 100.0 mm, 100.00 mm, 100.000 mm, 100.0000 mm, 100.00000 mm, 100.000000 mm, and the like. Furthermore, disclosure herein of a duration value of 0.1 hours is meant to include additional and/or alternative disclosure(s) of duration values of 0.10 hours, 0.100 hours, 0.1000 hours, 0.10000 hours, 0.100000 hours, 0.1000000 hours, and the like. Furthermore, the use of less significant figures to express a value is not mean to limit the scope of this disclosure with regard to the values of additional digits not expressed in the disclosed value. For example, disclosure herein of a width value of 1 mm is meant to include additional and/or alternative disclosure(s) of width values of, e.g., 1.1 mm, 1.2 mm, 1.3 mm, 1.4 mm, 1.01 mm, 1.001 mm, 1.0001 mm, 1.00001 mm, 1.000001 mm, and the like.

Biogas is a renewable gas often generated from anaerobic digestion processes based upon the anoxic digestion of organic material. It has been estimated that renewable gas from waste biomass including agricultural waste has the potential to add up to 2.5 quadrillion BTU annually, which is estimated to be enough to meet the natural gas needs of about 50% of homes in the United States or up to about 10% of all natural gas used in the United States. Biorefining (the process of biogas production from organic materials/biosolids) of biosolids removed from wastewater in the United States could produce enough biogas to potentially meet up to about 12% of the national electricity demand in the United States.

Biogas production entails the biological or thermochemical transformation of organic material to form raw biogas, which is then upgraded or conditioned to increase the concentration of methane (CH₄) in the biogas to sufficiently high levels (e.g., greater than about 85%-90%) such that the conditioned/upgraded biogas can be added directly to conventional natural gas pipelines, used in conventional natural gas-burning vehicles/equipment, and/or the like. Biogas production can be or comprise anerobic digestion, collected as a byproduct gas from landfills and wastewater treatment, a Sabatier reaction process, thermal gasification, and/or the like.

As part of biogas refining, e.g., during conditioning or upgrading of the raw biogas to increase the concentration of CH₄ and higher alkanes in the biogas and reduce or remove contaminants and inert/non-combustible materials and gases from the biogas, a tail gas is generated. However, biogas conditioning/upgrading processes are not 100% efficient in terms of separating all the CH₄ from the raw biogas and/or in terms of removing all inert materials or contaminants from the raw biogas. Instead, tail gas from biogas conditioning/upgrading processes typically comprises some amount of CH₄, as well as inert gases such as carbon dioxide (CO₂), and other materials, contaminants, or waste products extracted from the raw biogas during conditioning/upgrading, such as volatile organic carbons (VOCs), siloxanes, hydrogen sulfide (H₂S), carbonyl sulfide (COS), and/or the like.

Among other considerations or technical issues being discussed herein, and for which the present disclosure includes one or more technical solutions, is the desire to recover at least some of the CH₄ from the tail gas that would otherwise be lost as a waste stream from the biorefinery following biogas conditioning or upgrading. Another desire from a biorefinery techno-economic perspective is to extract further value from the raw biogas in addition to the value of the upgraded/conditioned biogas and the value of the further recovered CH₄ from the tail gas, which can be combined back into the upgraded/conditioned biogas.

Also, while certain constituents of typical tail gas from a biogas biorefinery, such as VOCs, heavy metals, H₂S, and COS may have little or no value proposition, there are many industrial and consumer-facing uses for CO₂ that presents a value proposition associated with further purification of the CO₂-comprising tail gas or recovery of CO₂ from the tail gas.

Thus, the inventors have conceived of and diligently reduced to practice multiple embodiments of a system and method for purifying (e.g., increasing a CO₂ concentration in a CO₂-comprising tail gas) and/or recovering CO₂ from tail gas. According to some embodiments, such a process can be carried out to generate or produce high-quality CO₂, such as food-grade CO₂, beverage-grade CO₂, and/or the like.

According to these and/or other embodiments, such a process or method for producing high-quality CO₂ can be carried out using, or starting from, a feedstock that would otherwise be a waste stream, such as tail gas from a refinery or biorefinery. According to some embodiments, systems and methods described herein are provided for extracting CO₂ from a process waste stream and/or increasing the CO₂ concentration in a CO₂-containing or CO₂-based process waste stream. According to some embodiments, systems and methods described herein are provided for high-purity CO₂ extraction from a tail gas stream generated during a renewable natural gas (RNG) biorefining process and/or from an RNG biorefinery.

RNG biorefining typically involves the conversion of biogas, produced through anaerobic digestion of organic materials, into a high-purity methane gas that can be used as a substitute for fossil natural gas. The biogas upgrading or conditioning process is essential to achieve this transformation. Initially, raw biogas, which typically contains between about 45% and about 80% methane (CH₄), along with CO₂, hydrogen sulfide (H₂S), water vapor, and other trace contaminants, undergoes several purification steps. These steps typically include the removal of water, CO₂, H₂S, and volatile organic compounds (VOCs) through technologies such as membrane separation, pressure swing adsorption (PSA), and/or chemical scrubbing. The goal of RNG biorefining is typically to increase the methane content to over about 90%, preferably to over about 92%, and more preferably to over about 95%, making it suitable for pipeline injection or use as a fuel for vehicles or equipment configured to burn natural gas.

During the upgrading process, a waste stream known as “tail gas” is generated. Tail gas primarily consists of the removed CO₂, residual CH₄, H₂S, VOCs, COS, and siloxanes. The composition of tail gas can vary depending on the specific upgrading technology and the initial biogas composition. Typically, tail gas contains a significant amount of CO₂, minor amounts of CH₄ (which can be as high as 15% or higher depending on the efficiency of the upgrading process), and trace amounts of other contaminants.

In some embodiments, the “tail gas” or “biogas” can comprise one or more other components, such as contaminants. In some embodiments, the “tail gas” or “biogas” can comprise one or more of water vapor, nitrogen, ammonia, non-volatile residues, non-volatile organics, phosphines, total hydrocarbons, total non-methane hydrocarbons, methanol, acetaldehyde, volatile organic compounds, total other volatile oxygenates, aromatic hydrocarbons, cyclic aromatic hydrocarbons, polycyclic aromatic hydrocarbons, sulfur, sulfur dioxide (SO₂), hydrogen cyanide, vinyl chloride, ethylene oxide, ethane, ethylene, propane, propylene, isobutane, n-butane, butene, isopentane, n-pentane, hexanes, methyl mercaptan, ethyl mercaptan, dimethyl sulfide, carbon disulfide, t-butyl mercaptan, isopropy mercaptan, n-propyl mercaptan, methyl ethyl sulfide, 2-butyl mercaptan, i-butyl mercaptan, dietyl sulfide, n-butyl mercaptan, dimethyl disulfide, volatile sulfur compounds, dimethyl ether, diethyl ether, propionaldehyde, acetone, t-butanol, ethanol, isopropanol, ethyl acetate, methyl ethyl ketone, 2-butanol, n-propanol, isobutanol, n-butanol, isoamyl acetate, isoamyl alcohol, volatile oxygenates, other similar materials or compounds, variants thereof, or combinations thereof.

Typically, a tail gas from an RNG biorefinery is routed to destruction unit, e.g., such as a flare, a regenerative thermal oxidizer (RTO), a direct fired thermal oxidizer (DFTO), a recuperative thermal oxidizer (RTO), or a thermal combustor system (TCS), to prevent the release of methane, a potent greenhouse gas, into the atmosphere. The destruction of tail gas from RNG biorefineries currently involves oxidizing the methane and other VOCs at high temperatures and converting them into CO₂ and water vapor, thereby mitigating their environmental impact.

However, the tail gas produced from a biogas upgrading/conditioning process or biogas biorefinery may represent a valuable process flow. For example, the tail gas from such an RNG biorefinery, which typically comprises between about 70 wt. % CO₂ and about 90 wt. % CO₂, can be a reliable source of CO₂. For example, the tail gas can be used as an input for greenhouses, which require elevated CO₂ to promote growth and respiration in plants being grown therein. Alternatively, tail gas from an RNG biorefinery could be used as an input for a CO₂ sequestration processes, such as by incorporating the tail gas into concrete materials or the like, which can ‘fix’ or ‘sequester’ the CO₂ in a durable material and allow for the production/reception of associated carbon credits, which can be sold or otherwise exchanged, such as via an open carbon credit market or the like. However, higher value product(s) can be formed from the tail gas, such as food-grade CO₂ or beverage-grade CO₂, in a variety of industrial processes, and/or the like. However, the tail gas stream itself cannot be directly used as food-grade CO₂ or beverage-grade CO₂, or in one of a variety of industrial processes, due to impurities and unwanted materials in the tail gas, such as the COS, H₂S, siloxanes, heavy metals, moisture content (MC), and/or the like. As such, the tail gas must be further processed before it can be used as food-grade CO₂ or beverage-grade CO₂, or in one of a variety of different industrial processes. However, there are technical issues and concerns surrounding the direct use of tail gas and also surrounding the use of tail gas as a feedstock or input for a process of further processing the tail gas to produce high (er)-quality CO₂.

Among other concerns, depending upon the technology used for RNG biorefining, the tail gas produced as a waste stream from that RNG biorefining process can vary greatly both in terms of tail gas composition or contaminants therein and in terms of mass flow rate of the tail gas waste stream. Oftentimes, for example, when pressure swing absorption (PSA) gas separation is used for RNG biorefining, a higher concentration of contaminants such as COS, sulfur compounds, and/or siloxanes in the tail gas can make it difficult to achieve high-purity CO₂ separation from the tail gas.

The quality or purity of CO₂ used in many industrial applications may not need to be as high-quality or pure as food-grade CO₂ or beverage-grade CO₂, so the desired use, destination, or customer for the CO₂ is important to consider when evaluating which of the sub-processes, steps, equipment, and/or materials described herein are to be used. For example, food-grade CO₂ or beverage-grade CO₂ is CO₂ that will be used for, e.g., the carbonation of water or other beverages, the tapping of beer and other draft drinks, removal of air from food packaging or added as a protective atmosphere within packaging, for use in CO₂-containing fire extinguishers or fixed fire extinguishing systems, and the production of dry ice (pellets and solid CO₂ blocks), among other uses.

Food-grade and beverage-grade standards for gases are often different between different countries, regions, and standardization agencies, not to mention between different applications, uses, products, companies, and products. Nevertheless, the composition requirements for the CO₂ (e.g., food-grade CO₂ or beverage-grade CO₂) may dictate the desired composition of the final CO₂ product stream achieved from the processes/systems described herein for purifying RNG tail gas or separating high-purity or high-quality CO₂ from RNG tail gas. One example of CO₂ gas product composition requirements for food-grade CO₂ according to an example food-grade CO₂ standard is provided in Table 1.

TABLE 1
Example Composition Requirements for Food-Grade CO₂

| Component | Concentration (v/v) | |
|---|---|---|
| CO₂ | ~99.5% | |
| Moisture Content | 20 | parts-per-million (ppm) maximum |
| O₂ | 50 | ppm maximum |
| CO | 10 | ppm maximum |
| NH₄ | 5 | ppm maximum |
| NO/NO₂ | 5 | ppm maximum |
| Non-volatile Residue | 10 | ppm maximum |
| Non-volatile Organic Residue | 10 | ppm maximum |
| Phosphine | 0.3 | ppm maximum |
| Total Hydrocarbons | 50 | ppm maximum |
| Acetaldehyde | 0.5 | ppm maximum |
| Total Sulfur | 0.5 | ppm maximum |
| SO₂ | 5 | ppm maximum |

| | |
|---|---|
| Foreign Odor/Taste | None |

Example beverage-grade CO₂ gas composition requirements are provided in Table 2.

TABLE 2
Example Composition Requirements for Beverage-Grade CO₂

| Component | Concentration (v/v) | |
|---|---|---|
| CO₂ | >99.99% | |
| Moisture Content | 20 | parts-per-million (ppm) maximum |
| O₂ | 30 | ppm maximum |
| CO | 10 | ppm maximum |
| NH₄ | 2.5 | ppm maximum |
| NO/NO₂ | 2.5 | ppm maximum |
| Non-volatile Residue | 10 | ppm maximum |
| Non-volatile Organic Residue | 5 | ppm maximum |
| Phosphine | 0.3 | ppm maximum |
| Total Hydrocarbons | 50 | ppm maximum |
| Acetaldehyde | 0.2 | ppm maximum |
| Aromatic Hydrocarbons | 20 | parts-per-billion (ppb) maximum |
| Total Sulfur | 0.1 | ppm maximum |
| SO₂ | 1 | ppm maximum |

| | |
|---|---|
| Foreign Odor/Taste | None |

According to some embodiments of the method and system described herein, producing high-purity CO₂, such as food-grade CO₂ or beverage-grade CO₂, from tail gas generated in an RNG biorefinery involves several key processes and specialized equipment. The primary goal of further processing of the RNG biorefinery tail gas is to separate CO₂ from the tail gas or purify the tail gas in terms of a concentration of CO₂ in the tail gas and/or the removal of other materials or contaminants in the tail gas from the mixture of gases in the tail gas stream, which typically includes CO₂, residual CH₄, H₂S, VOCs, COS, and other trace contaminants. In some embodiments, if the tail gas comprises VOCs and/or siloxanes, the process/system can comprise temperature swing adsorption (TSA), e.g., as part of, with, alongside, or instead of, scrubbers, such as dry scrubbers. In some embodiments, the dry scrubbers used can comprise or use impregnated activated carbon to remove VOCs and/or siloxanes from the tail gas.

According to some embodiments, a process or method for producing high-purity CO₂ from RNG biorefinery tail gas comprises one or more compression steps. The tail gas is initially compressed to increase the pressure of the tail gas stream, which can help in subsequent separation processes. The compressed tail gas stream can then be cooled to condense water vapor in the compressed tail gas stream and remove the condensed moisture from the compressed and cooled tail gas stream.

In some embodiments, H₂S, COS, and other sulfur-containing compounds can be removed from the tail gas using chemical scrubbers or adsorbents like activated carbon or zinc oxide.

After separating sulfur-containing compounds from the tail gas, the tail gas can then be dehydrated to remove some or all of the remaining moisture, e.g., using one or more dehydration units, one or more molecular sieves, one or more dryers, one or more desiccant-based systems, one or more evaporative units, and/or one or more glycol-based dehydration systems.

The tail gas can then be further purified in terms of CO₂ concentration and/or an absence of non-CO₂ materials or contaminants from the tail gas. For example, the system/method can comprise an amine scrubbing process for CO₂ capture/separation in which the tail gas is contacted with an amine solution (e.g., monoethanolamine) that selectively absorbs CO₂. The resulting CO₂-rich amine solution is then heated in a stripper column to release high-purity CO₂.

Additionally or alternatively, the system/process can comprise a Pressure Swing Adsorption (PSA) process that uses adsorbent materials that preferentially adsorb CO₂ at a high pressure. The adsorbent is then regenerated by reducing the pressure, releasing the captured CO₂.

Additionally or alternatively, the system/process can comprise a Vacuum Swing Adsorption (VSA) process that is similar to the PSA process but operates under vacuum conditions to enhance CO₂ recovery and purity.

Additionally or alternatively, the system/process can comprise a membrane separation process, such as one or more gas separation membranes dimensioned and configured to selectively allow CO₂ to pass through the membrane while retaining other gases. Such gas separation membrane methods can be used in combination with other technologies to achieve a sufficiently high purity without excessively fouling the gas separation membranes by first partially purifying the tail gas (e.g., using an amine scrubbing process, a PSA process, or a VSA process) and then further purifying the partially purified tail gas using one or more gas separation membranes.

In certain embodiments, a process such as cryogenic distillation can be used to achieve very-high or ultra-high purity CO₂, e.g., as a tertiary or terminal purification step or stage. Cryogenic distillation comprises further cooling a partially purified tail gas having an increased CO₂ concentration relative to the raw tail gas but also having a CO₂ concentration that is below a desired final CO₂ level. At very low temperatures, CO₂ liquefies and can be separated from other gases. In some embodiments, processes such as cryogenic distillation can comprise one or more of condensation of CO₂ and/or liquefaction of CO₂.

In some embodiments, one or more additional/alternative purification process may be carried out, such as an additional adsorption process or a catalytic oxidation process, to remove any remaining impurities, e.g., to ensure the CO₂ meets food-grade CO₂ standards or beverage-grade CO₂ standards.

While the present disclosure includes descriptions of example processes and systems for purifying tail gas from tail gas from an RNG biorefinery, any similar CO₂-containing gas can be used as a feedstock for a similar CO₂ purification process. For example, an exhaust gas from thermal processes or combustion of waste, fossil fuels and biogenic fuels often contain a large concentration of CO₂. Such off-gases typically contain about 20% CO₂, but can contain a higher percentage of CO₂, as well as moisture, inert gases, COS, carbon disulfide (CS₂), and/or the like. Alternatively, off-gases or tail gases from other fuel gas refineries such as hydrocarbon refineries, mining facilities, wastewater treatment plants, and landfills can also be used, which can contain 30-70% CO₂ as well as VOCs like methane, moisture, H₂S, siloxanes, and other components. Alternatively, a CO₂-rich gas from the production of ammonia and urea, ethanol, hydrogen, detergents, and plastics can contain very high concentrations of CO₂, but also contain moisture, inert gases, VOC, amines, and other impurities.

By integrating these processes and equipment, high-purity CO2, e.g., CO2 having a suitable purity for use in food and beverage applications, can be efficiently produced from the tail gas of an RNG biorefinery or another CO₂-containing process stream or gas flow.

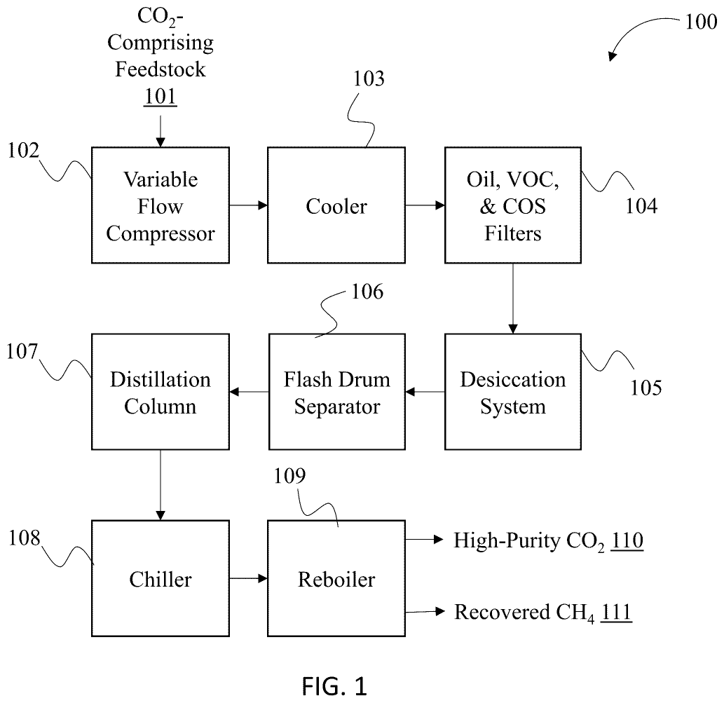

Referring now to FIG. 1, a simplified block-flow diagram of a CO₂ purification/separation process 100 is illustrated. The CO₂ purification/separation process 100 is carried out to produce CO₂ from an input flow/stream. The input flow/stream can be or comprise any suitable CO₂-comprising or CO₂-based flow or stream. In some embodiments, the input flow/stream can be or comprise a waste stream from another facility, such as a renewable natural gas (RNG) production process, RNG upgrading process, RNG conditioning process, or another similar process. As illustrated in FIG. 1, the input (or feedstock) to the CO₂ purification/separation process 100 is illustrated as being a CO₂-Comprising Feedstock 101. The CO₂-Comprising Feedstock 101 can comprise a relatively high percentage of CO₂, which makes it a suitable (even advantageous) feedstock for the CO₂ purification/separation process 100. In some embodiments, the CO₂-Comprising Feedstock 101 can have a CO₂ concentration that is relatively stable, or a CO₂ concentration that varies over time. In some embodiments, the CO₂ concentration in the CO₂-Comprising Feedstock 101 can vary in a predictable or foreseeable manner, while in other embodiments, the change(s) in CO₂ concentration in the CO₂-Comprising Feedstock 101 over time can change in an unpredictable or only partially predictable manner. In instances in which the CO₂-Comprising Feedstock 101 is a waste stream or byproduct/waste product flow from another process, such as an RNG upgrading/conditioning process, the CO₂ concentration in the CO₂-Comprising Feedstock 101 can depend at least in part on the type of process/facility creating the CO₂-Comprising Feedstock 101, processing parameters of the facility creating the CO₂-Comprising Feedstock 101, or the like.

According to some embodiments, the CO₂ concentration in the CO₂-Comprising Feedstock 101 can be greater than about 10 wt. %, greater than about 15 wt. %, greater than about 20 wt. %, greater than about 25 wt. %, greater than about 30 wt. %, greater than about 35 wt. %, greater than about 40 wt. %, greater than about 45 wt. %, greater than about 50 wt. %, greater than about 55 wt. %, greater than about 60 wt. %, greater than about 65 wt. %, greater than about 70 wt. %, greater than about 75 wt. %, greater than about 80 wt. %, greater than about 85 wt. %, greater than about 90 wt. %, greater than about 95 wt. %, greater than about 96 wt. %, greater than about 97 wt. %, greater than about 98 wt. %, greater than about 99 wt. %, inclusive of all values and ranges therewithin. In some embodiments, the CO₂ concentration in the CO₂-Comprising Feedstock 101 can be between about 10 wt. % and about 99 wt. %, between about 15 wt. % and about 99 wt. %, between about 20 wt. % and about 99 wt. %, between about 25 wt. % and about 99 wt. %, between about 30 wt. % and about 99 wt. %, between about 35 wt. % and about 99 wt. %, between about 40 wt. % and about 99 wt. %, between about 45 wt. % and about 99 wt. %, between about 50 wt. % and about 99 wt. %, between about 55 wt. % and about 99 wt. %, between about 60 wt. % and about 99 wt. %, between about 65 wt. % and about 99 wt. %, between about 70 wt. % and about 99 wt. %, between about 75 wt. % and about 99 wt. %, between about 80 wt. % and about 99 wt. %, between about 85 wt. % and about 99 wt. %, between about 90 wt. % and about 99 wt. %, between about 95 wt. % and about 99 wt. %, between about 50 wt. % and about 95 wt. %, between about 60 wt. % and about 95 wt. %, between about 70 wt. % and about 95 wt. %, between about 80 wt. % and about 95 wt. %, between about 90 wt. % and about 95 wt. %, between about 90 wt. % and about 95 wt. %, between about 10 wt. % and about 90 wt. %, between about 20 wt. % and about 90 wt. %, between about 30 wt. % and about 90 wt. %, between about 40 wt. % and about 90 wt. %, between about 50 wt. % and about 90 wt. %, between about 60 wt. % and about 90 wt. %, between about 70 wt. % and about 90 wt. %, or between about 80 wt. % and about 90 wt. %, inclusive of all values and ranges therebetween.

In some embodiments, the CO₂-Comprising Feedstock 101 can also comprise, contain, or include other materials, chemicals, components, impurities, and/or the like. For example, the CO₂-Comprising Feedstock 101 can comprise CH₄, volatile organic compounds (VOCs), siloxanes, COS, H₂S, particulate matter, heavy metals, and/or the like.

In some embodiments, the CO₂-Comprising Feedstock 101 can comprise less than about 50 wt. % CH₄, less than about 45 wt. % CH₄, less than about 40 wt. % CH₄, less than about 35 wt. % CH₄, less than about 30 wt. % CH₄, less than about 25 wt. % CH₄, less than about 20 wt. % CH₄, less than about 15 wt. % CH₄, less than about 14 wt. % CH₄, less than about 13 wt. % CH₄, less than about 12 wt. % CH₄, less than about 11 wt. % CH₄, less than about 10 wt. % CH₄, less than about 9 wt. % CH₄, less than about 8 wt. % CH₄, less than about 7 wt. % CH₄, less than about 6 wt. % CH₄, less than about 5 wt. % CH₄, less than about 4 wt. % CH₄, less than about 3 wt. % CH₄, less than about 2 wt. % CH₄, less than about 1 wt. % CH₄, less than about 0.75 wt. % CH₄, or less than about 0.5 wt. % CH₄, inclusive of all values and ranges therebetween. In some embodiments, the CO₂-Comprising Feedstock 101 can comprise between about 0.5 wt. % CH₄ and about 20 wt. % CH₄, between about 0.75 wt. % CH₄ and about 20 wt. % CH₄, between about 1 wt. % CH₄ and about 20 wt. % CH₄, between about 2 wt. % CH₄ and about 20 wt. % CH₄, between about 3 wt. % CH₄ and about 20 wt. % CH₄, between about 4 wt. % CH₄ and about 20 wt. % CH₄, between about 5 wt. % CH₄ and about 20 wt. % CH₄, between about 6 wt. % CH₄ and about 20 wt. % CH₄, between about 7 wt. % CH₄ and about 20 wt. % CH₄, between about 8 wt. % CH₄ and about 20 wt. % CH₄, between about 9 wt. % CH₄ and about 20 wt. % CH₄, between about 10 wt. % CH₄ and about 20 wt. % CH₄, between about 15 wt. % CH₄ and about 20 wt. % CH₄, between about 0.5 wt. % CH₄ and about 15 wt. % CH₄, between about 0.5 wt. % CH₄ and about 14 wt. % CH₄, between about 0.5 wt. % CH₄ and about 13 wt. % CH₄, between about 0.5 wt. % CH₄ and about 12 wt. % CH₄, between about 0.5 wt. % CH₄ and about 11 wt. % CH₄, between about 0.5 wt. % CH₄ and about 10 wt. % CH₄, between about 0.5 wt. % CH₄ and about 9 wt. % CH₄, between about 0.5 wt. % CH₄ and about 8 wt. % CH₄, between about 0.5 wt. % CH₄ and about 7 wt. % CH₄, between about 0.5 wt. % CH₄ and about 6 wt. % CH₄, between about 0.5 wt. % CH₄ and about 5 wt. % CH₄, between about 0.5 wt. % CH₄ and about 4 wt. % CH₄, between about 0.5 wt. % CH₄ and about 3 wt. % CH₄, between about 0.5 wt. % CH₄ and about 2 wt. % CH₄, between about 0.5 wt. % CH₄ and about 1 wt. % CH₄, or between about 1 wt. % CH₄ and about 15 wt. % CH₄, inclusive of all values and ranges therebetween.

In some embodiments, the CO₂-Comprising Feedstock 101 can comprise only trace amounts of certain other materials or contaminants, such as VOCs, COS, siloxanes, H₂S, heavy metals, and/or the like. In some embodiments, the CO₂-Comprising Feedstock 101 can comprise moisture, thereby having an initial moisture content (MC) of between about 0.1 wt. % MC and about 25 wt. %, inclusive of all values and ranges therebetween.

In some embodiments, the CO₂ purification/separation process 100 can further comprise a Variable Flow Compressor 102 configured to compress the CO₂-Comprising Feedstock 101. The Variable Flow Compressor 102 can be controlled to vary its flow rate based on one or more factors. For example, the Variable Flow Compressor 102 can be configured to vary flow rate based on changes in mass flow rate of the CO₂-Comprising Feedstock 101 being input to the Variable Flow Compressor 102. In some embodiments, the Variable Flow Compressor 102 can be configured to adjust flow rate based upon changes in one or more of: changes in moisture content of the CO₂-Comprising Feedstock 101, changes in CO₂ concentration in the CO₂-Comprising Feedstock 101, changes in CH₄ concentration in the CO₂-Comprising Feedstock 101, changes in density of the CO₂-Comprising Feedstock 101, changes in thermal mass of the CO₂-Comprising Feedstock 101, changes in a temperature of the CO₂-Comprising Feedstock 101, changes in a pressure of the CO₂-Comprising Feedstock 101, changes in volumetric flow rate of the CO₂-Comprising Feedstock 101, and/or the like.

The Variable Flow Compressor 102 can be in communication with, controlled by, or comprise one or more of: a variable-frequency drive (VFD), one or more piping & instrumentation diagram (P&ID) control system sub-processes (such as one or more P&ID loops), one or more sensors or instruments, and/or the like, each of which are not illustrated in FIG. 1 for the sake of simplicity. For example, one or more sensors (not shown) can be used, such as a gas flow sensor, compressed gas flow measurement device, a variable area meter, a rotameter, an orifice plate system, a venturi tube system, a pilot tube system, a vortex meter, a thermal mass meter, and/or the like. The real-time or near-real-time output from such a sensor can be used as an input for a P&ID control system to monitor a variable or characteristic of the CO₂-Comprising Feedstock 101. The P&ID control system can then be used to control the Variable Flow Compressor 102, such as by changing a setting of a VFD, actuating a flow control valve, and/or the like.

In some embodiments, the CO₂ purification/separation system 100 can further comprise a Cooler 103 configured to reduce the temperature of the CO₂-Comprising Feedstock 101 after being compressed using the Variable Flow Compressor 102. The Cooler 103 can be or comprise one or more of: an evaporative cooling device, a refrigerant gas cycle, a pressure-reduction chiller, a gas compression-chiller, and/or the like.

In some embodiments, the CO₂ purification/separation system 100 can further comprise one or more Oil, VOC, & COS Filters 104. After being compressed and cooled/chilled, the CO₂-Comprising Feedstock 101 is filtered using the Oil, VOC, & COS Filters 104. In some embodiments, the Oil, VOC, & COS Filters 104 can comprise one or more specialized processes and equipment designed to target the oil (e.g., oil droplets), VOCs, and COS. In some embodiments, the Oil, VOC, & COS Filters 104 can comprise one or more mechanical filters configured to capture oil droplets and particulate matter using coalescing filters or demisters. In some embodiments, the Oil, VOC, & COS Filters 104 can comprise one or more adsorption processes configured to remove VOCs. Activated carbon or zeolite beds are commonly used for this purpose, as they have high surface areas that adsorb VOC molecules effectively. In some embodiments, the Oil, VOC, & COS Filters 104 can comprise one or more of a chemical scrubbing process or a catalytic hydrolysis process. As an example, a chemical scrubbing process can comprise passing the CO₂-Comprising Feedstock 101 through a scrubber containing an alkaline solution, such as amine or caustic soda, which reacts with COS to form non-volatile compounds that can be easily separated from the gas stream. Alternatively, catalytic hydrolysis can be used to convert COS in the CO₂-Comprising Feedstock 101 to H₂S in the presence of a catalyst, and the resulting H₂S is then removed using desulfurization techniques like zinc oxide beds or iron sponge.

In some embodiments, the CO₂ purification/separation system 100 can further comprise a Desiccation System 105. The Desiccation System 105 can comprise a liquid desiccant dehydration process, an adsorption dehydration process, a membrane separation process, or a cryogenic dehydration process. The liquid desiccant process can comprise contacting the CO₂-Comprising Feedstock 101, after being compressed and chilled/cooled, with a liquid desiccant, such as triethylene glycol (TEG) in an absorber column. The TEG absorbs water vapor from the CO₂-Comprising Feedstock 101. The water-rich TEG can then be regenerated by heating it in a reboiler, where water is boiled off and the TEG is recycled back to the absorber for further use in the liquid desiccant process.

Additionally or alternatively, an adsorption dehydration process can be used which passes the CO₂-Comprising Feedstock 101 through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the CO₂-Comprising Feedstock 101 to pass through the membrane(s) while retaining the CO₂ from the CO₂-Comprising Feedstock 101. This approach is compact and energy-efficient, making it suitable for smaller-scale applications or where space is limited.

Additionally or alternatively, the cryogenic dehydration process can involve cooling the CO₂-Comprising Feedstock 101 to very low temperatures, causing water vapor from the CO₂-Comprising Feedstock 101 to condense, and be separated from the CO₂-Comprising Feedstock 101, as liquid water. This approach is effective for achieving very low moisture levels but is energy-intensive and typically used in conjunction with other dehydration methods.

In some embodiments, the CO₂ purification/separation system 100 can further comprise a Flash Drum Separator 106 configured to remove CH₄ from the CO₂-Comprising Feedstock 101. The flash separation process carried out in the Flash Drum Separator 106 leverages the differences in volatility between CH₄ and CO₂. The CO₂-Comprising Feedstock 101 can be (further) compressed and then heated before being introduced into the Flash Drum Separator 106. Upon entering the Flash Drum Separator 106, the CO₂-Comprising Feedstock 101 experiences a sudden pressure drop, causing the more volatile component(s) (e.g., CH₄) of the CO₂-Comprising Feedstock 101 to vaporize while the less volatile component(s) (e.g., CO₂) from the CO₂-Comprising Feedstock 101 remains largely in the liquid phase in the CO₂-Comprising Feedstock 101.

The Flash Drum Separator 106, also known as a flash vessel or flash tank, is or comprises a pressure vessel designed to facilitate the rapid phase separation of a liquid-gas mixture. The flash drum of the Flash Drum Separator 106 operates based on the principle of partial vaporization. When the CO₂-Comprising Feedstock 101, which may now have an elevated/higher pressure and/or temperature, enters the Flash Drum Separator 106, the CO₂-Comprising Feedstock 101 experiences a pressure drop which causes a portion of the liquid portion of the CO₂-Comprising Feedstock 101 to vaporize (e.g., instantly). The vapor phase of the CO₂-Comprising Feedstock 101, which may be enriched with CH₄, rises to the top of the Flash Drum Separator 106 and can be withdrawn from the Flash Drum Separator 106 via a vapor outlet, while the liquid phase of the CO₂-Comprising Feedstock 101, which may be (further) enriched with CO₂, settles to the bottom of the Flash Drum Separator 106 and can be withdrawn from the Flash Drum Separator 106 via a liquid outlet.

The Flash Drum Separator 106 can include an inlet for the CO₂-rich gas mixture, the outlet at the top for the vapor phase (e.g., rich in CH₄), and the outlet at the bottom for the liquid phase (e.g., rich in CO₂). Internally, the drum of the Flash Drum Separator 106 may have baffles or demisters to enhance phase separation of the CO₂-Comprising Feedstock 101 and prevent liquid carryover into the vapor stream. The efficiency of the flash separation process in the Flash Drum Separator 106 may depend on a variety of factors, such as the pressure and temperature conditions, the composition of the CO₂-Comprising Feedstock 101, the design and operating parameters of the Flash Drum Separator 106, and/or the like.

After the CH₄-rich vapor phase is removed from the CO₂-Comprising Feedstock 101 using the Flash Drum Separator 106 and removed from the Flash Drum Separator 106 via the vapor outlet at or near the top of the Flash Drum Separator 106, the CH₄-rich vapor phase of the CO₂-Comprising Feedstock 101 can be returned to the main RNG product stream from the RNG biorefinery process/facility.

In some embodiments, the CO₂ purification/separation system 100 can further comprise a Distillation Column 107. After the CO₂-rich liquid phase is formed from or removed from the CO₂-Comprising Feedstock 101 using the Flash Drum Separator 106 and removed from the Flash Drum Separator 106 via the liquid outlet at or near the bottom of the Flash Drum Separator 106, the CO₂-rich liquid phase can be communicated to/into the Distillation Column 107 for further separation of additional remaining CH₄ from the CO₂-rich liquid phase of the CO₂-Comprising Feedstock 101.

According to one or more other embodiment(s), a CO₂ purification/separation system can be provided that is similar in many or all elements to the CO₂ purification/separation system 100 except that it does not include the Flash Drum Separator 106. In such other embodiment(s), instead of returning a CH₄-rich vapor phase of the CO₂-Comprising Feedstock 101 to the main RNG product stream from the RNG biorefinery process/facility after flash drum separation, the CO₂ purification/separation system can directly communicate the CO₂-Comprising Feedstock 101 to subsequent components/elements of the CO₂ purification/separation system. In such other embodiment(s), the CO₂ purification/separation system 100 can further comprise the Distillation Column 107 and the CO₂-Comprising Feedstock 101 can be communicated to/into the Distillation Column 107 for separation of CH₄ from the CO₂-Comprising Feedstock 101.

In some embodiments, a CO₂ purification/separation system can be provided that is similar in many or all elements to the CO₂ purification/separation system 100 except that it does not include the Flash Drum Separator 106. In such other embodiment(s), instead of using Flash Drum Separator 106 to enhance the liquid CO₂ yields, the Flash Drum Separator 106 can be eliminated from the system and the functionality thereof can be incorporated into other processes or operations, such as column distillation using, e.g., the Distillation Column 107. As an example, when the CO₂-Comprising Feedstock 101 is or comprises biogas produced in a landfill, for example, the biogas (e.g., vent gas from the landfill) typically contains oxygen and nitrogen, which will be removed in the Distillation Column 107. In some such instances, the vent gas from such a landfill operation will typically comprise CO₂, CH₄, O₂, and N₂. In some embodiments, the CO₂ purification/separation system 100 can comprise a membrane system. In some embodiments, the membrane system can be dimensioned and configured for the separation of CO₂ and CH₄ from the vent gas, which may contain O₂ in the CO₂ stream and N₂ in the CH₄ stream. In some embodiments, O₂ and N₂ can be eliminated from the separated CO₂ and CH₄ gas streams using, e.g., temperature swing adsorption (TSA), catalysts, impregnated activated carbon, and/or the like. In some embodiments, residual CO₂ (e.g., pure or ultra-pure CO₂) can be redirected to one or more upstream compressor stages/operations.

In some embodiments, the Distillation Column 107 can be configured to use thermal distillative separation of a second CH₄ vapor phase from the CO₂-rich liquid phase of the CO₂-Comprising Feedstock 101. The Distillation Column 107 can be configured to heat the CO₂-rich liquid phase of the CO₂-Comprising Feedstock 101 to form CO₂ bottoms at or near the bottom of the Distillation Column 107 and further form the second CH₄-rich vapor phase from the CO₂-Comprising Feedstock 101 at or near the top of the Distillation Column 107. The second CH₄-rich vapor phase from the CO₂-Comprising Feedstock 101 can then be removed from the Distillation Column 107 and subsequently condensed to return the CH₄ removed using the Distillation Column 107 to the main RNG product stream from the RNG biorefinery process/facility. In other embodiments, the Distillation Column 107 can be configured to use cryogenic distillation, such as a controlled freeze zone (CFZ) process or the like.

In some embodiments, the CO₂ purification/separation system 100 can further comprise a Chiller 108 configured to reduce the temperature of the CO₂ bottoms after the CO₂ bottoms are removed from the Distillation Column 107. The Chiller 108 can comprise one or more heat exchangers, such as heat exchangers comprising a series of tubes or a series of plates that are cooled by a secondary fluid, such as water or glycol. The Chiller 108 can be configured to cause the CO₂ bottoms removed from the Distillation Column 107 to be communicated through, across, between, or about/nearby the series of tubes or plates in the heat exchanger(s). The secondary fluid (e.g., a refrigerant or other such pre-chilled fluid) can be communicated through, across, between, or about/nearby the series of tubes or plates in the heat exchanger(s), while being maintained out of contact with the CO₂ bottoms. By placing the CO₂ bottoms in thermal communication with the secondary fluid in the heat exchanger(s), the heat exchanger(s) allow for indirect cooling by exchanging heat from the CO₂ bottoms to the secondary fluid. Other suitable materials for the secondary fluid can include, among other materials, one or both of ammonia or Freon. The Chiller 108 can be a closed-loop cooling system or a semi-closed loop cooling system. The Chiller 108 can comprise one or more subcomponents, apparatuses, or hardware such as: compressors, condensers, evaporators, and/or expansion valves.

Alternatively or additionally, the Chiller 108 can comprise one or more quench towers in which CO₂ bottoms removed from the Distillation Column 107 can be phase changed from a liquid to a gas by reducing the pressure and/or increasing the temperature of the CO₂ bottoms. The CO₂ bottoms in gas phase can then be sprayed with a cooling liquid, such as water, to rapidly reduce its temperature. Thereby, the Chiller 108 can be configured not only to cool the CO₂ bottoms but also helps remove particulates and soluble impurities from the CO₂ bottoms.

Alternatively or additionally, the Chiller 108 can comprise a cryogenic cooling system that involves cooling the CO₂ bottoms removed from the Distillation Column 107 to extremely low temperatures using liquid nitrogen or other cryogenic fluids. Cryogenic cooling operates by employing extremely low temperatures, e.g., between about −150° C. and about 0° C., to cool materials or gases. The cryogenic cooling process can begin with the compression of a cryogenic fluid, such as liquid nitrogen or helium, at room temperature, which raises its pressure and temperature. This compressed fluid is then precooled using a heat exchanger and another cooling medium, typically a refrigerant or a secondary cryogenic fluid. Following this, the fluid undergoes expansion through a valve or an expansion engine, resulting in a significant temperature drop due to the Joule-Thomson effect, where the fluid cools as it expands and its pressure decreases. The now-cold, low-pressure cryogenic fluid is then used to cool the target material or gas (i.e., CO₂ bottoms removed from the Distillation Column 107) via another heat exchanger, where it absorbs heat from the material or gas. Finally, the low-pressure fluid is cycled back to the compressor to repeat the process. Cryogenic cooling systems can comprise other components such as compressors, heat exchangers, expansion valves, and/or cryocoolers, which are specialized refrigerators designed to achieve cryogenic temperatures. Example cryogenic cooling systems can maintain extremely low temperatures.

In some embodiments, the Chiller 108 can further comprise one or more other components, such as fans, pumps, and/or control systems to optimize the process of cooling/chilling the CO₂ bottoms. For example, the Chiller 108 can comprise a Shell Claus Off-gas Treatment (SCOT) unit in which the CO₂ bottoms are first heated in an in-line burner before entering a hydrogenation reactor. The effluent from this hydrogenation reactor is then cooled by generating low-pressure steam and further cooled by water exchange. The cooled CO₂ bottoms in gas phase can then be treated in an amine absorber to remove residual H₂S. This multi-step process ensures that the CO₂ bottoms are effectively cooled and treated before being further processed in the CO₂ purification/separation system 100.

In some embodiments, the CO₂ purification/separation system 100 can further comprise a Reboiler 109. Reboiling processes for CO₂ bottoms removed from the Distillation Column 107 and chilled using the Chiller 108 can involve heating the CO₂ bottoms in gas phase to separate and recover valuable components, using the Reboiler 109 as the primary equipment. The Reboiler 109 can be or comprise a heat exchanger that provides the necessary heat to cause separation of a gas mixture or a liquid mixture into several component parts. For example, the Reboiler 109 can be configured to heat and/or vaporize the CO₂ bottoms removed from the Distillation Column 107 and subsequently chilled using the Chiller 108, thereby causing the CO₂ bottoms to vaporize. The CO₂ bottoms can then rise through a separator. In some embodiments, the separator can be or comprise the Distillation Column 107. In some embodiments, in the separator, the CO₂ bottoms in vapor phase can separate into two or more different parts or portions based on differing boiling points of various constituents or components parts in the CO₂ bottoms. In the context of CO₂ bottoms separated from the CO₂-Comprising Feedstock 101, the Reboiler 109 can be configured to heat the CO₂ bottoms to drive off CO₂ and other volatile components, which can then be condensed and collected. Alternatively, the Reboiler 109 can be configured to heat the CO₂ bottoms to drive off some or all of any remaining CH₄ from the CO₂ bottoms separated from the CO₂-Comprising Feedstock 101 using the Flash Drum Separator 106 and/or the Distillation Column 107.

Among other options, the Reboiler 109 can be or comprise one or more of: a kettle reboiler, a thermosiphon reboiler, or a forced circulation reboiler. Kettle reboilers are simple and robust, consisting of a shell where the liquid is heated by steam or another heating medium. Thermosiphon reboilers rely on natural circulation driven by density differences between the heated and unheated liquid, making them relatively more energy efficient. Forced circulation reboilers use pumps to circulate the liquid, providing better control over the heating process and accommodating higher heat fluxes.

The Reboiler 109 can also comprise various components or sub-processes. For instance, the heating medium used in the Reboiler 109 can be supplied to the Reboiler 109 through a steam control valve, which regulates a flow rate and a pressure of the heating medium in/into the Reboiler 109. Once heated, the CO₂ bottoms can then be communicated into a separation device, such as the Distillation Column 107, where it undergoes separation. The performance of the Reboiler 109 can be monitored and controlled, e.g., using temperature and pressure sensors, to ensure suitable or optimal operation of the CO₂ purification/separation system 100. Additionally or alternatively, the Reboiler 109 can comprise one or more condensers that may be used to cool and condense at least some components separated from the CO₂ bottoms, facilitating their collection and further processing.

In some embodiments, the CO₂ purification/separation system 100 can further comprise a variety of storage or conveyance means for one or more RNG product streams and/or one or more CO₂-rich gas streams from the Flash Drum Separator 107 and/or the Reboiler 109. In some embodiments, the storage or conveyance means can be configured for storing or conveying one or more of High-Quality CO₂ 110 and/or Recovered CH₄ 111. For example, one or more sensors, analyzers, or the like can be used to determine a composition (e.g., CO₂ concentration) in the High-Quality CO₂ 110. If the CO₂ concentration of the High-Quality CO₂ 110 is sufficiently high and undesirable materials or impurities are non-existent or sufficiently scarce in the High-Quality CO₂ 110, the High-Quality CO₂ 110 can be considered as a finished CO₂ product from the CO₂ purification/separation system 100.

However, if the CO₂ concentration of the High-Quality CO₂ 110 is not sufficiently high and/or undesirable materials or impurities are present at concentrations above one or more concentration thresholds in the High-Quality CO₂ 110, the High-Quality CO₂ 110 can be considered as an intermediate CO₂ product from the CO₂ purification/separation system 100 and can be returned to a prior stage or step of the CO₂ purification/separation system 100, e.g., to the Cooler 103 or between the Cooler 103 and the Oil, VOC, & COS Filters 104; or to the Desiccation System 105 or between the Desiccation System 105 and the Flash Drum Separator 106.

In some embodiments, the Recovered CH₄ 111 can be communicated to the RNG biorefinery, biogas facility, or other such source of the CO₂-rich tail gas being used as feedstock in the CO₂ purification/separation system 100. For example, the Recovered CH₄ 111 can be returned to the RNG biorefinery to be further processed, conditioned, or upgraded.

Alternatively, depending on the concentration of CH₄ in the Recovered CH₄ 111 and/or the presence/concentration of other materials or impurities in the Recovered CH₄ 111, the Recovered CH₄ 111 can be communicated back to the RNG biorefinery for direct combination/mixing of the Recovered CH₄ 111 with one or more process or product streams in or from the RNG biorefinery, such as a primary RNG product stream from the RNG biorefinery.

The described/illustrated processes and equipment from the CO₂ purification/separation system 100 can ensure that the CO₂-Comprising Feedstock 101 is sufficiently purified to meet the required specifications for various applications, such as for industrial applications, as food-grade CO₂, as beverage-grade CO₂, and/or the like. The choice(s) of specific technologies and/or hardware, and their configurations and/or processing parameters, can vary based on the initial composition of the CO₂-Comprising Feedstock 101 and the desired composition (e.g., purity) and/or other characteristics of the finished CO₂ product from the CO₂ purification/separation system 100.

In some embodiments, the CO₂ purification/separation system 100 can be carried out as a standalone process or in a standalone facility. For example, the CO₂ purification/separation system 100 can be fabricated/provided as/in a standalone greenfield site or a standalone greenfield facility. According to some embodiments, the CO₂ purification/separation system 100 can be provided as a standalone facility that is configured to receive an input flow of tail gas from a separate (e.g., spatially non-collocated) RNG upgrading/conditioning facility, or the like, by way of conveyance means, such as a pipeline therebetween, truck transport therebetween, or by way of other suitable conveyance means therebetween.

In some embodiments, the CO₂ purification/separation system 100 can be carried out as part of another process, adjacent to another process, within or as part of another process, and/or within another facility. For example, the CO₂ purification/separation system 100 can be collocated with or within another facility or positioned/located adjacent to/abutting another facility such as an RNG upgrading/conditioning facility.

In some embodiments, the CO₂ purification/separation system 100 can further comprise a H₂S filtration unit (not shown) that uses one or more of: chemical solvents, liquid scavengers, iron-removal filters, solid absorbents, membrane separation, and/or an exchange bed.

According to some embodiments, the CO₂ purification/separation system 100 can include/use variable mass flow rate compressors and mass flow rate sensors at the tail gas inlet for improved process control and automated adjustments of downstream processes in response to a variable feedstock mass flow rate, which can change in terms of a volumetric flow rate, a mass flow rate, and/or a density as tail gas composition changes.

Further, in some embodiments, the CO₂ purification/separation system 100 can comprise several stages of filtration and COS polishing to remove contaminants from the CO₂-Comprising Feedstock 101 prior to separation of remaining CH₄ from the CO₂, which presents the bulk of the composition of the CO₂-Comprising Feedstock 101 after filtration and polishing. For example, COS polishing can be accomplished using a carbonyl sulfide exchange bed comprising a reactor that contains a fixed bed of ion exchange resin or the like for desorbing COS from the CO₂-Comprising Feedstock 101. In certain embodiments, the exchange bed can use a carbon medium impregnated with a copper compound as the COS exchange medium for COS polishing of the CO₂-Comprising Feedstock 101.

According to some embodiments, the CO₂ purification/separation system 100 can also comprise and operate several condensers and chillers to maintain a temperature of the CO₂-Comprising Feedstock 101 prior within a relatively low temperature range (as compared to existing CO₂ separation/purification processes) prior to and during flash drum separation and/or column distillation. For example, the CO₂ purification/separation system 100 can operate at temperatures as low as, or lower than, about −10° C., while existing CO₂ separation/purification processes and systems typically operate at a minimum temperature of about 20° C. By maintaining a relatively reduced temperature before and during flash drum separation and column distillation, the subsequent reboiling process can more efficiently separate residual CH₄ from the bulk CO₂ and the residual CH₄ can be returned to the RNG product stream.

According to some embodiments, the CO₂ purification/separation system 100 can also comprise fewer heat exchangers, fewer coolers/chillers, and/or fewer oil/water filtration steps, e.g., as compared to existing CO₂ purification systems and processes, thereby achieving a significant reduction (e.g., an orders-of-magnitude reduction in some example systems and processes) in energy intensiveness of the CO₂ purification/separation system 100 relative to existing CO₂ purification systems. For example, according to one embodiment, the CO₂ purification/separation system 100 can be configured to operate with an electrical load of about 80 kW, while existing CO₂ separation/purification systems typically operate with an electrical load of about 90 MW.

According to some embodiments, the CO₂ purification/separation system 100 can use one or more compressor(s) equipped with a variable frequency drive (VFD) and configured to adjust the compressor operation based upon a varied throughput, which in the case of the systems and methods described herein as the CO₂-Comprising Feedstock 101 may vary in terms of composition, mass/thermal/volumetric flow rate, and/or the like. Control of the compressors and/or other equipment or processes in the CO₂ purification/separation system 100 can be carried out to control for suitably high-quality CO₂ production from the CO₂-Comprising Feedstock 101. As mentioned earlier, a composition (and therefore a mass flow rate) of the CO₂-Comprising Feedstock 101 can vary over time. Additionally or alternatively, a magnitude of the CO₂-Comprising Feedstock 101 produced can vary over time, such as based upon the amount of raw biogas being produced, which may be seasonal, may be constrained by available organic material, may change based upon partial downtime of the RNG biorefinery, and/or for any of a variety of other reasons. By using VFD-equipped compressors a flow rate/processing rate of the CO₂ purification/separation system 100 can be maintained at a relative stable or steady pace.

Another benefit of the CO₂ purification/separation system 100 is that, according to some embodiments, it may operate at a maximum pressure of between about 200 PSI (i.e., about 1.379e⁺⁶ Pascal) and about 600 PSI (i.e., about 4.137e⁺⁶ Pascal), such as about 400 PSI (i.e., 2.758e⁺⁶ Pascal), while most existing CO₂ purification/separation systems operate at a maximum pressure of 1,000 PSI (i.e., 6.895e⁺⁶ Pascal) or greater. In some embodiments, the CO₂ purification/separation system 100 can operate at a maximum pressure of between about 300 PSI (i.e., 2.068e⁺⁶ Pascal) and about 700 PSI (i.e., 4.826e⁺⁶ Pascal). This reduced maximum operating pressure provides multiple benefits in terms of equipment sizing and capacity engineering, as well as in terms of the safety to operators and others working within and around the CO₂ purification/separation system 100.

Also, the flexibility of the CO₂ purification/separation system 100 can be greater than existing CO₂ purification/separation systems. For example, the CO₂ purification/separation system 100 may be configured to be ‘bolted onto’ (or relatively easily integrated with) a variety of different types of biorefinery, including a PSA gas separation RNG biorefinery, a membrane-based RNG biorefinery, and/or others. Existing CO₂ separation/purification systems and processes are not well suited for handling certain impurities, such as COS, siloxanes, and/or the like. Conversely, the CO₂ purification/separation system 100 can handle COS and/or other impurities in the CO₂-Comprising Feedstock 101. Additionally or alternatively, the CO₂ purification/separation system 100 can be flexibly used for purifying the CO₂-Comprising Feedstock 101 when the CO₂-Comprising Feedstock 101 is received from a membrane-based RNG biorefinery that already removes COS, siloxanes, and/or other impurities before the tail gas outlet, without negatively impacting the operability of the CO₂ purification/separation system 100 or requiring any changes to the configuration or operation of the RNG biorefinery before integration of the CO₂ purification/separation system 100 into/with the RNG biorefinery. Conversely, existing CO₂ separation/purification systems and processes cannot be used for processing tail gas from a PSA gas separation RNG biorefinery because of contaminant fouling and COS contamination of the CO₂ and/or the CH₄ being separated therefrom.

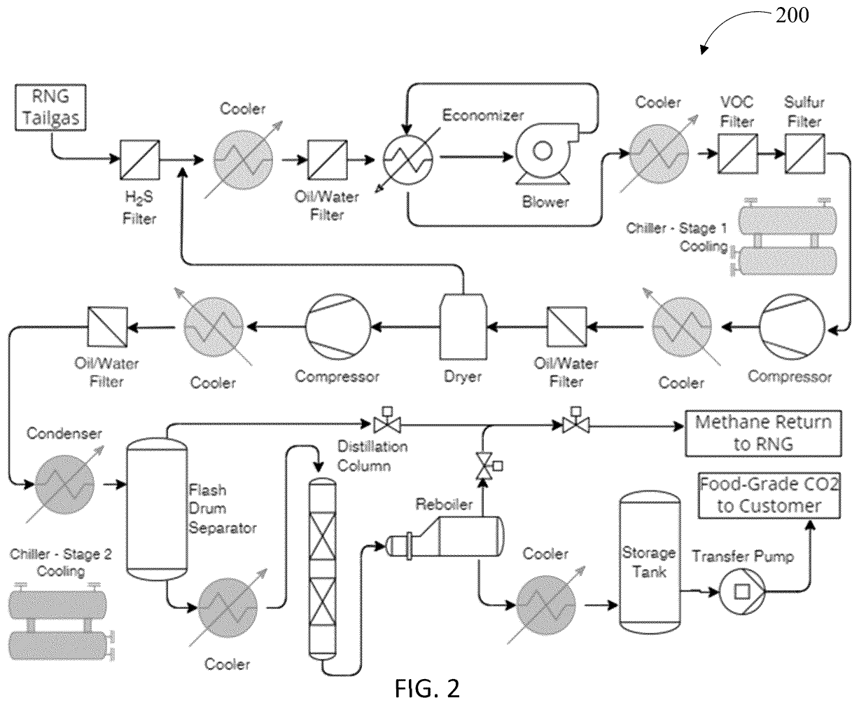

Referring now to FIG. 2, a simplified block-flow diagram of a CO₂ purification/separation process 200 is illustrated. The CO₂ purification/separation process 200 can be carried out in a system or facility similar to, or the same as, the CO₂ purification/separation system 100 described above. The CO₂ purification/separation process 200 is carried out to produce CO₂ from an input flow/stream. The input flow/stream can be or comprise any suitable CO₂-comprising or CO₂-based flow or stream, which can be the same as the CO₂ Comprising Feedstock 101 described above with regard to FIG. 1. In some embodiments, the input flow/stream can be or comprise a waste stream from another facility, such as a renewable natural gas (RNG) production process, RNG upgrading process, RNG conditioning process, or another similar process. In some embodiments, the input (or feedstock) to the CO₂ purification/separation process 200 can be an RNG tail gas. The RNG tail gas can comprise a relatively high percentage of CO₂, which makes it a suitable (even advantageous) feedstock for the CO₂ purification/separation process 200. Since the RNG tail gas is a waste stream or byproduct/waste product flow from, e.g., an RNG upgrading/conditioning process, the CO₂ concentration in the RNG tail gas can depend at least in part on the type of process/facility creating the RNG tail gas, processing parameters of the facility creating the RNG tail gas, or the like.

In some embodiments, the CO₂ purification/separation process 200 can further comprise process or step for filtering H₂S from the RNG tail gas. For example, the CO₂ purification/separation process 200 can comprise a ‘gas sweetening’ step or another suitable process for removing H₂S from the RNG tail gas. Among other embodiments and solutions contemplated and included within the scope of this present disclosure is a variety of chemical absorption processes, such as those using a scrubbing process where the gas is passed through a liquid solution containing a chemical absorbent, like an amine (e.g., monoethanolamine, DEA, MDEA), which reacts with the H₂S in the RNG tail gas, effectively removing it from the RNG tail gas process stream. Additionally or alternatively, the removal of H₂S from the RNG tail gas process stream can be carried out using an iron/copper bimetallic catalytic oxidation desulfurization system, such as one using an absorbent formed by adding N-methyl pyrrolidone (NMP) and CuCl₂ aqueous solution to an iron-based ionic liquid (Fe-IL). Other and/or additional processes and technologies can be used for removing H₂S from the RNG tail gas.

After H₂S removal, the CO₂ purification/separation process 200 can subsequently comprise a (e.g., first) cooling/chilling process or step. For example, the cooling/chilling process or step can comprise one or more heat exchange stages. The RNG tail gas process stream or a portion thereof can be passed through one or more heat exchangers where it transfers heat to a cooling medium like chilled water or a refrigerant, causing the gas temperature to drop considerably. Cooling the RNG tail gas may condense the RNG tail gas mixture and/or components therein and prepare the RNG tail gas for further subsequent processing, such as the separation of CO₂ or CH₄ from the RNG tail gas process stream.

Following cooling/chilling of the RNG tail gas, the CO₂ purification/separation process 200 can subsequently comprise a (e.g., first) oil/water filtration process or step. The oil/water filtration step or stage can comprise a coalescing filter, which works by causing tiny liquid droplets to clump together (i.e., coalesce) into larger droplets that can then be easily separated from the gas stream through gravity drainage. The oil/water filtration process can be similar to oil/water filtration processes that can be used for removing oil and water from natural gas. A coalescing filter can include filter media within a coalescer. The filter media can have a fibrous structure that is dimensioned and configured to trap liquid droplets of oil or water, thereby allowing them to collide and combine (i.e., coalesce) into larger droplets that can be more easily removed. In some embodiments, a coalescing filter can include one or multiple filter stages, such as different filter stages that are configured to sequentially remove different sized droplets of oil or water with increasing efficiency. In some embodiments, a coalescing filter can comprise one or more baffles or mesh portions configured to enhance droplet collision and coalescence.

Alternatively, oil and/or water can be removed from the RNG tail gas by using a hydrophilic or oleophilic material that is operable to cause chemical/physical attraction of oil and/or water from the RNG tail gas process stream. For example, a glycol dehydration unit can be used to remove water or water vapor from the RNG tail gas process stream. As another example, fluidic oil can be removed from the RNG tail gas process stream using one or more of: straining processes, membrane filtration processes, vacuum dehydration, filter bags, electrostatic coalescing filters, mechanical screen traps, and/or the like.

As illustrated in FIG. 2, following the filtration of oil/water from the RNG tail gas, the CO₂ purification/separation process 200 can subsequently comprise an economizer process, which may use a condensing economizer, a refrigeration economizer, or the like. The economizer process can be carried out to recover sensible and latent heat from the RNG tail gas, thereby further chilling or cooling the RNG tail gas process stream and reducing process heat/energy use in the CO₂ purification/separation process 200 or in a collocated biorefinery or other source of the RNG tail gas. The economizer process can comprise a shell and tube heat exchanger, a condensing heat exchanger, an integrated flue gas treatment system, and/or the like. The economizer process can further include a blower configured to circulate the RNG tail gas process flow.

As illustrated in FIG. 2, following the economizer process, the CO₂ purification/separation process 200 can subsequently comprise a further (e.g., second) chiller/cooler step. The second chiller stage can be similar to or the same as the first chiller/cooler step described above. After a further chiller/cooler step, the CO₂ purification/separation process 200 can subsequently comprise a VOC filter and a sulfur filter. In some embodiments, VOCs can be removed from the RNG tail gas using an activated carbon filtration process, a thermal oxidation process, a biological treatment process, a hybrid thermal destruction process, and/or the like. Sulfur can be removed from the RNG tail gas can be carried out using any suitable desulfurization process, such as a limestone slurry scrubber, an alkaline absorbent process, a dry scrubbing process, an amine scrubbing process, a membrane filtration process, and/or the like. In some embodiments, the processes for removing VOCs and sulfur can be separate, while in other embodiments, VOC and sulfur removal can be carried out via a combined process.

As illustrated in FIG. 2, following the process(es) for removing VOCs and/or sulfur from the RNG tail gas process flow, the CO₂ purification/separation process 200 can subsequently comprise a (e.g., first) chiller-stage 1 cooling process. This additional chiller/cooling step/stage can be carried out in order to facilitate the next step, which is a compressor stage during which one or more compressors are used to compress the RNG tail gas process flow.

After compression of the RNG tail gas process flow, the CO₂ purification/separation process 200 can subsequently comprise an additional (e.g., third) cooler process and an additional oil/water filtration/removal process. The additional compression step/stage and the additional chilling/cooling process can be the same or similar to other such processes described herein.

After the additional oil/water filtration process, the CO₂ purification/separation process 200 can subsequently comprise a drying step. Drying of the chilled and compressed RNG tail gas process stream can be used to prepare the RNG tail gas process flow for subsequent separation process(es). Just before, during, and/or after the drying process, gas analysis can be carried out to determine whether the RNG tail gas process flow still comprises H₂S, VOCs, sulfur compounds, oil, water, water vapor, and/or other contaminants, all or portions of the RNG tail gas process stream can be redirected back to an earlier stage or step of the CO₂ purification/separation process 200. However, if the RNG tail gas process stream is sufficiently free of such contaminants, it can be communicated on to the remaining steps or stages of the CO₂ purification/separation process 200.

In some embodiments, the CO₂ purification/separation process 200 can subsequently comprise an additional (e.g., second) compression stage or step, followed by an additional (e.g., fourth) cooling or chilling step or stage, and further followed by an additional (e.g., second) oil/water filtration step or stage.

After these additional compression, cooling/chilling, and oil/water filtration steps or stages, the CO₂ purification/separation process 200 can subsequently comprise a condenser step or stage. During the condenser step or stage, a condenser can be used to collect any sensible/latent heat from the RNG tail gas process stream. Then, the RNG tail gas process stream can be further cooled/chilled in a chiller-stage 2 cooling process. The further cooled RNG tail gas process stream can, during this step/stage be reduced to a temperature of between about −30° C. and about 10° C. During the condenser step/stage, an absorbent material such as glycol or the like can be used to absorb gas and hydrocarbons from the RNG tail gas process stream. In some embodiments, a contact tower or the like can be used during the condenser step or stage.

In some embodiments, the CO₂ purification/separation process 200 can subsequently comprise a flash drum separation process. During flash drum separation, a flash drum separator can be used to remove the gas and condensate hydrocarbons from the glycol that was absorbed during the condenser stage (e.g., in the contact tower) from the RNG tail gas process stream. From the flash drum separation process, methane can be separated from the RNG tail gas process stream and may be returned to the RNG biorefinery or other facility that generated the RNG tail gas.

After flash drum separation, the CO₂ purification/separation process 200 can subsequently comprise an additional (e.g., fifth) cooling/chilling step or stage, and after the additional cooling/chilling step or stage, a column distillation step or stage. During column distillation, a distillation column is used to further separate at least a portion of the remaining methane from the RNG tail gas process stream based upon a difference in boiling points of compressed methane CH₄ and compressed CO₂ (and likewise the difference in boiling points of various other components in the compressed RNG tail gas) to fractionate the CH⁴, CO₂, and/or other constituents or components of the compressed RNG tail gas. CH₄, once stripped out of the compressed RNG tail gas process stream, can be returned to the RNG biorefinery or other facility that generated the RNG tail gas.

Column distillation of the CO₂-rich liquid phase can result in further separation of additional remaining CH₄ from the CO₂-rich liquid phase of the RNG tail gas. In some embodiments, the column distillation can be carried out by heating the CO₂-rich liquid phase of the RNG tail gas to form CO₂ bottoms at or near the bottom of the Distillation column (e.g., 107) and further form the second CH₄-rich vapor phase from the RNG tail gas at or near the top of the distillation column. The second CH₄-rich vapor phase from the RNG tail gas can then be removed from the distillation column and subsequently condensed to return the CH₄ to the main RNG product stream from the RNG biorefinery process/facility. In other embodiments, a cryogenic distillation process, such as a controlled freeze zone (CFZ) process or the like, can be used.

The further-refined RNG tail gas process stream can then be communicated to a reboiler. The reboiler can comprise one or more heat exchangers that are configured to heat the compressed RNG tail gas process stream. After reboiling, some additional CH₄ may be separated out from the now-purified CO₂, and the additional CH₄ can be communicated from the reboiler to the RNG biorefinery or other facility that generated the RNG tail gas. The product stream from the reboiler can now comprise a sufficiently low concentration of CH₄ and/or contaminants, and a sufficiently high concentration of CO₂, so as to be suitable for the intended purpose in terms of the quality or grade of the CO₂ product gas. After an additional (e.g., sixth) cooling/chilling stage, the CO₂ product gas can then be communicated into a storage tank or the like. When needed, a transfer pump or the like can be used to communicate one or more volumes of the CO₂ product gas out of the facility or process.

In some embodiments, the CO₂ purification/separation process 200 may need multiple cooling/chilling steps or stages such that the temperature and pressure of the RNG tail gas is sufficient going into one or more stages or steps of the CO₂ purification/separation process 200. Compression of the RNG tail gas can be controlled to vary the flow rate of RNG tail gas into the CO₂ purification/separation process 200, e.g., based on one or more factors. For example, compression and/or flow rate of the RNG tail gas can vary based on changes in mass flow rate of the RNG tail gas being received from the biorefinery and/or based upon changes in one or more of: changes in moisture content of the RNG tail gas, changes in CO₂ concentration in the RNG tail gas, changes in CH₄ concentration in the RNG tail gas, changes in density of the RNG tail gas, changes in thermal mass of the RNG tail gas, changes in a temperature of the RNG tail gas, changes in a pressure of the RNG tail gas, changes in volumetric flow rate of the RNG tail gas, and/or the like.

In some embodiments, one or more of the cooling/chilling steps or stages of the CO₂ purification/separation process 200 can be carried out using one or more of: an evaporative cooling device, a refrigerant gas cycle, a pressure-reduction chiller, a gas compression-chiller, and/or the like.

In some embodiments, the dryer stage(s) of the CO₂ purification/separation process 200 can comprise a process for chemically desiccating the RNG tail gas. Desiccation can be carried out using a liquid desiccant dehydration process, an adsorption dehydration process, a membrane separation process, or a cryogenic dehydration process. The liquid desiccant process can comprise contacting the RNG tail gas, after being compressed and chilled/cooled, with a liquid desiccant, such as triethylene glycol (TEG) in an absorber column. The TEG absorbs water vapor from the RNG tail gas. The water-rich TEG can then be regenerated by heating it in a reboiler, where water is boiled off and the TEG is recycled back to the absorber for further use in the liquid desiccant process.

Additionally or alternatively, an adsorption dehydration process can be used which passes the RNG tail gas through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the RNG tail gas to pass through the membrane(s) while retaining the CO₂ from the RNG tail gas. This approach is compact and energy-efficient, making it suitable for smaller-scale applications or where space is limited.

Additionally or alternatively, the cryogenic dehydration process can involve cooling the RNG tail gas to very low temperatures, causing water vapor from the RNG tail gas to condense and be separated as liquid water. This approach is effective for achieving very low moisture levels but is energy-intensive and typically used in conjunction with other dehydration methods.

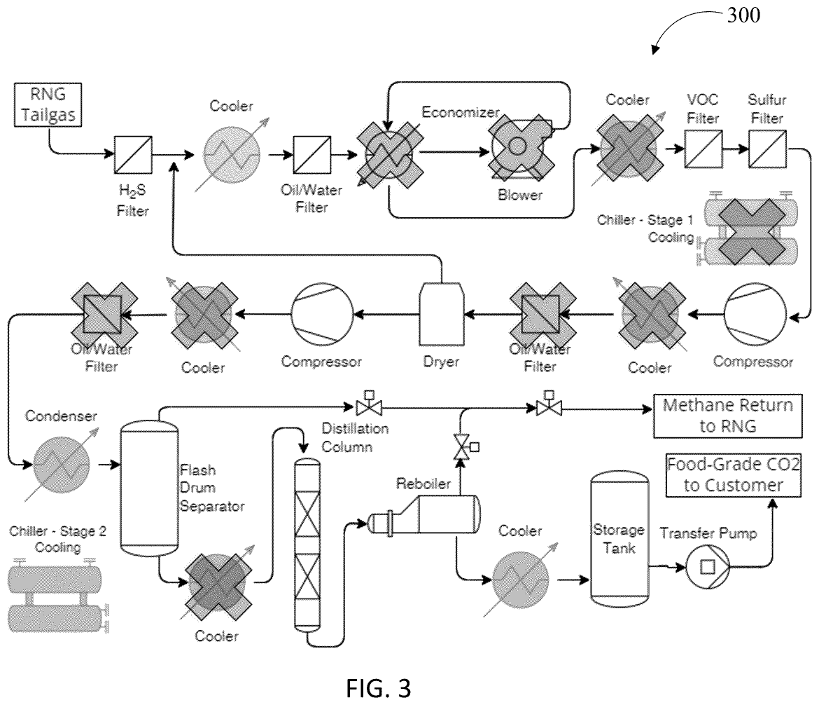

Referring now to FIG. 3, a block-flow diagram of a CO₂ purification/separation process 300 is illustrated. The CO₂ purification/separation process 300 illustrated in FIG. 3 is a modified process of the CO₂ purification/separation process 200 illustrated in FIG. 2. As compared to the CO₂ purification/separation process 200, the CO₂ purification/separation process 200 can comprise a reduced number of cooling and filtration steps, which can lead to increased process efficiency. The difference between the CO₂ purification/separation process 200 and the CO₂ purification/separation process 300 is illustrated using gray x's over the units/processes that may not need be needed in the CO₂ purification/separation process 300.

For example, while the CO₂ purification/separation process 200 is illustrated as comprising six cooling/chilling steps or stages, the CO₂ purification/separation process 300 can comprise only two cooling/chilling steps or stages. Further, the CO₂ purification/separation process 300 can operate without using an economizer/blower unit or process. The CO₂ purification/separation process 300 can likewise operate without the chiller-stage 1 cooler unit and/or without two of the three oil/water filtration processes included in the CO₂ purification/separation process 300.

In some embodiments, the initial cooling/chilling process following H₂S filtration may be configured to sufficiently reduce the temperature of the RNG tail gas process stream such that additional cooling/chilling stages are not needed before VOC/sulfur filtration, after the first or second compression stages, or after flash separation in a flash drum separator.

The input flow/stream can be or comprise any suitable CO₂-comprising or CO₂-based flow or stream. In some embodiments, the input flow/stream can be or comprise a waste stream from another facility, such as a renewable natural gas (RNG) production process, RNG upgrading process, RNG conditioning process, or another similar process. As illustrated in FIG. 3, the input (or feedstock) to the CO₂ purification/separation process 300 can be a CO₂-Comprising Feedstock (e.g., 101), such as RNG tail gas. The RNG tail gas can comprise a relatively high percentage of CO₂, which makes it a suitable (even advantageous) feedstock for the CO₂ purification/separation process 300. Since the RNG tail gas is a waste stream or byproduct/waste product flow from, e.g., an RNG upgrading/conditioning process, the CO₂ concentration in the RNG tail gas can depend at least in part on the type of process/facility creating the RNG tail gas, processing parameters of the facility creating the RNG tail gas, or the like.

In some embodiments, the CO₂ purification/separation process 300 can further comprise a compressing the RNG tail gas. Compression of the RNG tail gas can be controlled to vary the flow rate of RNG tail gas into the CO₂ purification/separation process 300, e.g., based on one or more factors. For example, compression and/or flow rate of the RNG tail gas can vary based on changes in mass flow rate of the RNG tail gas being received from the biorefinery and/or based upon changes in one or more of: changes in moisture content of the RNG tail gas, changes in CO₂ concentration in the RNG tail gas, changes in CH₄ concentration in the RNG tail gas, changes in density of the RNG tail gas, changes in thermal mass of the RNG tail gas, changes in a temperature of the RNG tail gas, changes in a pressure of the RNG tail gas, changes in volumetric flow rate of the RNG tail gas, and/or the like.

In some embodiments, the CO₂ purification/separation process 300 can further comprise cooling the RNG tail gas after the RNG tail gas is compressed. The cooling can be carried out using one or more of: an evaporative cooling device, a refrigerant gas cycle, a pressure-reduction chiller, a gas compression-chiller, and/or the like.

In some embodiments, the CO₂ purification/separation process 300 can further comprise filtering for one or more of oil, VOCs, COS, and/or the like.

In some embodiments, the CO₂ purification/separation process 300 can further comprise desiccating the RNG tail gas. Desiccation can be carried out using a liquid desiccant dehydration process, an adsorption dehydration process, a membrane separation process, or a cryogenic dehydration process. The liquid desiccant process can comprise contacting the RNG tail gas, after being compressed and chilled/cooled, with a liquid desiccant, such as triethylene glycol (TEG) in an absorber column. The TEG absorbs water vapor from the RNG tail gas. The water-rich TEG can then be regenerated by heating it in a reboiler, where water is boiled off and the TEG is recycled back to the absorber for further use in the liquid desiccant process.

Additionally or alternatively, an adsorption dehydration process can be used which passes the RNG tail gas through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the RNG tail gas to pass through the membrane(s) while retaining the CO₂ from the RNG tail gas. This approach is compact and energy-efficient, making it suitable for smaller-scale applications or where space is limited.

Additionally or alternatively, the cryogenic dehydration process can involve cooling the RNG tail gas to very low temperatures, causing water vapor from the RNG tail gas to condense and be separated as liquid water. This approach is effective for achieving very low moisture levels but is energy-intensive and typically used in conjunction with other dehydration methods.

In some embodiments, the CO₂ purification/separation process 300 can further comprise a flash separation in a flash drum separator (e.g., 106) configured to remove CH₄ from the RNG tail gas. The flash separation process leverages the differences in volatility between CH₄ and CO₂. The RNG tail gas can be (further) compressed and then heated before being introduced into the Flash Drum Separator. Upon entering the Flash Drum Separator, the RNG tail gas experiences a sudden pressure drop, causing the more volatile component(s) (e.g., CH₄) of the RNG tail gas to vaporize while the less volatile component(s) (e.g., CO₂) from the RNG tail gas remains largely in the liquid phase in the RNG tail gas.

After the CH₄-rich vapor phase is removed from the RNG tail gas and removed from the Flash Drum Separator, the CH₄-rich vapor phase of the RNG tail gas can be returned to the main RNG product stream from the RNG biorefinery process/facility.

In some embodiments, the CO₂ purification/separation process 300 can further comprise column distillation of the CO₂-rich liquid phase formed from or removed from the RNG tail gas. Column distillation of the CO₂-rich liquid phase can result in further separation of additional remaining CH₄ from the CO₂-rich liquid phase of the RNG tail gas.

In some embodiments, the column distillation can be carried out by heating the CO₂-rich liquid phase of the RNG tail gas to form CO₂ bottoms at or near the bottom of the Distillation column (e.g., 107) and further form the second CH₄-rich vapor phase from the RNG tail gas at or near the top of the distillation column. The second CH₄-rich vapor phase from the RNG tail gas can then be removed from the distillation column and subsequently condensed to return the CH₄ to the main RNG product stream from the RNG biorefinery process/facility. In other embodiments, a cryogenic distillation process, such as a controlled freeze zone (CFZ) process or the like, can be used.

In some embodiments, the CO₂ purification/separation process 300 can further comprise reducing the temperature of the CO₂ bottoms after the CO₂ bottoms are removed from the distillation column. The temperature reduction can be carried out using one or more heat exchangers, such as heat exchangers comprising a series of tubes or a series of plates that are cooled by a secondary fluid, such as water or glycol. This can cause the CO₂ bottoms removed to be communicated through, across, between, or about/nearby the series of tubes or plates in the heat exchanger(s). The secondary fluid (e.g., a refrigerant or other such pre-chilled fluid) can be communicated through, across, between, or about/nearby the series of tubes or plates in the heat exchanger(s), while being maintained out of contact with the CO₂ bottoms. By placing the CO₂ bottoms in thermal communication with the secondary fluid in the heat exchanger(s), the heat exchanger(s) allow for indirect cooling by exchanging heat from the CO₂ bottoms to the secondary fluid. Other suitable materials for the secondary fluid can include, among other materials, one or both of ammonia or Freon. Such a chilling/cooling process can be a closed-loop cooling system or a semi-closed loop cooling system.

Alternatively or additionally, the temperature reduction can be carried out using one or more quench towers in which CO₂ bottoms can be phase changed from a liquid to a gas by reducing the pressure and/or increasing the temperature of the CO₂ bottoms. The CO₂ bottoms in gas phase can then be sprayed with a cooling liquid, such as water, to rapidly reduce its temperature, which not only cools the CO₂ bottoms but also helps remove particulates and soluble impurities from the CO₂ bottoms.

Alternatively or additionally, cryogenic cooling can be used to cool the CO₂ bottoms to extremely low temperatures using liquid nitrogen or other cryogenic fluids. Cryogenic cooling operates by employing extremely low temperatures, e.g., between about −150° C. and about 0° C., to cool materials or gases. The cryogenic cooling process can begin with the compression of a cryogenic fluid, such as liquid nitrogen or helium, at room temperature, which raises its pressure and temperature. This compressed fluid is then precooled using a heat exchanger and another cooling medium, typically a refrigerant or a secondary cryogenic fluid. Following this, the fluid undergoes expansion through a valve or an expansion engine, resulting in a significant temperature drop due to the Joule-Thomson effect, where the fluid cools as it expands and its pressure decreases. The now-cold, low-pressure cryogenic fluid is then used to cool the target material or gas (i.e., CO₂ bottoms) via another heat exchanger, where it absorbs heat from the material or gas. Finally, the low-pressure fluid is cycled back to the compressor to repeat the process. Cryogenic cooling systems can comprise other components such as compressors, heat exchangers, expansion valves, and/or cryocoolers, which are specialized refrigerators designed to achieve cryogenic temperatures. Example cryogenic cooling systems can maintain extremely low temperatures.

In some embodiments, the CO₂ purification/separation process 300 can further comprise reboiling of the CO₂ bottoms by heating the CO₂ bottoms in gas phase to separate and recover valuable components. Reboiling can be carried out using one or more heat exchangers that provide(s) the necessary heat to cause separation of a gas mixture or a liquid mixture into several component parts. For example, a reboiler can be configured to heat and/or vaporize the CO₂ bottoms, thereby causing the CO₂ bottoms to vaporize. The CO₂ bottoms can then rise through a separator. In some embodiments, the separator can be or comprise a distillation column (e.g., 107). In some embodiments, in the separator, the CO₂ bottoms in vapor phase can separate into two or more different parts or portions based on differing boiling points of various constituents or components parts in the CO₂ bottoms. In the context of CO₂ bottoms separated from the RNG tail gas, the reboiling process can comprise heating the CO₂ bottoms to drive off CO₂ and other volatile components, which can then be condensed and collected. Alternatively, reboiling can be carried out to heat the CO₂ bottoms to drive off some or all of any remaining CH₄ from the CO₂ bottoms separated from the RNG tail gas. Among other options, reboiling can be carried out using one or more of: a kettle reboiler, a thermosiphon reboiler, or a forced circulation reboiler.

In some embodiments, the CO₂ purification/separation process 300 can further comprise storing or conveying one or more RNG product streams and/or one or more CO₂-rich gas streams. In some embodiments, the storage or conveyance can be of one or more of high-quality CO₂ streams and/or recovered CH₄. If the composition/purity of a high-quality CO₂ stream such as the CO₂ bottoms is sufficiently high, it can be considered a final product stream and stored/conveyed out of the system/facility.

However, if the CO₂ concentration of the CO₂ bottoms is not sufficiently high and/or undesirable materials or impurities are present at concentrations above one or more concentration thresholds, the CO₂ bottoms can be considered as an intermediate CO₂ product from the CO₂ purification/separation process 300 and can be returned to a prior stage or step of the CO₂ purification/separation process 300 for further processing.

The described/illustrated CO₂ purification/separation process 300 can be used to ensure that the RNG tail gas is sufficiently purified to meet the required specifications for various applications, such as for industrial applications, as food-grade CO₂, as beverage-grade CO₂, and/or the like. The choice(s) of specific technologies and/or hardware, and their configurations and/or processing parameters, can vary based on the initial composition of the RNG tail gas and the desired composition (e.g., purity) and/or other characteristics of the finished CO₂ product from the CO₂ purification/separation process 300.

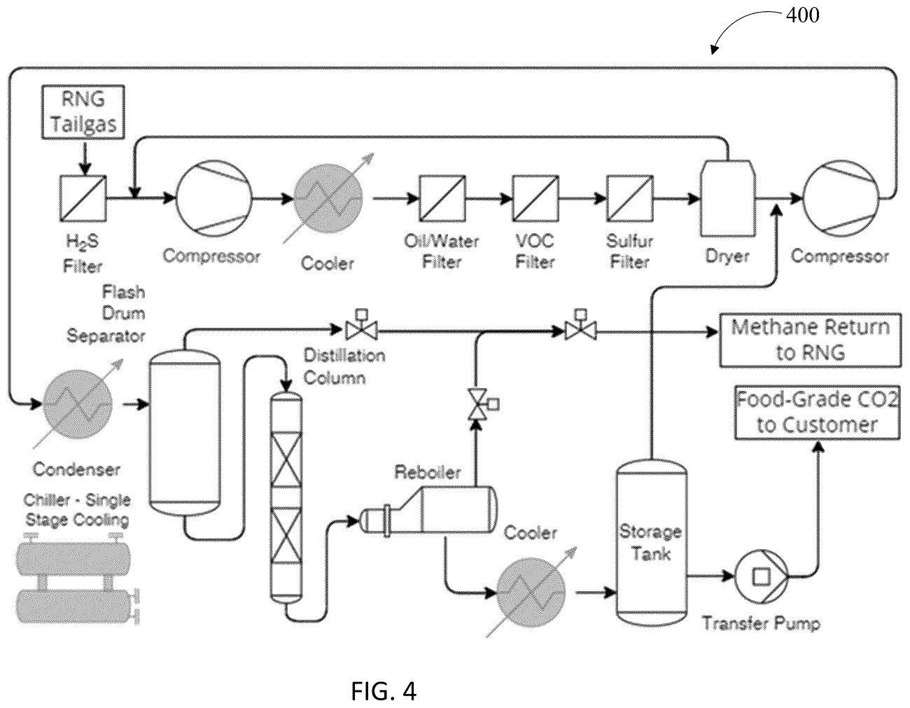

Referring now to FIG. 4, a CO₂ purification/separation process 400 is illustrated in simplified block-flow diagram form. The CO₂ purification/separation process 400 may comprise similar steps, stages, units, elements, equipment, or sub-processes to selected ones of those used in CO₂ purification/separation process 200 and/or the CO₂ purification/separation process 300.

As compared to the CO₂ purification/separation process 200, the CO₂ purification/separation process 400 can comprise a reduced number of cooling and filtration steps, which can lead to increased process efficiency. The difference between the CO₂ purification/separation process 200 and the CO₂ purification/separation process 400 can comprise more efficient compression processes, more effective CH₄/CO₂ separation at lower temperatures, and/or improved process efficiency.

For example, while the CO₂ purification/separation process 200 is illustrated as comprising six cooling/chilling steps or stages, the CO₂ purification/separation process 400 can comprise only two cooling/chilling steps or stages. Further, the CO₂ purification/separation process 400 can operate without using an economizer/blower unit or process. The CO₂ purification/separation process 400 can likewise operate without the chiller—stage 1 cooler unit and/or without two of the three oil/water filtration processes included in the CO₂ purification/separation process 400.

In some embodiments, the initial cooling/chilling process following H₂S filtration may be configured to sufficiently reduce the temperature of the RNG tail gas process stream such that additional cooling/chilling stages are not needed before VOC/sulfur filtration, after the first or second compression stages, or after flash separation in a flash drum separator.

The input flow/stream can be or comprise any suitable CO₂-comprising or CO₂-based flow or stream. In some embodiments, the input flow/stream can be or comprise a waste stream from another facility, such as a renewable natural gas (RNG) production process, RNG upgrading process, RNG conditioning process, or another similar process. As illustrated in FIG. 4, the input (or feedstock) to the CO₂ purification/separation process 400 can be a CO₂-Comprising Feedstock (e.g., 101), such as RNG tail gas. The RNG tail gas can comprise a relatively high percentage of CO₂, which makes it a suitable (even advantageous) feedstock for the CO₂ purification/separation process 400. Since the RNG tail gas is a waste stream or byproduct/waste product flow from, e.g., an RNG upgrading/conditioning process, the CO₂ concentration in the RNG tail gas can depend at least in part on the type of process/facility creating the RNG tail gas, processing parameters of the facility creating the RNG tail gas, or the like.

In some embodiments, the CO₂ purification/separation process 400 can further comprise a compressing the RNG tail gas. Compression of the RNG tail gas can be controlled to vary the flow rate of RNG tail gas into the CO₂ purification/separation process 400, e.g., based on one or more factors. For example, compression and/or flow rate of the RNG tail gas can vary based on changes in mass flow rate of the RNG tail gas being received from the biorefinery and/or based upon changes in one or more of: changes in moisture content of the RNG tail gas, changes in CO₂ concentration in the RNG tail gas, changes in CH₄ concentration in the RNG tail gas, changes in density of the RNG tail gas, changes in thermal mass of the RNG tail gas, changes in a temperature of the RNG tail gas, changes in a pressure of the RNG tail gas, changes in volumetric flow rate of the RNG tail gas, and/or the like.

In some embodiments, the CO₂ purification/separation process 400 can further comprise cooling the RNG tail gas after the RNG tail gas is compressed. The cooling can be carried out using one or more of: an evaporative cooling device, a refrigerant gas cycle, a pressure-reduction chiller, a gas compression-chiller, and/or the like.

In some embodiments, the CO₂ purification/separation process 400 can further comprise filtering for one or more of oil, VOCs, COS, and/or the like.

In some embodiments, the CO₂ purification/separation process 400 can further comprise desiccating the RNG tail gas. Desiccation can be carried out using a liquid desiccant dehydration process, an adsorption dehydration process, a membrane separation process, or a cryogenic dehydration process. The liquid desiccant process can comprise contacting the RNG tail gas, after being compressed and chilled/cooled, with a liquid desiccant, such as triethylene glycol (TEG) in an absorber column. The TEG absorbs water vapor from the RNG tail gas. The water-rich TEG can then be regenerated by heating it in a reboiler, where water is boiled off and the TEG is recycled back to the absorber for further use in the liquid desiccant process.

Additionally or alternatively, an adsorption dehydration process can be used which passes the RNG tail gas through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the RNG tail gas to pass through the membrane(s) while retaining the CO₂ from the RNG tail gas. This approach is compact and energy-efficient, making it suitable for smaller-scale applications or where space is limited.

Additionally or alternatively, the cryogenic dehydration process can involve cooling the RNG tail gas to very low temperatures, causing water vapor from the RNG tail gas to condense and be separated as liquid water. This approach is effective for achieving very low moisture levels but is energy-intensive and typically used in conjunction with other dehydration methods.

In some embodiments, the CO₂ purification/separation process 400 can further comprise a flash separation in a flash drum separator (e.g., 106) configured to remove CH₄ from the RNG tail gas. The flash separation process leverages the differences in volatility between CH₄ and CO₂. The RNG tail gas can be (further) compressed and then heated before being introduced into the Flash Drum Separator. Upon entering the Flash Drum Separator, the RNG tail gas experiences a sudden pressure drop, causing the more volatile component(s) (e.g., CH₄) of the RNG tail gas to vaporize while the less volatile component(s) (e.g., CO₂) from the RNG tail gas remains largely in the liquid phase in the RNG tail gas.

After the CH₄-rich vapor phase is removed from the RNG tail gas and removed from the Flash Drum Separator, the CH₄-rich vapor phase of the RNG tail gas can be returned to the main RNG product stream from the RNG biorefinery process/facility.

In some embodiments, the CO₂ purification/separation process 400 can further comprise column distillation of the CO₂-rich liquid phase formed from or removed from the RNG tail gas. Column distillation of the CO₂-rich liquid phase can result in further separation of additional remaining CH₄ from the CO₂-rich liquid phase of the RNG tail gas.

In some embodiments, the column distillation can be carried out by heating the CO₂-rich liquid phase of the RNG tail gas to form CO₂ bottoms at or near the bottom of the distillation column (e.g., 107) and further form the second CH₄-rich vapor phase from the RNG tail gas at or near the top of the distillation column. The second CH₄-rich vapor phase from the RNG tail gas can then be removed from the distillation column and subsequently condensed to return the CH₄ to the main RNG product stream from the RNG biorefinery process/facility. In other embodiments, a cryogenic distillation process, such as a CFZ process or the like, can be used.

In some embodiments, the CO₂ purification/separation process 400 can further comprise reducing the temperature of the CO₂ bottoms after the CO₂ bottoms are removed from the distillation column. The temperature reduction can be carried out using one or more heat exchangers, such as heat exchangers comprising a series of tubes or a series of plates that are cooled by a secondary fluid, such as water or glycol. This can cause the CO₂ bottoms removed to be communicated through, across, between, or about/nearby the series of tubes or plates in the heat exchanger(s). The secondary fluid (e.g., a refrigerant or other such pre-chilled fluid) can be communicated through, across, between, or about/nearby the series of tubes or plates in the heat exchanger(s), while being maintained out of contact with the CO₂ bottoms. By placing the CO₂ bottoms in thermal communication with the secondary fluid in the heat exchanger(s), the heat exchanger(s) allow for indirect cooling by exchanging heat from the CO₂ bottoms to the secondary fluid. Other suitable materials for the secondary fluid can include, among other materials, one or both of ammonia or Freon. Such a chilling/cooling process can be a closed-loop cooling system or a semi-closed loop cooling system.

Alternatively or additionally, the temperature reduction can be carried out using one or more quench towers in which CO₂ bottoms can be phase changed from a liquid to a gas by reducing the pressure and/or increasing the temperature of the CO₂ bottoms. The CO₂ bottoms in gas phase can then be sprayed with a cooling liquid, such as water, to rapidly reduce its temperature, which not only cools the CO₂ bottoms but also helps remove particulates and soluble impurities from the CO₂ bottoms.

Alternatively or additionally, cryogenic cooling can be used to cool the CO₂ bottoms to extremely low temperatures using liquid nitrogen or other cryogenic fluids. Cryogenic cooling operates by employing extremely low temperatures, e.g., between about −150° C. and about 0° C., to cool materials or gases. The cryogenic cooling process can begin with the compression of a cryogenic fluid, such as liquid nitrogen or helium, at room temperature, which raises its pressure and temperature. This compressed fluid is then precooled using a heat exchanger and another cooling medium, typically a refrigerant or a secondary cryogenic fluid. Following this, the fluid undergoes expansion through a valve or an expansion engine, resulting in a significant temperature drop due to the Joule-Thomson effect, where the fluid cools as it expands and its pressure decreases. The now-cold, low-pressure cryogenic fluid is then used to cool the target material or gas (i.e., CO₂ bottoms) via another heat exchanger, where it absorbs heat from the material or gas. Finally, the low-pressure fluid is cycled back to the compressor to repeat the process. Cryogenic cooling systems can comprise other components such as compressors, heat exchangers, expansion valves, and/or cryocoolers, which are specialized refrigerators designed to achieve cryogenic temperatures. Example cryogenic cooling systems can maintain extremely low temperatures.

In some embodiments, the CO₂ purification/separation process 400 can further comprise reboiling of the CO₂ bottoms by heating the CO₂ bottoms in gas phase to separate and recover valuable components. Reboiling can be carried out using one or more heat exchangers that provide(s) the necessary heat to cause separation of a gas mixture or a liquid mixture into several component parts. For example, a reboiler can be configured to heat and/or vaporize the CO₂ bottoms, thereby causing the CO₂ bottoms to vaporize. The CO₂ bottoms can then rise through a separator. In some embodiments, the separator can be or comprise a distillation column (e.g., 107). In some embodiments, in the separator, the CO₂ bottoms in vapor phase can separate into two or more different parts or portions based on differing boiling points of various constituents or components parts in the CO₂ bottoms. In the context of CO₂ bottoms separated from the RNG tail gas, the reboiling process can comprise heating the CO₂ bottoms to drive off CO₂ and other volatile components, which can then be condensed and collected. Alternatively, reboiling can be carried out to heat the CO₂ bottoms to drive off some or all of any remaining CH₄ from the CO₂ bottoms separated from the RNG tail gas. Among other options, reboiling can be carried out using one or more of: a kettle reboiler, a thermosiphon reboiler, or a forced circulation reboiler.

In some embodiments, the CO₂ purification/separation process 400 can further comprise storing or conveying one or more RNG product streams and/or one or more CO₂-rich gas streams. In some embodiments, the storage or conveyance can be of one or more of high-quality CO₂ streams and/or recovered CH₄. If the composition/purity of a high-quality CO₂ stream such as the CO₂ bottoms is sufficiently high, it can be considered a final product stream and stored/conveyed out of the system/facility.

However, if the CO₂ concentration of the CO₂ bottoms is not sufficiently high and/or undesirable materials or impurities are present at concentrations above one or more concentration thresholds, the CO₂ bottoms can be considered as an intermediate CO₂ product from the CO₂ purification/separation process 400 and can be returned to a prior stage or step of the CO₂ purification/separation process 400 for further processing.

The described/illustrated CO₂ purification/separation process 400 can be used to ensure that the RNG tail gas is sufficiently purified to meet the required specifications for various applications, such as for industrial applications, as food-grade CO₂, as beverage-grade CO₂, and/or the like. The choice(s) of specific technologies and/or hardware, and their configurations and/or processing parameters, can vary based on the initial composition of the RNG tail gas and the desired composition (e.g., purity) and/or other characteristics of the finished CO₂ product from the CO₂ purification/separation process 400.

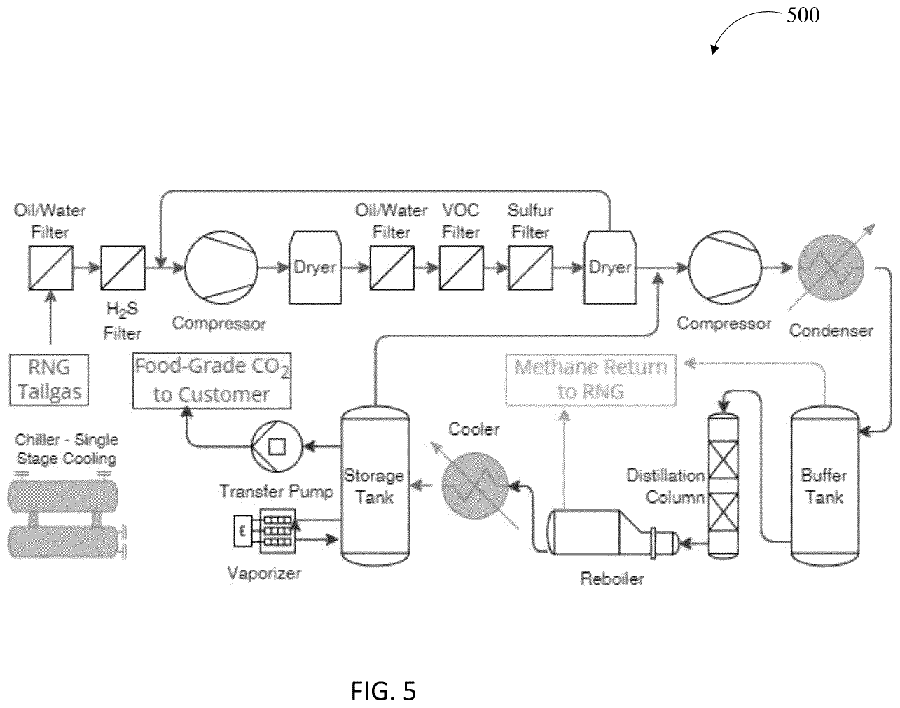

Referring now to FIG. 5, a CO₂ purification/separation process 500 is illustrated in simplified block-flow diagram form. The CO₂ purification/separation process 500 may comprise similar steps, stages, units, elements, equipment, or sub-processes to selected ones of those used in other CO₂ purification/separation processes described herein (e.g., 200, 300, or 400). As compared to the CO₂ purification/separation process 200, the CO₂ purification/separation process 500 can comprise a reduced number of cooling and filtration steps, which can lead to increased process efficiency. The difference between the CO₂ purification/separation process 200 and the CO₂ purification/separation process 500 can comprise more efficient compression processes, more effective CHA/CO₂ separation at lower temperatures, and/or improved process efficiency.

For example, while the CO₂ purification/separation process 200 is illustrated as comprising six cooling/chilling steps or stages, the CO₂ purification/separation process 500 can comprise only a single cooling/chilling step or stage. Further, the CO₂ purification/separation process 500 can operate without using an economizer/blower unit or process. The CO₂ purification/separation process 500 can likewise operate without the chiller-stage 2 cooler unit and/or without one of the three oil/water filtration processes included in the CO₂ purification/separation process 200.

In some embodiments, the initial cooling/chilling process following H₂S filtration may be configured to sufficiently reduce the temperature of the RNG tail gas process stream such that additional cooling/chilling stages are not needed before VOC/sulfur filtration, after the first or second compression stages, or after flash separation in a flash drum separator.

The input flow/stream can be or comprise any suitable CO₂-comprising or CO₂-based flow or stream. In some embodiments, the input flow/stream can be or comprise a waste stream from another facility, such as a renewable natural gas (RNG) production process, RNG upgrading process, RNG conditioning process, or another similar process. As illustrated in FIG. 5, the input (or feedstock) to the CO₂ purification/separation process 500 can be a CO₂-Comprising Feedstock (e.g., 101), such as RNG tail gas. The RNG tail gas can comprise a relatively high percentage of CO₂, which makes it a suitable (even advantageous) feedstock for the CO₂ purification/separation process 500. Since the RNG tail gas is a waste stream or byproduct/waste product flow from, e.g., an RNG upgrading/conditioning process, the CO₂ concentration in the RNG tail gas can depend at least in part on the type of process/facility creating the RNG tail gas, processing parameters of the facility creating the RNG tail gas, or the like.

In some embodiments, the CO₂ purification/separation process 500 can further comprise a compressing the RNG tail gas. Compression of the RNG tail gas can be controlled to vary the flow rate of RNG tail gas into the CO₂ purification/separation process 500, e.g., based on one or more factors. For example, compression and/or flow rate of the RNG tail gas can vary based on changes in mass flow rate of the RNG tail gas being received from the biorefinery and/or based upon changes in one or more of: changes in moisture content of the RNG tail gas, changes in CO₂ concentration in the RNG tail gas, changes in CH₄ concentration in the RNG tail gas, changes in density of the RNG tail gas, changes in thermal mass of the RNG tail gas, changes in a temperature of the RNG tail gas, changes in a pressure of the RNG tail gas, changes in volumetric flow rate of the RNG tail gas, and/or the like.

In some embodiments, the CO₂ purification/separation process 500 can further comprise cooling the RNG tail gas after the RNG tail gas is compressed. The cooling can be carried out using one or more of: an evaporative cooling device, a refrigerant gas cycle, a pressure-reduction chiller, a gas compression-chiller, and/or the like.

In some embodiments, the CO₂ purification/separation process 500 can further comprise filtering for one or more of oil, VOCs, COS, and/or the like.

In some embodiments, the CO₂ purification/separation process 500 can further comprise desiccating the RNG tail gas. Desiccation can be carried out using a liquid desiccant dehydration process, an adsorption dehydration process, a membrane separation process, or a cryogenic dehydration process. The liquid desiccant process can comprise contacting the RNG tail gas, after being compressed and chilled/cooled, with a liquid desiccant, such as TEG in an absorber column. The TEG absorbs water vapor from the RNG tail gas. The water-rich TEG can then be regenerated by heating it in a reboiler, where water is boiled off and the TEG is recycled back to the absorber for further use in the liquid desiccant process.

Additionally or alternatively, an adsorption dehydration process can be used which passes the RNG tail gas through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the RNG tail gas to pass through the membrane(s) while retaining the CO₂ from the RNG tail gas. This approach is compact and energy-efficient, making it suitable for smaller-scale applications or where space is limited.

Additionally or alternatively, the cryogenic dehydration process can involve cooling the RNG tail gas to very low temperatures, causing water vapor from the RNG tail gas to condense and be separated as liquid water. This approach is effective for achieving very low moisture levels but is energy-intensive and typically used in conjunction with other dehydration methods.

In some embodiments, the CO₂ purification/separation process 500 can further comprise a flash separation in a flash drum separator (e.g., 106) configured to remove CH₄ from the RNG tail gas. The flash separation process leverages the differences in volatility between CH₄ and CO₂. The RNG tail gas can be (further) compressed and then heated before being introduced into the Flash Drum Separator. Upon entering the Flash Drum Separator, the RNG tail gas experiences a sudden pressure drop, causing the more volatile component(s) (e.g., CH₄) of the RNG tail gas to vaporize while the less volatile component(s) (e.g., CO₂) from the RNG tail gas remains largely in the liquid phase in the RNG tail gas.

After the CH₄-rich vapor phase is removed from the RNG tail gas and removed from the Flash Drum Separator, the CH₄-rich vapor phase of the RNG tail gas can be returned to the main RNG product stream from the RNG biorefinery process/facility.

In some embodiments, the CO₂ purification/separation process 500 can further comprise column distillation of the CO₂-rich liquid phase formed from or removed from the RNG tail gas. Column distillation of the CO₂-rich liquid phase can result in further separation of additional remaining CH₄ from the CO₂-rich liquid phase of the RNG tail gas.

In some embodiments, the column distillation can be carried out by heating the CO₂-rich liquid phase of the RNG tail gas to form CO₂ bottoms at or near the bottom of the distillation column (e.g., 107) and further form the second CH₄-rich vapor phase from the RNG tail gas at or near the top of the distillation column. The second CH₄-rich vapor phase from the RNG tail gas can then be removed from the distillation column and subsequently condensed to return the CH₄ to the main RNG product stream from the RNG biorefinery process/facility. In other embodiments, a cryogenic distillation process, such as a CFZ process or the like, can be used.

In some embodiments, the CO₂ purification/separation process 500 can further comprise reducing the temperature of the CO₂ bottoms after the CO₂ bottoms are removed from the distillation column. The temperature reduction can be carried out using one or more heat exchangers, such as heat exchangers comprising a series of tubes or a series of plates that are cooled by a secondary fluid, such as water or glycol. This can cause the CO₂ bottoms removed to be communicated through, across, between, or about/nearby the series of tubes or plates in the heat exchanger(s). The secondary fluid (e.g., a refrigerant or other such pre-chilled fluid) can be communicated through, across, between, or about/nearby the series of tubes or plates in the heat exchanger(s), while being maintained out of contact with the CO₂ bottoms. By placing the CO₂ bottoms in thermal communication with the secondary fluid in the heat exchanger(s), the heat exchanger(s) allow for indirect cooling by exchanging heat from the CO₂ bottoms to the secondary fluid. Other suitable materials for the secondary fluid can include, among other materials, one or both of ammonia or Freon. Such a chilling/cooling process can be a closed-loop cooling system or a semi-closed loop cooling system.

Alternatively or additionally, the temperature reduction can be carried out using one or more quench towers in which CO₂ bottoms can be phase changed from a liquid to a gas by reducing the pressure and/or increasing the temperature of the CO₂ bottoms. The CO₂ bottoms in gas phase can then be sprayed with a cooling liquid, such as water, to rapidly reduce its temperature, which not only cools the CO₂ bottoms but also helps remove particulates and soluble impurities from the CO₂ bottoms.

Alternatively or additionally, cryogenic cooling can be used to cool the CO₂ bottoms to extremely low temperatures using liquid nitrogen or other cryogenic fluids. Cryogenic cooling operates by employing extremely low temperatures, e.g., between about −150° C. and about 0° C., to cool materials or gases. The cryogenic cooling process can begin with the compression of a cryogenic fluid, such as liquid nitrogen or helium, at room temperature, which raises its pressure and temperature. This compressed fluid is then precooled using a heat exchanger and another cooling medium, typically a refrigerant or a secondary cryogenic fluid. Following this, the fluid undergoes expansion through a valve or an expansion engine, resulting in a significant temperature drop due to the Joule-Thomson effect, where the fluid cools as it expands and its pressure decreases. The now-cold, low-pressure cryogenic fluid is then used to cool the target material or gas (i.e., CO₂ bottoms) via another heat exchanger, where it absorbs heat from the material or gas. Finally, the low-pressure fluid is cycled back to the compressor to repeat the process. Cryogenic cooling systems can comprise other components such as compressors, heat exchangers, expansion valves, and/or cryocoolers, which are specialized refrigerators designed to achieve cryogenic temperatures. Example cryogenic cooling systems can maintain extremely low temperatures.

In some embodiments, the CO₂ purification/separation process 500 can further comprise reboiling of the CO₂ bottoms by heating the CO₂ bottoms in gas phase to separate and recover valuable components. Reboiling can be carried out using one or more heat exchangers that provide(s) the necessary heat to cause separation of a gas mixture or a liquid mixture into several component parts. For example, a reboiler can be configured to heat and/or vaporize the CO₂ bottoms, thereby causing the CO₂ bottoms to vaporize. The CO₂ bottoms can then rise through a separator. In some embodiments, the separator can be or comprise a distillation column (e.g., 107). In some embodiments, in the separator, the CO₂ bottoms in vapor phase can separate into two or more different parts or portions based on differing boiling points of various constituents or components parts in the CO₂ bottoms. In the context of CO₂ bottoms separated from the RNG tail gas, the reboiling process can comprise heating the CO₂ bottoms to drive off CO₂ and other volatile components, which can then be condensed and collected. Alternatively, reboiling can be carried out to heat the CO₂ bottoms to drive off at least a portion of any remaining CH₄ from the CO₂ bottoms separated from the RNG tail gas. Among other options, reboiling can be carried out using one or more of: a kettle reboiler, a thermosiphon reboiler, or a forced circulation reboiler.

In some embodiments, the CO₂ purification/separation process 500 can further comprise storing or conveying one or more RNG product streams and/or one or more CO₂-rich gas streams. In some embodiments, the storage or conveyance can be of one or more of high-quality CO₂ streams and/or recovered CH₄. If the composition/purity of a high-quality CO₂ stream such as the CO₂ bottoms is sufficiently high, it can be considered a final product stream and stored/conveyed out of the system/facility.

However, if the CO₂ concentration of the CO₂ bottoms is not sufficiently high and/or undesirable materials or impurities are present at concentrations above one or more concentration thresholds, the CO₂ bottoms can be considered as an intermediate CO₂ product from the CO₂ purification/separation process 500 and can be returned to a prior stage or step of the CO₂ purification/separation process 500 for further processing.

The described/illustrated CO₂ purification/separation process 500 can be used to ensure that the RNG tail gas is sufficiently purified to meet the required specifications for various applications, such as for industrial applications, as food-grade CO₂, as beverage-grade CO₂, and/or the like. The choice(s) of specific technologies and/or hardware, and their configurations and/or processing parameters, can vary based on the initial composition of the RNG tail gas and the desired composition (e.g., purity) and/or other characteristics of the finished CO₂ product from the CO₂ purification/separation process 500. In some embodiments, the finished CO₂ product can be vaporized in a vaporizer or the like. In some embodiments, the single-stage chiller can be used to chill the RNG tail gas prior to any filtration or compression. In other embodiments, the single-stage chiller can be used to chill the RNG tail gas after initial filtration and compression but before any fractionation or separation processes.

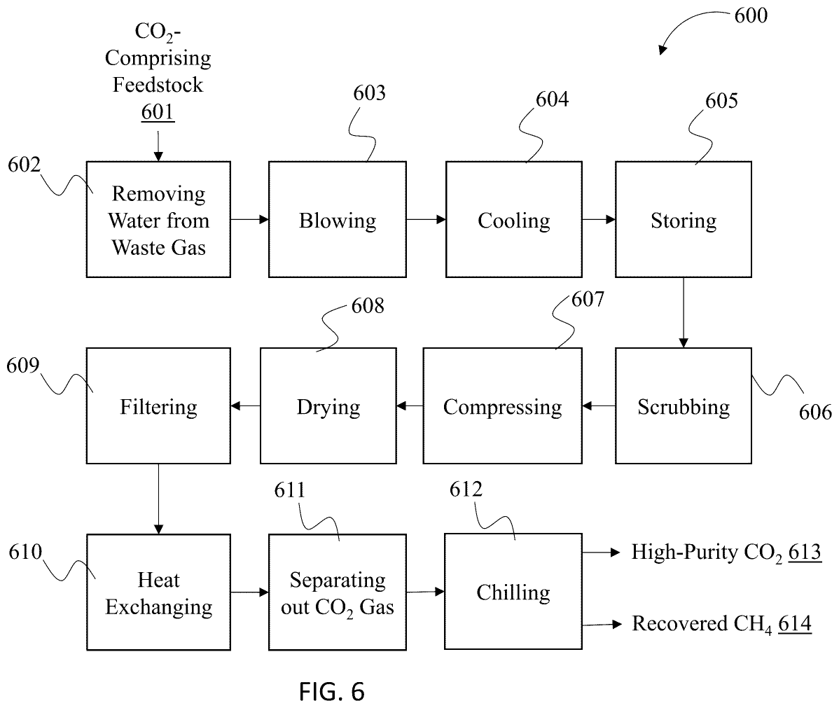

Referring now to FIG. 6, a CO₂ purification/separation process 600 is illustrated in simplified block-flow diagram form. The CO₂ purification/separation process 600 may comprise similar steps, stages, units, elements, equipment, or sub-processes to selected ones of those used in other CO₂ purification/separation processes described herein (e.g., 200, 300, 400, or 500). As compared to the CO₂ purification/separation process 200, for example, the CO₂ purification/separation process 600 can comprise a reduced number of cooling and filtration steps, which can lead to increased process efficiency. The difference between the CO₂ purification/separation process 200 and the CO₂ purification/separation process 600 can comprise more efficient compression processes, more effective CH₄/CO₂ separation at lower temperatures, and/or improved process efficiency.

For example, while the CO₂ purification/separation process 200 is illustrated as comprising six cooling/chilling operations, the CO₂ purification/separation process 600 can comprise less (e.g., one or two) cooling/chilling operation(s). Further, the CO₂ purification/separation process 600 can operate without using an economizer/blower unit or process. The CO₂ purification/separation process 600 can likewise operate without the chiller—stage 2 cooler unit and/or without one of the three oil/water filtration processes included in the CO₂ purification/separation process 200.

As illustrated in FIG. 6, the CO₂ purification/separation process 600 comprises inputting a CO₂-comprising feedstock 601, which can comprise, include, or be a waste stream, a tail gas, or the like. The CO₂ purification/separation process 600 can further comprise removing water from the waste gas 602, e.g., the CO₂-comprising feedstock 601. In some embodiments, the removing water from the waste gas 602 can be carried out using one or more filters, such as a coalescence filter.

After removing water from the waste gas 602, the CO₂ purification/separation process 600 can further comprise one or more blowing 603 operations and one or more cooling 604 operations.

The CO₂ purification/separation process 600 can further comprise storing 605 the CO₂-comprising feedstock 601 following the removing water from the waste gas 602, the blowing 603, and after the cooling 604. Storing 605 can be carried out in one or more buffer tanks, or the like.

The CO₂ purification/separation process 600 can further comprise, after storing 605, a one or more scrubbing 606 operations. In some embodiments, scrubbing 606 can comprise, e.g., H₂S filtration, VOC filtration, sulfur filtration, and/or the like.

The CO₂ purification/separation process 600 can further comprise one or more compressing 607 operations. Compressing 607 can be carried out using one or more booster compressors, or the like. After compressing 607, the CO₂ purification/separation process 600 can further comprise one or more drying 608 operations. Without wishing to be bound by any particular theory, compressing 607 before drying 608 can increase the efficiency and/or effectiveness of drying 608. Drying 608 can be carried out using any suitable gas drying operation(s) or device(s), e.g., a desiccant-based gas drying device or system.

The CO₂ purification/separation process 600 can further comprise one or more filtering 609 operations. Filtering 609 may be performed to remove, e.g., bacteria, debris, particulates, oil, VOCs, COS, and/or the like. In some embodiments, filtering 609 before performing other, subsequent operations of the CO₂ purification/separation process 600 can reduce the fouling of equipment during those subsequent operations, can increase the efficiency and efficacy of those subsequent operations, and can improve the overall quality of one or more final product stream(s) of the CO₂ purification/separation process 600, etc.

The CO₂ purification/separation process 600 can further comprise one or more heat exchanging 610 operations. Heat exchanging 610 can be performed using any suitable heat exchanger or similar device/system, such as a shell & tube heat exchanger, a gas/gas heat exchanger, a plate heat exchanger, a tube-in-tube heat exchanger, a double tube heat exchanger, and/or the like. Heat exchanging 610 can be performed to change an average temperature of the filtered, cooled, and at least partially de-watered CO₂-Comprising feedstock 601. For example, heat exchanging 610 can be performed to increase the average temperature of the filtered, cooled, and at least partially de-watered CO₂-Comprising feedstock 601 before subsequent steps of the CO₂ purification/separation process 600, such as subsequent steps that require or are improved by the average temperature of the gas stream being at least somewhat elevated relative to the average temperature of the gas stream at one or more points between an outlet of cooling 604 and an outlet of filtering 609.

After heat exchanging 610, the CO₂ purification/separation process 600 can further comprise separating out CO₂ gas 611. Separating out CO₂ gas 611 can be performed using any suitable procedure, approach, subprocess, equipment, device, or subsystem. For example, separating out CO₂ gas 611 can be performed using one or more distillation columns. In other examples, separating out CO₂ gas 611 can be performed using one or more membrane separation filters. In still other examples, separating out CO₂ gas 611 can be performed using direct air capture. In other examples, separating out CO₂ gas 611 can be performed using one or more liquid solvents and/or solid sorbents. In yet other examples, separating out CO₂ gas 611 can be performed using electrode/electrochemical attraction or electrocatalytic process(es). In other examples, separating out CO₂ gas 611 can be performed using mineral or zeolitic scrubbing. In other examples, separating out CO₂ gas 611 can be performed using one or more platform chemistry processes, such as the Sabatier process to form methane and water. In other examples, separating out CO₂ gas 611 can be performed using plasma splitting. In other examples, separating out CO₂ gas 611 can be performed by biochemical (e.g., enzymatic) formation of synthetic fuels or platform chemicals.

After separating out CO₂ gas 611, the CO₂ purification/separation process 600 further comprises chilling 612. After chilling 612, one or more product streams can be output to, e.g., a storage tank. In some embodiments, after chilling 612, the CO₂ purification/separation process 600 comprises outputting a high-purity CO₂ 613 stream. In some embodiments, after chilling 612, the CO₂ purification/separation process 600 comprises outputting a recovered CH₄ 614 stream.

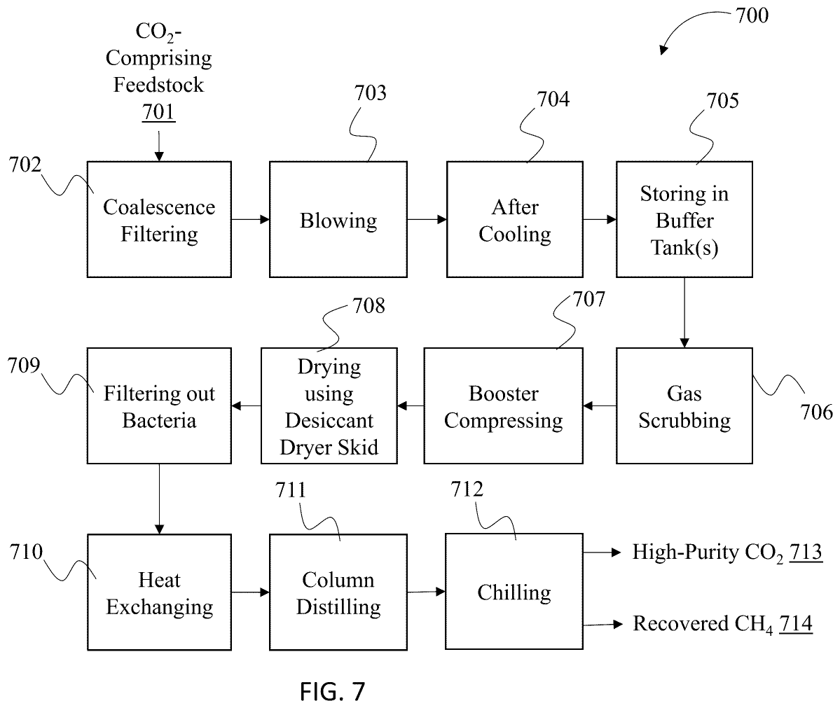

Referring now to FIG. 7, a CO₂ purification/separation process 700 is illustrated in simplified block-flow diagram form. The CO₂ purification/separation process 700 may comprise similar steps, stages, units, elements, equipment, or sub-processes to selected ones of those used in other CO₂ purification/separation processes described herein (e.g., 200, 300, 400, 500, or 600). As compared to the CO₂ purification/separation process 200, for example, the CO₂ purification/separation process 700 can comprise a reduced number of cooling and filtration steps, which can lead to increased process efficiency. The difference between the CO₂ purification/separation process 200 and the CO₂ purification/separation process 700 can comprise more efficient compression processes, more effective CH₄/CO₂ separation at lower temperatures, and/or improved process efficiency.

For example, while the CO₂ purification/separation process 200 is illustrated as comprising six cooling/chilling operations, the CO₂ purification/separation process 700 can comprise less (e.g., one or two) cooling/chilling operation(s). Further, the CO₂ purification/separation process 700 can operate without using an economizer/blower unit or process. The CO₂ purification/separation process 700 can likewise operate without the chiller-stage 2 cooler unit and/or without one of the three oil/water filtration processes included in the CO₂ purification/separation process 200.

As illustrated in FIG. 7, the CO₂ purification/separation process 700 comprises inputting a CO₂-comprising feedstock 701, which can comprise, include, or be a waste stream, a tail gas, or the like. The CO₂ purification/separation process 700 can further comprise coalescence filtering 702 to remove water from the CO₂-Comprising Feedstock 701. In some embodiments, the coalescence filtering 702 can be carried out using one or a plurality of coalescence filter(s).

After coalescence filtering 702, the CO₂ purification/separation process 700 can further comprise one or more blowing 703 operations and one or more after cooling 704 operations.

In some embodiments, after cooling 704 can be performed after blowing 703. After cooling 704 can be carried out using one or more of: an evaporative cooling device, a refrigerant gas cycle, a pressure-reduction chiller, a gas compression-chiller, and/or the like.

The CO₂ purification/separation process 700 can further comprise storing in buffer tank(s) 705 the CO₂-comprising feedstock 701, following coalescence filtering 702, blowing 703, and after cooling 704. Storing in buffer tank(s) 705 can be carried out in one or a plurality of buffer tanks, or the like.

The CO₂ purification/separation process 700 can further comprise, after storing in buffer tank(s) 705, a one or more gas scrubbing 706 operations. In some embodiments, gas scrubbing 706 can comprise, e.g., H₂S filtration, VOC filtration, sulfur filtration, and/or the like.

The CO₂ purification/separation process 700 can further comprise one or more booster compressing 707 operations. Booster compressing 707 can be carried out using one or a plurality of compressors, or the like. After booster compressing 707, the CO₂ purification/separation process 700 can further comprise one or more drying using desiccant dryer skid 708 operations. Without wishing to be bound by any particular theory, booster compressing 707 the CO₂-Comprising Feedstock 701 after coalescence filter 702 and gas scrubbing 706 but before drying using desiccant dryer skid 708 can increase the efficiency and/or effectiveness of drying using desiccant dryer skid 708. Drying using desiccant dryer skid 708 can be carried out using any suitable desiccant or combination of desiccants.

Drying using desiccant dryer skid 708 can be carried out using a liquid desiccant process, a solid desiccant process, a gaseous desiccant process, an adsorption dehydration process, or the like. In some embodiments, one or more additional drying or dehydration processes can be performed as part of (or in addition to) drying using desiccant dryer skid 708, such as a membrane separation process, a cryogenic dehydration process, etc. In some embodiments, a liquid desiccant process can comprise contacting the RNG tail gas, after blowing 703 and after cooling 704, with a liquid desiccant, such as TEG in an absorber column. The TEG absorbs water vapor from the CO₂-comprising feedstock 701 gas. Water-rich TEG can then be regenerated by heating it in a reboiler, where water is boiled off and the TEG is recycled back to the absorber for further use in the liquid desiccant process.

Additionally or alternatively, an adsorption dehydration process can be used which passes the CO₂-comprising feedstock 701 gas through solid desiccants such as silica gel, activated alumina, or molecular sieves. These materials have high surface areas and pore structures that adsorb water molecules. The adsorbent is periodically regenerated by heating or applying a vacuum to remove the adsorbed water.

Additionally or alternatively, a membrane separation process can be used to selectively allow water vapor from the CO₂-comprising feedstock 701 gas to pass through the membrane(s) while retaining the CO₂ from the CO₂-comprising feedstock 701 gas. This approach is compact and energy-efficient, making it suitable for smaller-scale applications or where space is limited.

Additionally or alternatively, the cryogenic dehydration process can involve cooling the CO₂-comprising feedstock 701 gas to very low temperatures, causing water vapor from the CO₂-comprising feedstock 701 gas to condense and be separated as liquid water. This approach is effective for achieving very low moisture levels but is energy-intensive and typically used in conjunction with other dehydration methods.

The CO₂ purification/separation process 700 can further comprise one or more filtering out bacteria 709 operations. Filtering out bacteria 709 may be performed to remove bacteria that would otherwise cause fouling or reduce efficiency/efficacy of subsequent processes, such as CO₂ separation or heat exchanging processes later in the CO₂ purification/separation process 700.

The CO₂ purification/separation process 700 can further comprise one or more heat exchanging 710 operations. Heat exchanging 710 can be performed using any suitable heat exchanger or similar device/system, such as a shell & tube heat exchanger, a gas/gas heat exchanger, a plate heat exchanger, a tube-in-tube heat exchanger, a double tube heat exchanger, and/or the like. Heat exchanging 710 can be performed to change an average temperature of the filtered, cooled, and at least partially de-watered CO₂-Comprising feedstock 701. For example, heat exchanging 710 can be performed to increase the average temperature of the filtered, cooled, and at least partially de-watered CO₂-Comprising feedstock 701 before subsequent steps of the CO₂ purification/separation process 700, such as subsequent steps that require or are improved by the average temperature of the gas stream being at least somewhat elevated relative to the average temperature of the gas stream at one or more points between an outlet of after cooling 704 and an outlet of filtering out bacteria 709.

After heat exchanging 710, the CO₂ purification/separation process 700 can further comprise column distilling 711 to separate out at least some of the CO₂ gas in the CO₂-Comprising Feedstock 701 and/or separating out contaminants and other gas(es) from the CO₂-Comprising Feedstock 701 to increase the concentration of CO₂ therein. Column distilling 711 can be performed using any suitable procedure, approach, subprocess, or subsystem, using any suitable design and/or scale of column distillation device/system, and/or according to any suitable operating parameters. For example, column distilling 711 can be performed using one distillation column, a plurality of distillation columns operating in parallel, a plurality of distillation columns operating in series, or a plurality of distillation columns which are operating partially in series and partially in parallel.

In some embodiments, one or more additional process can be carried out to aid in separation or, e.g., polishing, of the CO₂ gas stream using, e.g., one or more membrane separation filters, direct air capture, one or more liquid solvents and/or solid sorbents, electrode/electrochemical attraction or electrocatalytic process(es), mineral or zeolitic scrubbing, one or more platform chemistry processes, such as the Sabatier process to form methane and water, plasma splitting, biochemical (e.g., enzymatic) formation of synthetic fuels or platform chemicals, and/or the like.

After column distilling 711, the CO₂ purification/separation process 700 further comprises chilling 712. After chilling 712, one or more product streams can be output to, e.g., a storage tank. In some embodiments, after chilling 712, the CO₂ purification/separation process 700 comprises outputting a high-purity CO₂ 713 stream. In some embodiments, after chilling 712, the CO₂ purification/separation process 700 comprises outputting a recovered CH₄ 714 stream.

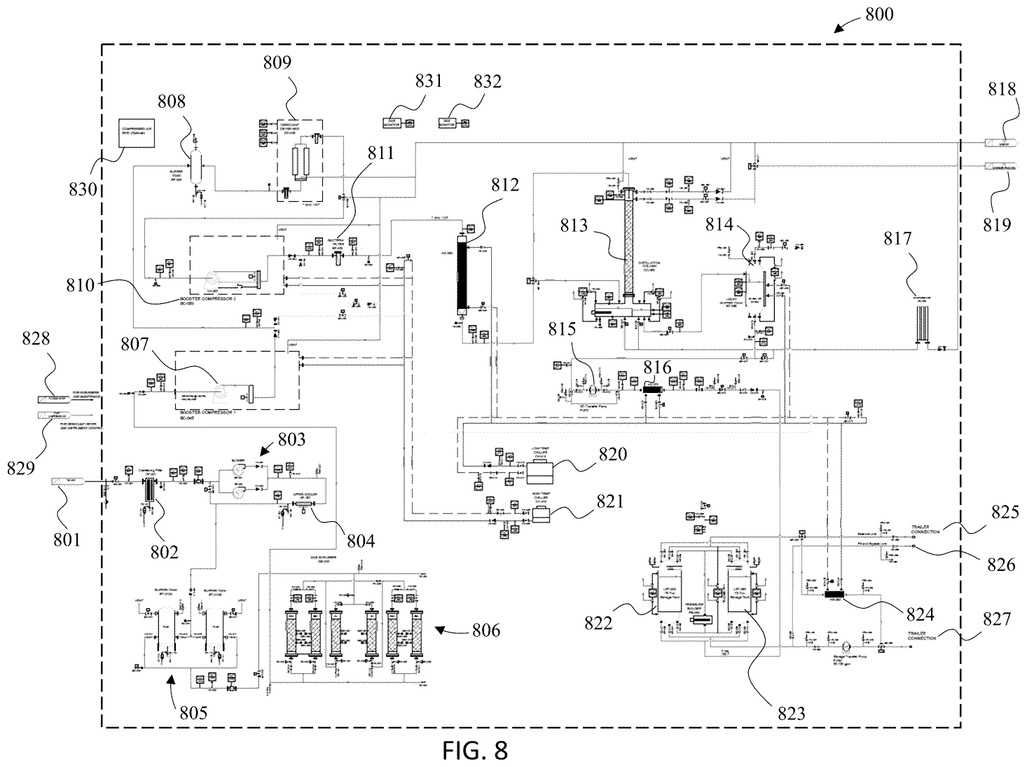

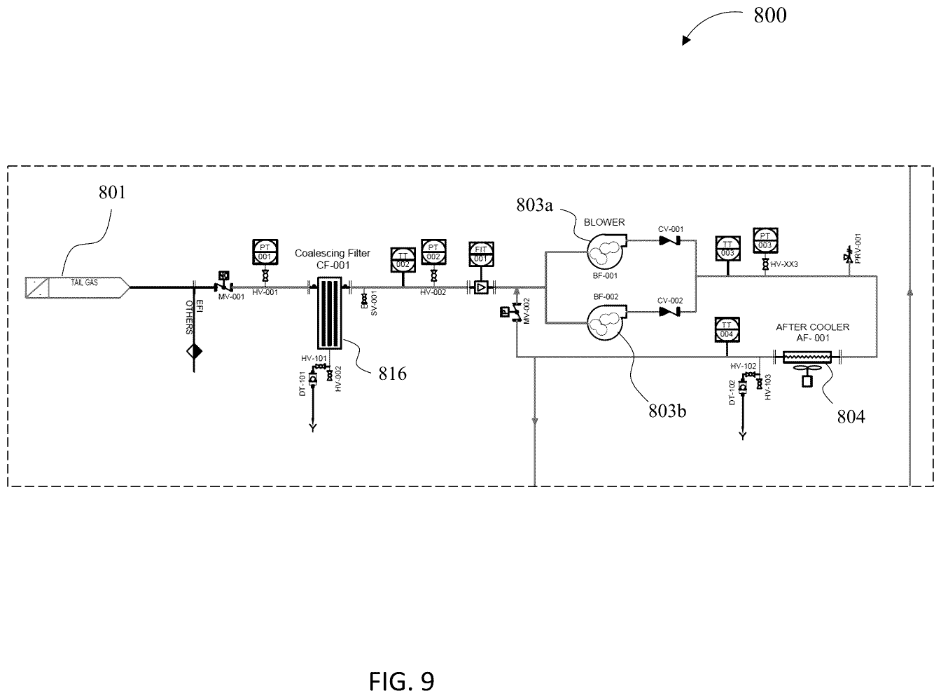

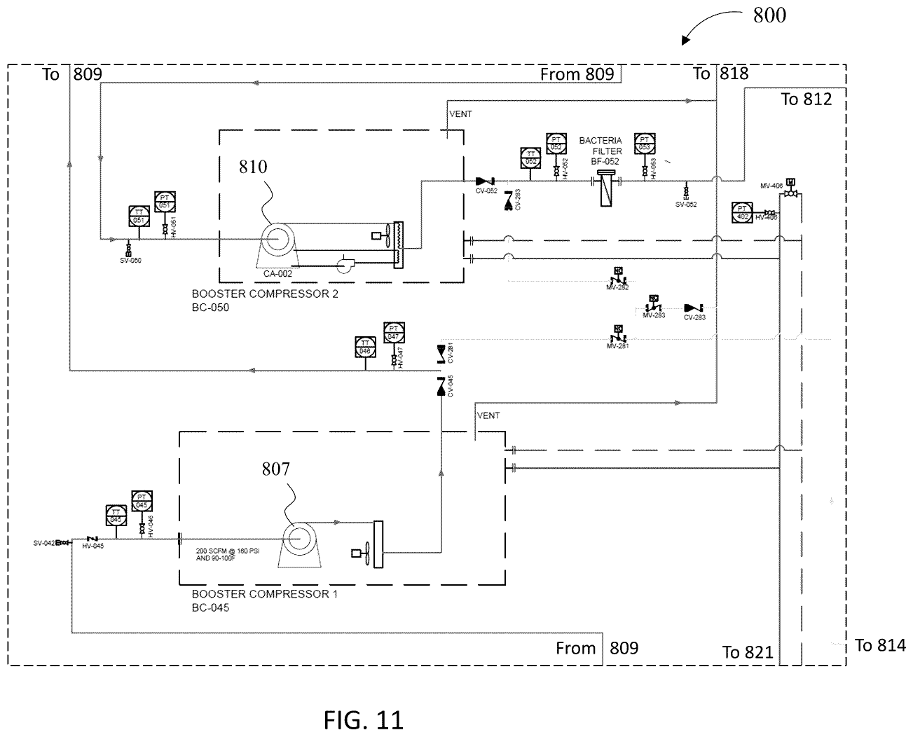

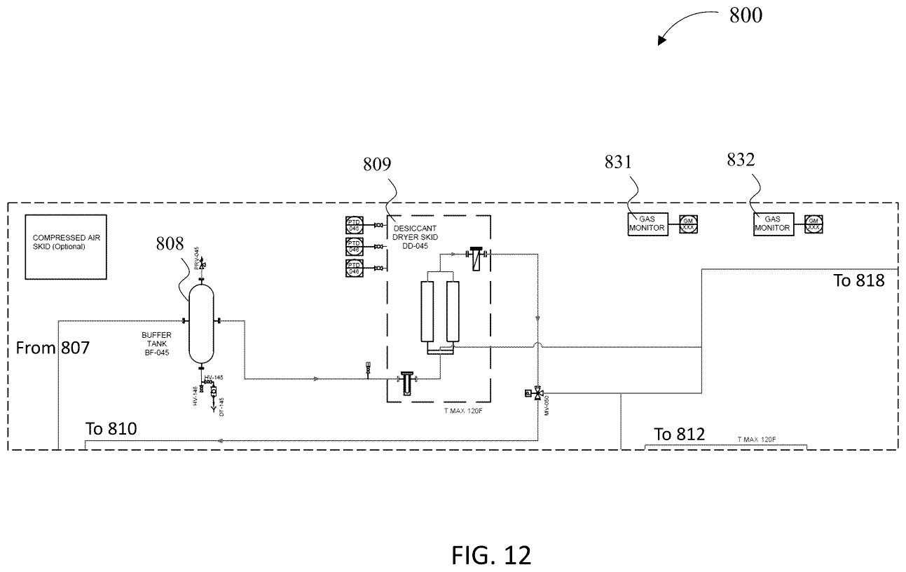

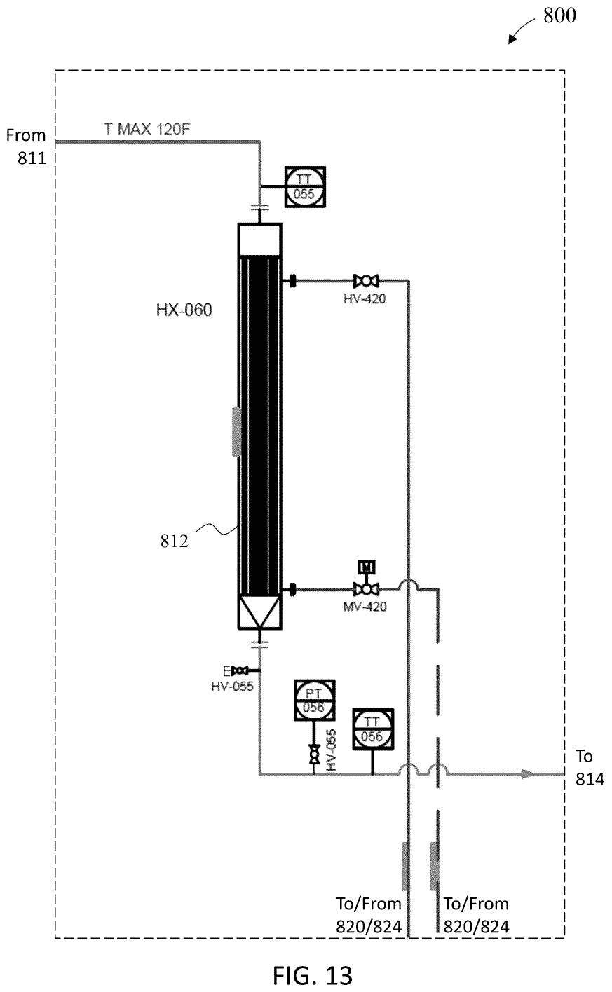

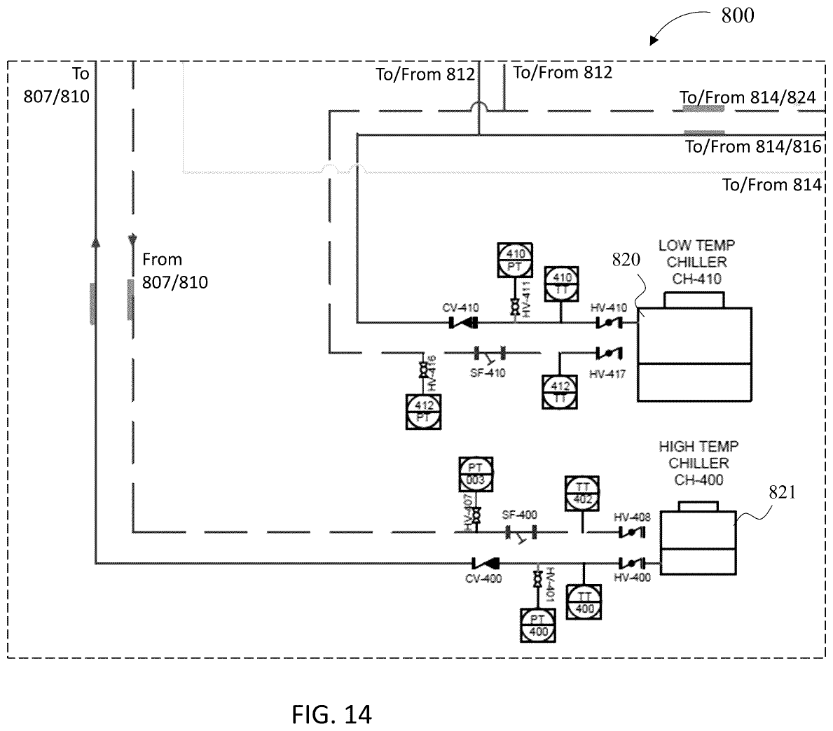

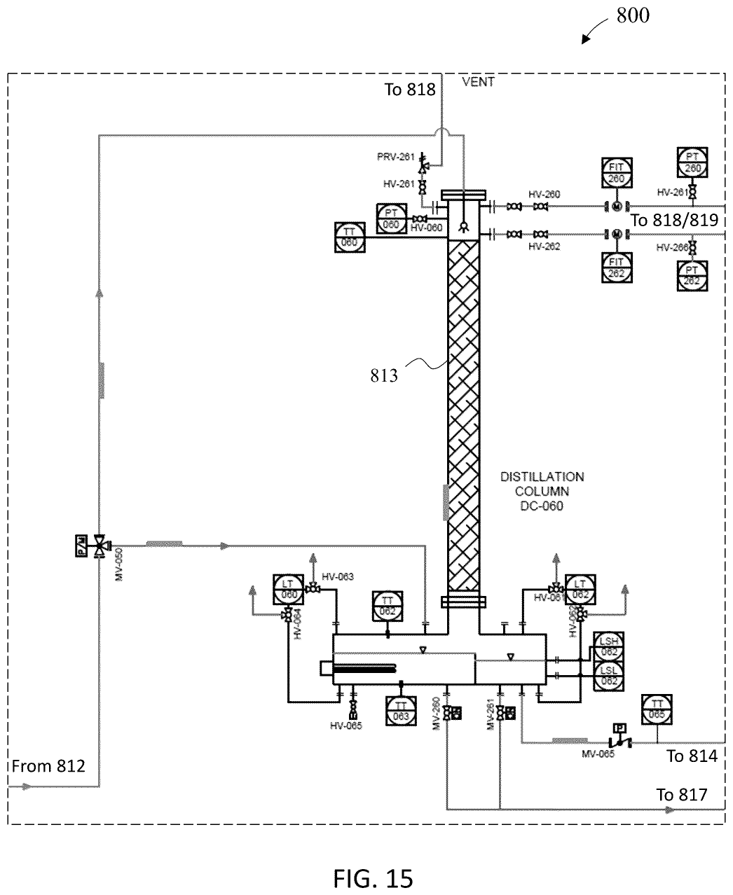

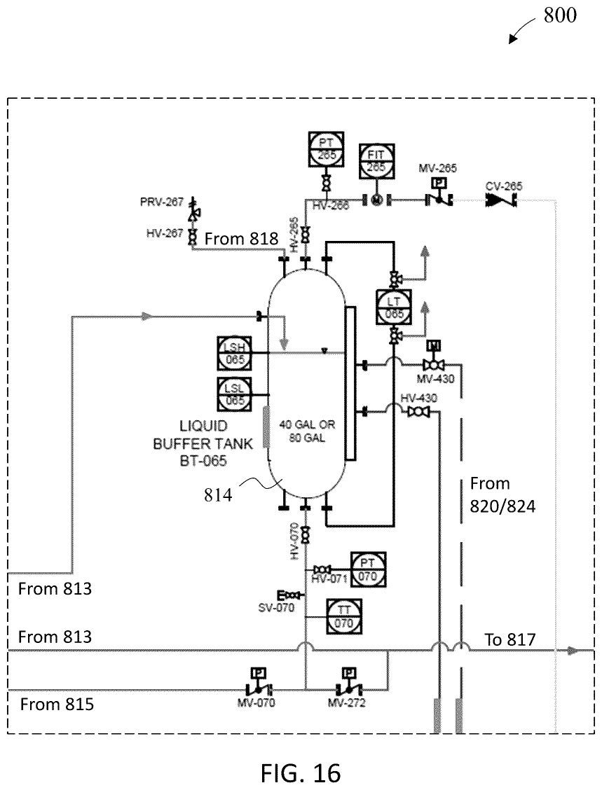

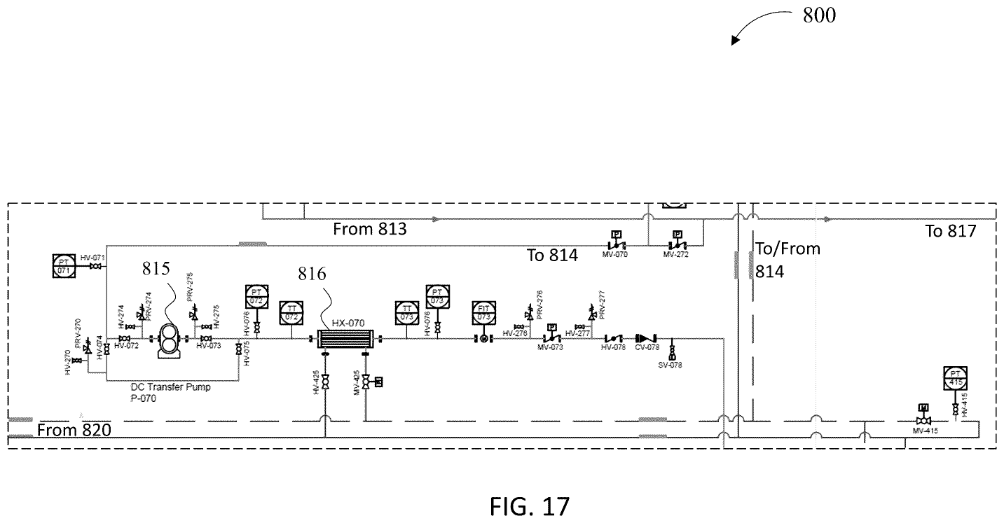

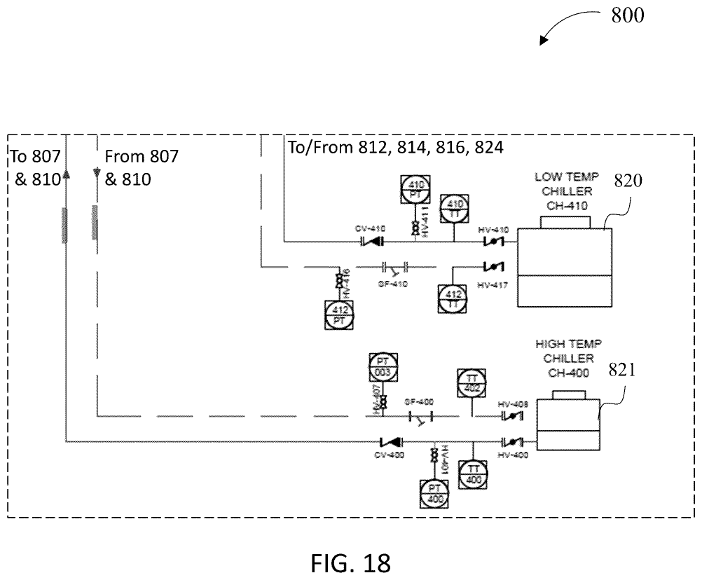

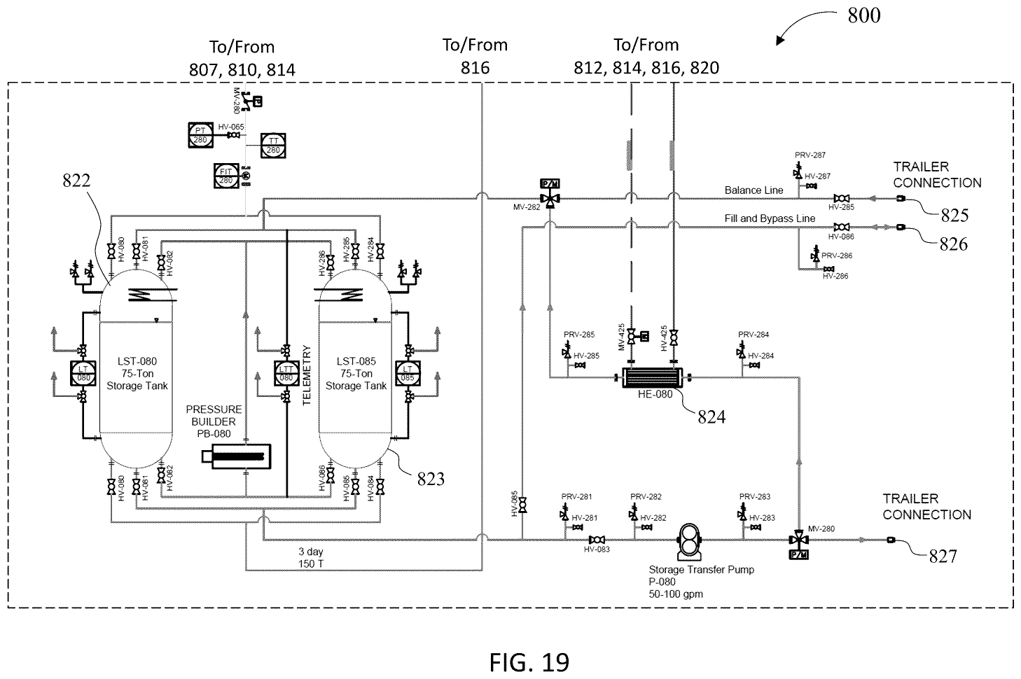

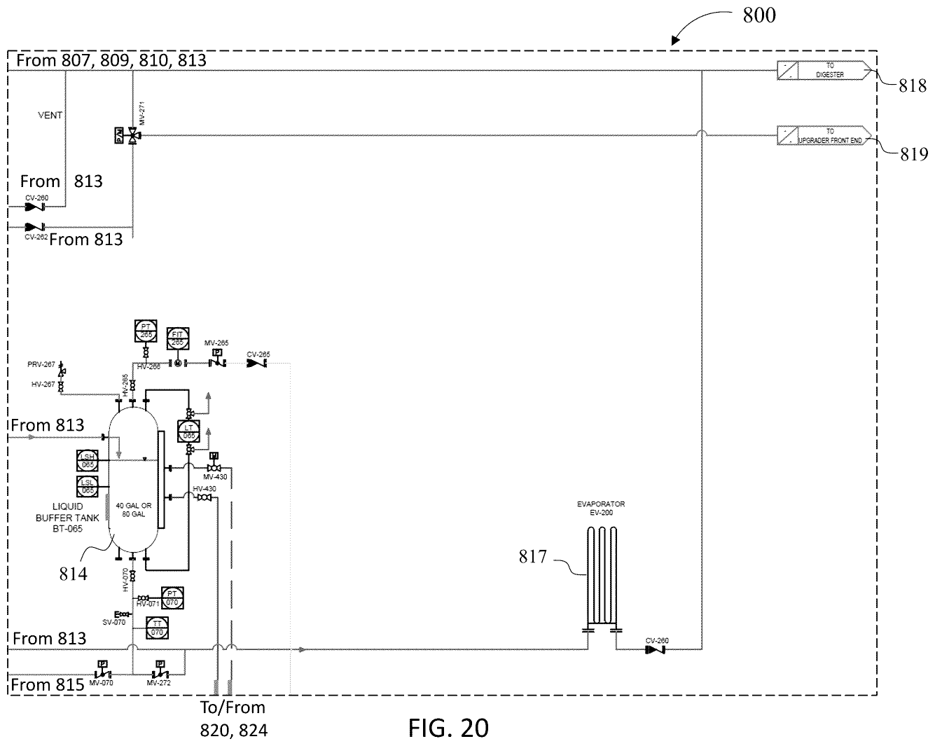

FIG. 8 illustrates a P&ID diagram of a process 800 for CO₂ purification and/or separation, while FIGS. 9-20 are subsets of the P&ID diagram in FIG. 8 that illustrate respective portions of the process 800. The P&ID diagrams, the CO₂ purification/separation process 800 may comprise one or more operations, elements, subsystems, subcomponents, devices, operational arrangements, and/or equipment arrangements that are similar to, or the same as, those in other CO₂ purification/separation processes described herein (e.g., 200, 300, 400, 500, 600, or 700). FIG. 8 is a P&ID diagram that provides a materially comprehensive, nearly comprehensive, or comprehensive overview of the process 800, while FIGS. 9-20 illustrate subsets of the process 800 illustrated in FIG. 8.

In some embodiments, the process 800 comprises intaking 801 a volume or a stream of a CO₂-comprising gas, such as the RNG tail gas described herein (and, optionally, a portion of upgraded/purified CO₂ gas from a later operation of the process 800), and filtering 802 impurities from the volume/stream of CO₂-comprising gas using, e.g., a coalescing filter.

After filtering 802, the process 800 comprises compressing 803 the CO₂-comprising gas using, e.g., one or more blowers. After the compressing 803, the process 800 further comprises chilling 804 the compressed CO₂-comprising gas using, e.g., a cooler, chiller, and/or the like.

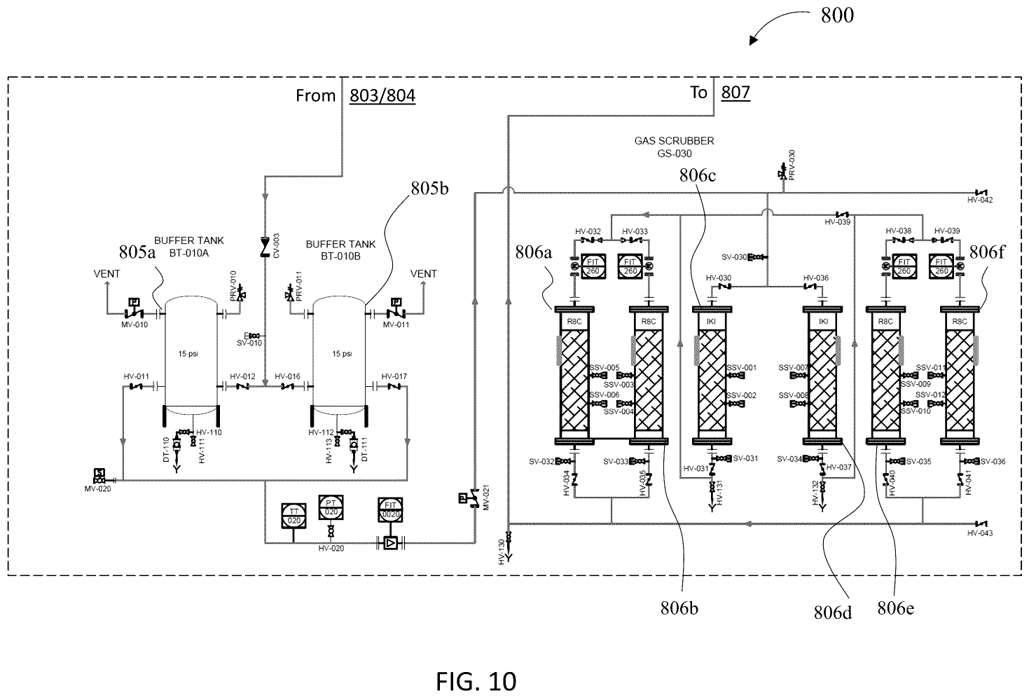

The process 800 can further comprise storing 805 the cooled and compressed CO₂-comprising gas in one or more buffer tanks. After storing 805 the cooled and compressed CO₂-comprising gas, the process 800 can further comprise gas scrubbing 806. Gas scrubbing 806 can be performed using one or a plurality of gas scrubbers. For example, as illustrated in FIG. 10, gas scrubbing 806 comprises gas scrubbing 806a-806f using six different gas scrubbers.

In some embodiments, the gas scrubbing 806 can be performed using one or more wet scrubbers which use a liquid, such as water or a chemical solution, to capture pollutants from a gas stream. In some embodiments, if wet scrubbers are used, the gas scrubbing 806 can be performed by communicating the cooled and compressed CO₂-comprising gas into a scrubbing chamber which is then contacted therein by a scrubbing liquid. The scrubbing liquid absorbs ore reacts with certain components, contaminants, pollutants, etc. in the cooled and compressed CO₂-comprising gas. The cooled and compressed CO₂-comprising gas can be contacted by the scrubbing liquid using, e.g., a spray nozzle, a demister, or the like. For acidic gases like SO₂ or HCl, alkaline solutions such as sodium hydroxide (NaOH) or lime (Ca(OH)₂) are often used. Wet scrubbers are highly effective for soluble gases and particulates but require wastewater treatment and corrosion-resistant materials.

Alternatively, in other embodiments, the gas scrubbing 806 can be performed using one or more dry scrubbers or dry injection systems. In such systems, a dry sorbent such as hydrated lime, sodium bicarbonate, or the like, can be disposed within the stream of the cooled and compressed CO₂-comprising gas in, e.g., a reactor vessel, using, e.g., a sorbent feeder or the like. The sorbent then reacts with certain components, constituents, particulars, contaminants, pollutants, or elements in the cooled and compressed CO₂-comprising gas to form solids, such as solid salts, which are then captured downstream. Dry scrubbers are often simpler than wet scrubbers and generate no liquid waste, but they are generally less efficient at gas scrubbing than wet systems and require more sorbent.

Alternatively, in other embodiments, the gas scrubbing 806 can be performed using one or more semi-dry scrubbers or spray dryers. These systems combine features of wet and dry scrubbers. In some implementations, a slurry of alkaline reagent is atomized into a hot gas stream in a spray dryer absorber. The water evaporates, leaving dry reaction products that are collected by a fabric filter. This method is effective for acid gas removal and avoids the complexities of wastewater handling. The key reaction is similar to dry scrubbing but occurs in a moist environment, which may enhance scrubbing efficiency.

Alternatively, in other embodiments, the gas scrubbing 806 can be performed using one or more Venturi scrubbers. Venturi scrubbers are a type of wet scrubber that are often used for particulate removal from gas streams. In some embodiments, if Venturi scrubbers are used, the gas scrubbing 806 can be performed by communicating the cooled and compressed CO₂-comprising gas into a converging-diverging throat where gas velocity increases, atomizing the scrubbing liquid into fine droplets. The high turbulence promotes collision and capture of particles. A cyclone separator or demister downstream removes the liquid droplets. These are effective for submicron particles but have high energy consumption due to pressure drop.

Alternatively, in other embodiments, the gas scrubbing 806 can be performed using one or more packed bed scrubbers. Packed bed scrubbers are often used for gas absorption. In some embodiments, if packed bed scrubbers are used, the gas scrubbing 806 can be performed by communicating the cooled and compressed CO₂-comprising gas into a vertical column filled with a packing material such as plastic saddles or rings that provide a large surface area for gas-liquid contact. The scrubbing liquid trickles down while the gas flows upward in a counter-current fashion. This configuration is often used for removing soluble gases like ammonia or chlorine from gas streams.

Alternatively, in other embodiments, the gas scrubbing 806 can be performed using one or more electrostatic wet scrubbers. Electrostatic wet scrubbers combine wet scrubbing with electrostatic precipitation. In some embodiments, if electrostatic wet scrubbers are used, the gas scrubbing 806 can be performed by communicating the cooled and compressed CO₂-comprising gas into a reaction chamber or vessel in which the gas stream interacts with a scrubbing liquid. After initial gas-liquid contact, an electrostatic field charges the droplets and particles, enhancing their collection on grounded surfaces. This often improves removal efficiency for fine particulates and mists.

After gas scrubbing 806, the process 800 can comprise booster compressing 807, which can be performed using one or more compressors, followed by storing 808 the CO₂-comprising gas in one or more buffer tanks. Storing 808 the CO₂-comprising gas in the buffer tank(s) may allow for a more consistent, stable volume and flow rate of the CO₂-comprising gas to be delivered to downstream devices and subsystems performing subsequent operations of the process 800.

From storing 808 in the buffer tank(s), at least a portion of the CO₂-comprising gas can be communicated to a dryer skid for desiccant drying 809. Desiccant drying 809 can be performed using any suitable desiccant or combination of desiccants, such as those described herein. From desiccant drying 809, at least a portion of the CO₂-comprising gas can be communicated to one or more second booster compressors for booster compressing 810.

From booster compressing 810, at least a portion of the CO₂-comprising gas can be communicated to one or more filters for bacteria filtering 811. Bacteria filtering 811 can be similar to, or the same as, the processes and methods described elsewhere herein for bacteria filtering. From bacteria filtering 811, at least a portion of the CO₂-comprising gas can be communicated to one or more heat exchangers for heat exchanging 812.

From heat exchanging 812, at least a portion of the CO₂-comprising gas can be communicated to one or more distillation columns for distilling 813. Distilling 813 can be performed using any suitable configuration, device, subsystem, components, operations, processes, or approaches such as those described elsewhere herein. Distilling 813 can cause at least a portion of the CO₂-comprising gas to be separated or otherwise transformed into a relatively purified CO₂-rich gas.

From distilling 813, at least a portion of the relatively purified CO₂-rich gas can be communicated to an upgrader front end by communicating 819. The upgrader front end may be a subsequent process or system that further upgrades the relatively purified CO₂-rich gas to, for example, further purify it until it complies with standards or requirements for being food grade CO₂.

Additionally or alternatively, at least a portion of the CO₂-comprising gas from distilling 813 can be recirculated back to the intaking 801 operation of the process 800. Additionally or alternatively, at least a portion of the CO₂-comprising gas can be communicated to a digester for digesting 818.

In some embodiments, the process 800 can be facilitated by additional (e.g., secondary or support) operations, such as storing 814 of certain liquids (e.g., process water, process air, heat exchange fluids, fluids for use in gas scrubbing 806, etc.) in one or more liquid buffer tanks.

In some embodiments, the additional (e.g., secondary or support) operations of the process 800 can additionally or alternatively include pumping 815 of certain liquids (e.g., process water, process air, heat exchange fluids, fluids for use in gas scrubbing 806, etc.) into or out of one or more liquid buffer tanks.

In some embodiments, the additional (e.g., secondary or support) operations of the process 800 can additionally or alternatively include heat exchanging 816 certain liquids (e.g., process water, process air, heat exchange fluids, fluids for use in gas scrubbing 806, etc.) as they are communicated into or out of one or more liquid buffer tanks.

In some embodiments, the additional (e.g., secondary or support) operations of the process 800 can additionally or alternatively include evaporating 817 a vented gas stream from, e.g., the distilling 813, before being communicated to the digester for digesting 818.

In some embodiments, the additional (e.g., secondary or support) operations of the process 800 can additionally or alternatively include low temperature chilling 820 and high temperature chilling 821, each of which can be carried out using, respectively, one or more chillers. The chillers can be used to reduce a temperature of a heat exchange fluid that is communicated to other operations within the process 800, such as compressing 808, compressing 810, heat exchanging 812, heat exchanging 824, etc.

In some embodiments, the additional (e.g., secondary or support) operations of the process 800 can additionally or alternatively include storing 822, 823 in of certain fluids (e.g., process water, process air, heat exchange fluids, fluids for use in gas scrubbing 806, etc.) in a storage and/or pressure building system. The storing 822, 823 can facilitate communication of these certain fluids to other operations within the process 800, such as heat exchanging 812, heat exchanging 824, distilling 814, etc.

In some embodiments, the additional (e.g., secondary or support) operations of the process 800 can additionally or alternatively include an additional operation of heat exchanging 824. Heat exchanging 824 can be performed to cool or heat certain fluids (e.g., process water, process air, heat exchange fluids, fluids for use in gas scrubbing 806, etc.).

In some embodiments, the additional (e.g., secondary or support) operations of the process 800 can additionally or alternatively include additional operation(s) such as communicating 825 via balance line from a trailer connection, communicating 826 via a fill and bypass line, and/or communicating 827 to a trailer via a trailer line (e.g., aided by use of a storage transfer pump or the like). In some embodiments, communicating 825 can comprise communicating a replenishing supply of one or more certain fluids (e.g., process water, process air, heat exchange fluids, fluids for use in gas scrubbing 806, etc.) into the liquid storage tanks used in storing 822, 823. In some embodiments, communicating 826 can comprise communicating a replenishing supply of one or more certain fluids (e.g., process water, process air, heat exchange fluids, fluids for use in gas scrubbing 806, etc.) into the liquid storage tanks used in storing 822, 823. In some embodiments, communicating 827 can comprise communicating an outflow of one or more certain fluids (e.g., process water, process air, heat exchange fluids, fluids for use in gas scrubbing 806, etc.) from one or more of the liquid storage tanks used in storing 822, 823 to or towards a trailer or other suitable device or system operably coupled to the liquid storage tanks.

In some embodiments, the additional (e.g., secondary or support) operations of the process 800 can additionally or alternatively include an additional operation of communicating 828 potable water, process water, or the like into the system for use in, e.g., gas scrubbing 806, various maintenance operations, etc.

In some embodiments, the additional (e.g., secondary or support) operations of the process 800 can additionally or alternatively include an additional operation of communicating 829 process air, plant air, compressed air, plant compressed air, or the like into the system for use in, e.g., desiccant drying 809, various maintenance operations, instrument controls, valve operation, etc.

In some embodiments, the additional (e.g., secondary or support) operations of the process 800 can additionally or alternatively include an additional operation of compressing 830 process air to form the process air, plant air, compressed air, plant compressed air, or the like that for communicating 829 the same into the system for use in, e.g., desiccant drying 809, various maintenance operations, instrument controls, valve operation, etc.

In some embodiments, the additional (e.g., secondary or support) operations of the process 800 can additionally or alternatively include additional operations of gas monitoring 831, 832. Gas monitoring 831, 832 can be performed to monitor one or more characteristics of the CO₂-comprising gas at intaking 801, at communicating 819 the upgraded CO₂-rich gas to the upgrader front end, and/or any other point or operation throughout the process 800 and throughout the plant.

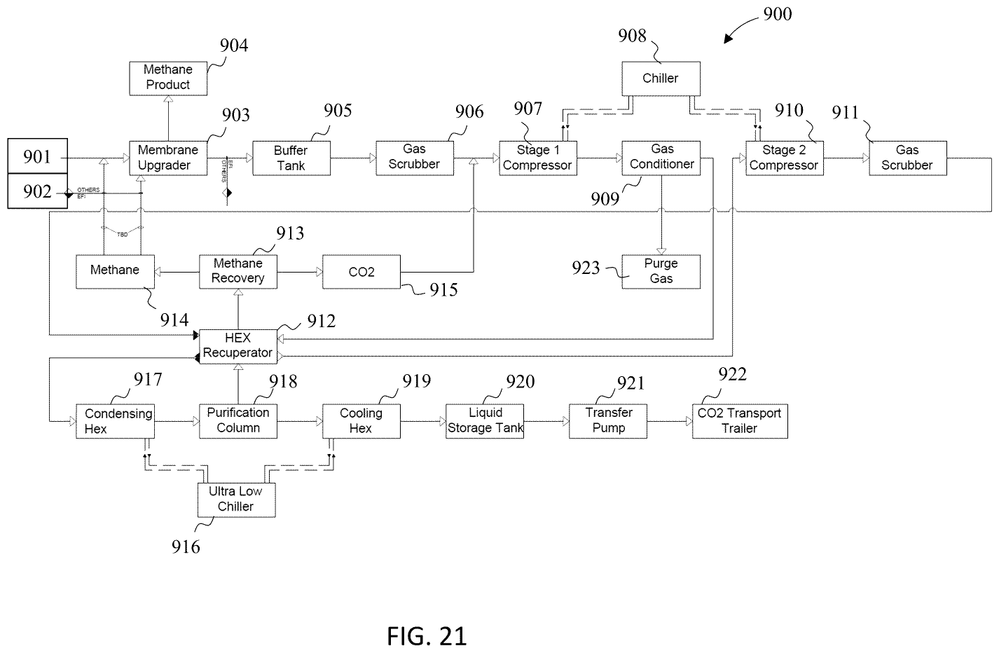

FIG. 21 illustrates a process flow diagram for a process 900 for CO₂ purification and/or separation. Various processes, components, devices, and subsystems illustrated for process 900 may be similar to, or the same as, corresponding processes, components, devise, and subsystems of process 800 and the corresponding system. Accordingly, the below description of process 900 includes mainly descriptions of processes, components, devices, and subsystems that are different from those of the system and processes described above (e.g., in process 800).

The process 900 can comprise intaking a CO₂-comprising gas stream 901 and intaking one or more additional streams 902, such as recirculation stream(s). The process 900 can further comprise methane upgrading 903 of the CO₂-comprising gas stream and providing a methane product stream 904. The process 900 can further comprise storing a CO₂-comprising gas stream 905, such as in one or more buffer tanks. The process 900 can further comprise gas scrubbing 906, stage one compressing 907, chilling 908, gas conditioning 909, and stage two compressing 910. After stage two compressing 910, the process 900 can further comprise gas scrubbing 911 and heat exchanging 912.

In some embodiments, the process 900 can further comprise methane recovering 913 and/or column purification 918, either of which can be carried out using a distillation column or the like. In some embodiments, the system 900 can be configured such that an outlet stream from the distillation column (e.g., in methane recovery 913, in column purification 918), such as an outlet stream that is rich in methane 914 can be separated from another outlet stream from the distillation column, such as an outlet stream rich in CO₂ 915. The process 900 can be configured to recirculate some or all of the separated methane 914 to the intaking 901 or the methane upgrading 903. In some embodiments, the process 900 can be configured to provide some or all of the separated methane 914 directly to the methane product stream 904.

In some embodiments, a combined outlet stream from the distillation column (e.g., 913, 918) can be rich in CO₂ and CH₄. In some embodiments, the process 900 can further comprise one or more membrane processes (e.g., 903) downstream from the distillation column (e.g., 913, 918) that are operable for concentrating the CH₄ (e.g., 914) and/or CO₂ (e.g., 915). From such a membrane process (e.g., 903), two product streams can be produced, a first product stream (e.g., 904) which is rich in CH₄ and a second product stream (e.g., 922) which is rich in CO₂. The first product stream (e.g., 904), which is rich in CH₄, can have a CH₄ concentration of, e.g., 96% CH₄.

In some embodiments, a combined outlet stream (comprising CH₄ and CO₂) from the distillation column (e.g., 913, 918) can have a sufficient gas pressure and be sufficiently volumetrically constrained to drive the combed outlet stream into and through the membrane process (e.g., 903). In some embodiments, the combined outlet stream from the distillation column (e.g., 913, 918) can be further compressed or pressurized to drive the combed outlet stream into and through the membrane process. In some embodiments, the membrane process (e.g., 903) can comprise a single-stage or a multi-stage membrane process. In some embodiments, the membrane process (e.g., 903) can comprise a pre-treatment process, an oxidizing stage, a polymer fiber filtration stage, and/or the like. In some embodiments, the membrane process (e.g., 903) can be configured to physically separate CH₄ (e.g., as retentate or concentrate) from CO₂ and other components (e.g., as permeate or waste).

Typically, gas membrane separation systems rely on (e.g., require) compression of the gas mixture at the intake/inlet in order for the gas to by physically driven through the membrane process. However, in the described system, according to certain embodiments, the CH₄/CO₂ mixture at the outlet of the distillation column (e.g., 813) already has a sufficiently high gas pressure to allow the CH₄/CO₂ mixture to be driven into the membrane separation subprocess (e.g., 903) without adding a separate compression step (e.g., gas compressor) into the process 900 between the distillation column (e.g., 913, 918) and the gas membrane separation subprocess (e.g., 903). In some embodiments, the process 900 can comprise or utilize only a small compressor or blower (e.g., after gas membrane separating 903 or between column distillation (e.g., 913, 918) and gas membrane separation 903) to allow for spec gas (e.g., CO₂) to be increased in pressure to a level that is sufficient to be recirculated back to an inlet of the CO₂ purification/concentration process (e.g., 900). Further, according to certain embodiments, the CH₄/CO₂ mixture at the outlet of the distillation column (e.g., 913, 918) may have a sufficient temperature to facilitate/aid gas separation during gas membrane separating (e.g., 903). In some embodiments, the CH₄/CO₂ mixture at the outlet of the distillation column (e.g., 913, 918) may need to be slightly temperature adjusted (e.g., chilled) in order for the CH₄/CO₂ mixture to have a sufficient temperature to facilitate/aid gas separation at gas membrane separating 903.

In some embodiments, the process 900 can further comprise low or ultra low chilling 916 of, e.g., a heat exchange fluid, such as a refrigerant. In some embodiments, the process 900 can further comprise condensing heat exchanging 917 for, e.g., a gas stream in the heat exchanger recuperating 912 and/or the column purification 918. In some embodiments, the process 900 can further comprise cooling heat exchanging 919 of a gas stream in or leaving column purification 918. After cooling heat exchanging 919, the process 900 can further comprise storing 920 a CO₂-rich gas stream in, e.g., a liquid storage tank or the like. After storing 920 the CO₂-rich gas stream, the process 900 can further comprise transfer pumping 221 the CO₂-rich gas stream for CO₂ trailer transporting 922 or the like. In some embodiments, the process 900 can, optionally, further comprise gas purging 923 from, e.g., the gas conditioning 909.

In some embodiments, the first stream which is rich in CH₄ can be provided (e.g., 904) as an overall product stream from the process 900. In some embodiments, the first product stream which is rich in CH₄ can be recirculated (e.g., to 901 or 903) or directed back to a collocated or nearby system or process, such as a renewable natural gas plant, such as to be added to an incoming feedstock stream of the collocated or nearby system or process, to be added to an outgoing product stream of the collocated or nearby system or process, or to be added into a mid-process stream within the collocated or nearby system or process. In some embodiments, the first product stream which is rich in CH₄ can be combusted (e.g., 923) to purge the gas, produce heat, produce steam, produce electricity, produce energy, perform work, and/or the like.

In some embodiments, the second product stream which is rich in CO₂ can itself be a product stream communicated (e.g., 920, 921, 922, 923) out of the process 900. In some embodiments, the second product stream which is rich in CO₂ can be further upgraded or refined downstream of column distilling (e.g., 913, 918) within the process 900.

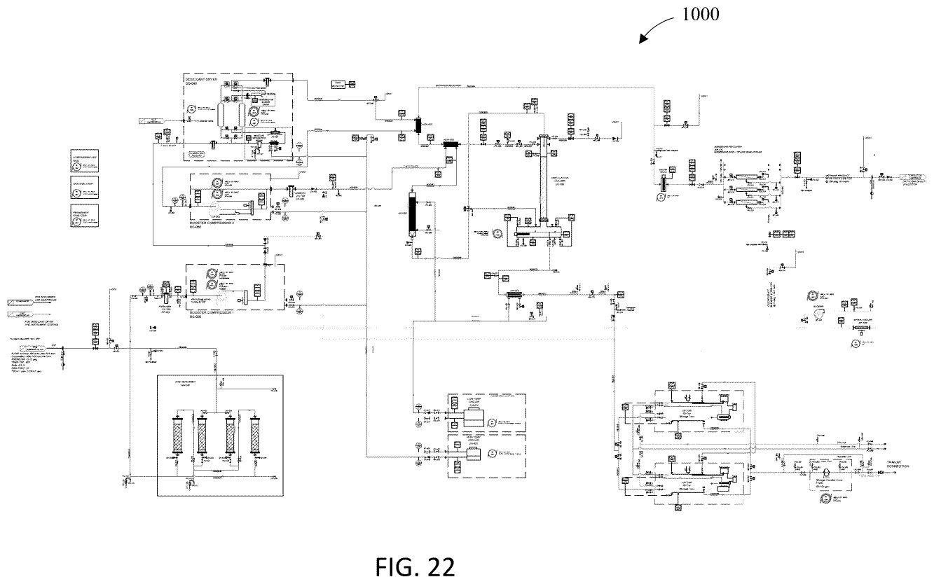

Referring now to FIG. 22, a system 1000 is illustrated that can be provided for carrying out a process, such as process 900. The system 1000 can be similar to the system illustrated in FIG. 8 that is configured to carry out the process 800. In some embodiments, one difference between the system illustrated in FIG. 8 and the system 1000 is that the low temperature chiller unit (e.g., 820) is configured to provide heat exchange/cooling services that can replace or supplement other processes (e.g., 812).

For example, as illustrated in FIG. 22, the system 1000 includes low temperature chilling with a water circulation loop to exchange heat using other heat exchange processes or operations. In some embodiments, a CO₂ purification/concentration process (e.g., 900) can use such a low temperature chiller with a heat exchange fluid loop that directly exchanges heat via a fully closed loop of heat exchange fluid driven through the process from, e.g., the low temperature chilling (e.g., 916). In such a way, the low temperature chiller can be more directly integrated into the cooling operations of the process (e.g., 900), which may either reduce the capacity of certain chilled water loop equipment needed or eliminate certain equipment altogether. In some embodiments, by more directly integrating the low temperature chilling (e.g., 916) subprocess into the cooling/chilling operations of the process 900, the system 1000 can be provided that is configured to carry out the process 900 in such a way as to reduce the size of the buffer tanks (e.g., 905) or eliminate the buffer tanks altogether. In some embodiments, by more directly integrating the low temperature chilling (e.g., 916) subprocess into the cooling/chilling operations of the process 900, the system 1000 can be provided that is configured to carry out the process 900 in such a way as to reduce the size of certain pumps, piping, electrical capacity, process water, process power, and/or the like. Said otherwise, in certain embodiments, the low temperature chilling (e.g., 916) can act as a chiller and a refrigeration loop, thereby doing much of the cooling subprocess(es) in the process 900. In some embodiments, the system 1000 can comprise a low temperature chiller skid. In certain embodiments, when the low temperature chilling process (e.g., 916) is more directly integrated as a chiller and refrigeration loop, e.g., when the low temperature chilling (e.g., 916) is directly circulating a heat exchange fluid other than chilled water, the system 1000 may comprise a low temperature chiller skid that is increased in size and/or capacity (e.g., relative to that used in the system illustrated in FIG. 8) to handle the additional heat exchange load.

In some embodiments, the low temperature chiller skid in the system 1000, instead of comprising two separate heat exchangers and two separate evaporators, can combine or consolidate these functions into the existing units. In some embodiments, the low temperature chiller skid in the system 1000 can comprise an ammonia chiller, a CO₂ chiller, a propane chiller, or the like. In some embodiments, the low temperature chiller skid in the system 1000 can be an evaporator-less chiller skid. In some embodiments, a heat exchange fluid outlet stream from the low temperature chiller skid in the system 1000 can have a temperature of between about −50° C. and about −20° C.

One or more of the elements, steps, tasks, or operations of the systems, processes, or methods (e.g., 100, 200, 300, 400, 500, 600, 700, 800, 900, 1000, 1200, 1300, 1400, 1500) described herein can be carried out using a computer or computer-based device, thereby automating at least part of the process. Furthermore, the use of a computer or computer-based device for carrying out certain elements or operations of a method or process as described herein may result in the improvement and enhancement of the computer or computer-based device itself. Furthermore, some elements or operations of a method or process as described herein may be improved or enhanced by being carried out using a computer or computer-based device. Also, some elements or operations of a method or process as described herein may only be carried out, or may only be carried out with sufficient accuracy or speed, using a computer or computer-based device. The computer or computer-based devices described herein, therefore, are specialized hardware and apparatuses, and do not constitute general-purpose computing devices. An example of such a computer or computer-based device is described below.

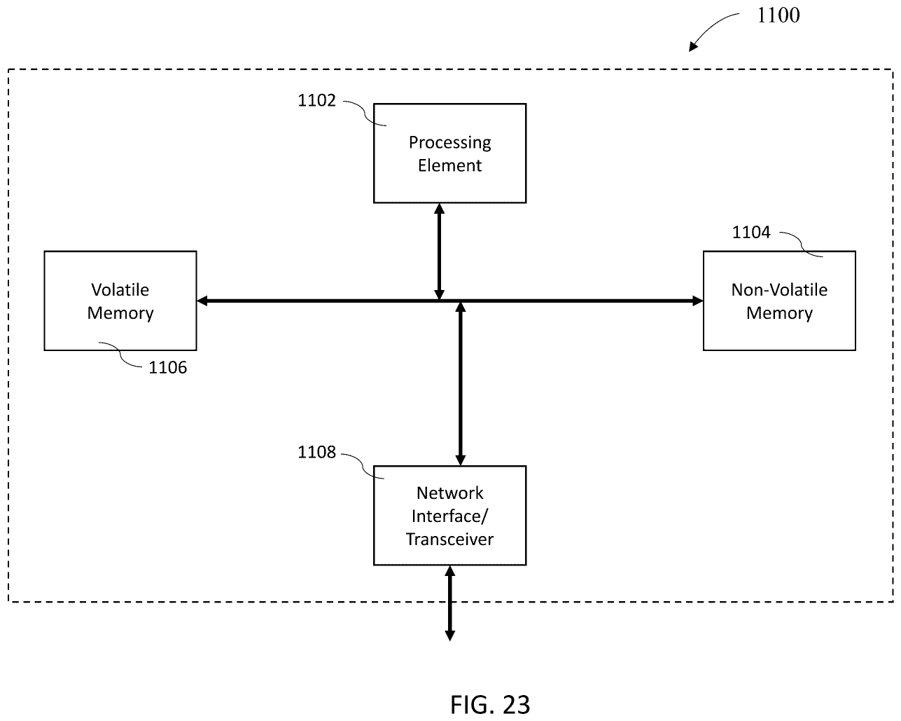

FIG. 23 provides a schematic of a computing device 1100 according to one embodiment of the present invention. In general, the terms computing device, computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As shown in FIG. 23, in one embodiment, the computing device 1100 may include or be in communication with one or more processing elements 1102 (also referred to as processors, processing circuitry, and/or similar terms used herein interchangeably) that communicate with other elements within the computing device 1100 via a bus, for example. As will be understood, the processing element 1102 may be embodied in a number of different ways. For example, the processing element 1102 may be embodied as one or more complex programmable logic devices (CPLDs), microprocessors, multi-core processors, coprocessing entities, application-specific instruction-set processors (ASIPs), microcontrollers, and/or controllers. Further, the processing element 1102 may be embodied as one or more other processing devices or circuitry. The term circuitry may refer to an entirely hardware embodiment or a combination of hardware and computer program products. Thus, the processing element 1102 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 1102 may be configured for a particular use or configured to execute instructions stored in volatile or non-volatile media or otherwise accessible to the processing element 1102. As such, whether configured by hardware or computer program products, or by a combination thereof, the processing element 1102 may be capable of performing steps or operations according to embodiments of the present invention when configured accordingly.

In one embodiment, the computing device 1100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 1104, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media 1104 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the computing device 1100 may further include or be in communication with volatile media (also referred to as volatile storage, memory, memory storage, memory circuitry and/or similar terms used herein interchangeably). In one embodiment, the volatile storage or memory may also include one or more volatile storage or memory media 1106, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 1102. Thus, the databases, database instances, database management systems, data, applications, programs, program modules, scripts, source code, object code, byte code, compiled code, interpreted code, machine code, executable instructions, and/or the like may be used to control certain aspects of the operation of the computing device 1100 with the assistance of the processing element 1102 and operating system.

In some embodiments, the computing device 1100 may also include one or more network interfaces, such as a network interface/transceiver 1108 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing device 1100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing device 1100 may include or be in communication with one or more input elements, such as a keyboard input, a mouse input, a touch screen/display input, motion input, movement input, audio input, pointing device input, joystick input, keypad input, and/or the like. The computing device 1100 may also include or be in communication with one or more output elements (not shown), such as audio output, video output, screen/display output, motion output, movement output, and/or the like.

In another embodiment, the computing device 1100 may include one or more components or functionality that are operable to cause performance of a method, such as those described in greater detail below. In some embodiments, the computing device 1100 can be suitable to carry out movement of various components of an apparatus, system, device, or the like, to perform at least part of a method as described herein. As will be recognized, these architectures and descriptions are provided for exemplary purposes only and are not limiting to the various embodiments.

In some embodiments, the computing device 1100 can be suitable to carry out movement of various components of an apparatus, system, device, or the like, to perform at least part of a method as described herein.

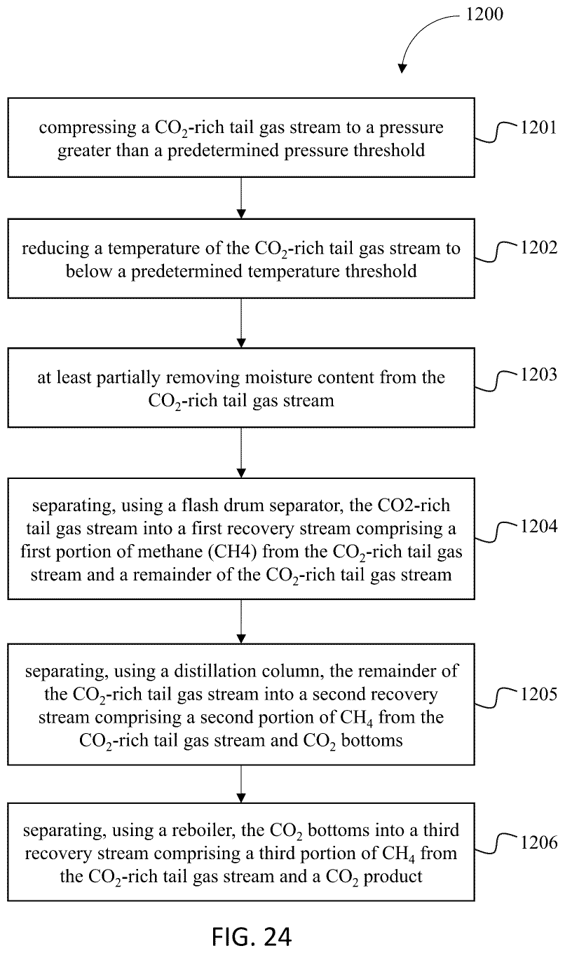

Referring now to FIG. 24, a method 1200 can be carried out to produce high-purity CO₂ from a CO₂-rich feedstock, such as tail gas from a biorefinery or the like. In some embodiments, the method 1200 can comprise compressing a CO₂-rich tail gas stream to a pressure greater than a predetermined pressure threshold, at 1201. In some embodiments, the method 1200 can further comprise reducing a temperature of the CO₂-rich tail gas stream to below a predetermined temperature threshold, at 1202. In some embodiments, the method 1200 can further comprise at least partially removing moisture content from the CO₂-rich tail gas stream, at 1203. In some embodiments, the method 1200 can further comprise separating, using a flash drum separator, the CO₂-rich tail gas stream into a first recovery stream comprising a first portion of methane (CH₄) from the CO₂-rich tail gas stream and a remainder of the CO₂-rich tail gas stream, at 1204. In some embodiments, the method 1200 can further comprise separating, using a distillation column, the remainder of the CO₂-rich tail gas stream into a second recovery stream comprising a second portion of CH₄ from the CO₂-rich tail gas stream and CO₂ bottoms, at 1205. In some embodiments, the method 1200 can further comprise separating, using a reboiler, the CO₂ bottoms into a third recovery stream comprising a third portion of CH₄ from the CO₂-rich tail gas stream and a CO₂ product, at 1206.

In some embodiments, the method 1200 can be carried out by an apparatus or device, such as one comprising, or in communication with, the computing device 1100. For example, the volatile memory 1106 or non-volatile memory 1104 of the computing device 1100 can store instructions (e.g., computer-readable instructions, computer program codes, software, computer program(s), etc.) thereon that are configured, when executed by a processor (e.g., the processing element 1102 of the computing device 1100), to cause the computing device 1100 or an apparatus/system in communication with the computing device 1100, to perform one or more elements or aspects of the method 1200.

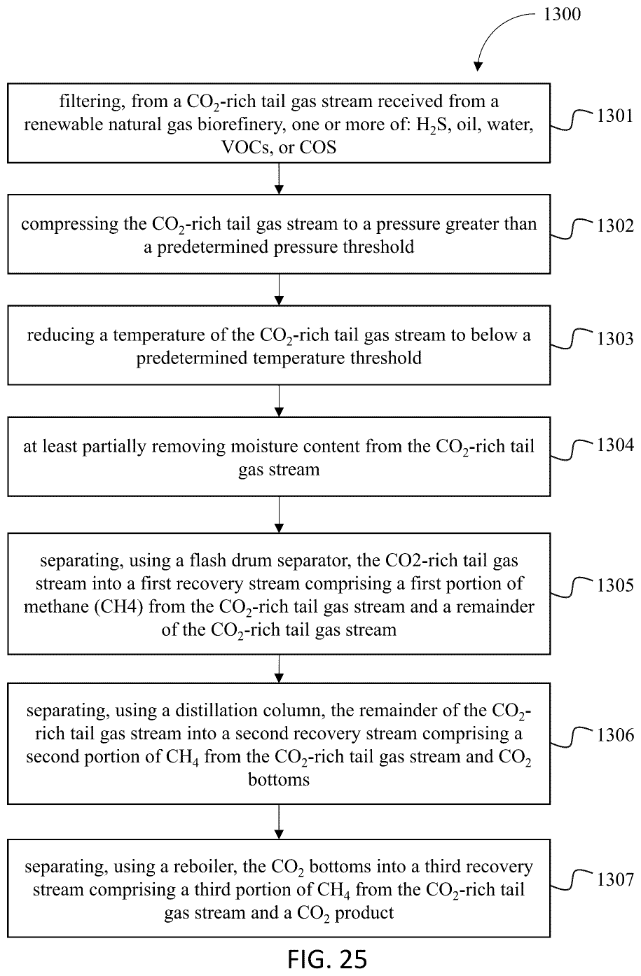

Referring now to FIG. 25, a method 1300 can be carried out for producing high-purity CO₂. The method 1300 can comprise filtering, from a CO₂-rich tail gas stream received from a renewable natural gas biorefinery, one or more of: H₂S, oil, water, VOCs, or COS, at 1301. In some embodiments, the method 1300 can further comprise compressing the CO₂-rich tail gas stream to a pressure greater than a predetermined pressure threshold, at 1302. In some embodiments, the method 1300 can further comprise reducing a temperature of the CO₂-rich tail gas stream to below a predetermined temperature threshold, at 1303. In some embodiments, the method 1300 can further comprise at least partially removing moisture content from the CO₂-rich tail gas stream, at 1304. In some embodiments, the method 1300 can further comprise separating, using a flash drum separator, the CO₂-rich tail gas stream into a first recovery stream comprising a first portion of methane (CH₄) from the CO₂-rich tail gas stream and a remainder of the CO₂-rich tail gas stream, at 1305. In some embodiments, the method 1300 can further comprise separating, using a distillation column, the remainder of the CO₂-rich tail gas stream into a second recovery stream comprising a second portion of CH₄ from the CO₂-rich tail gas stream and CO₂ bottoms, at 1306. In some embodiments, the method 1300 can further comprise separating, using a reboiler, the CO₂ bottoms into a third recovery stream comprising a third portion of CH₄ from the CO₂-rich tail gas stream and a CO₂ product, at 1307.

In some embodiments, the method 1300 can be carried out by an apparatus or device, such as one comprising, or in communication with, the computing device 1100. For example, the volatile memory 1106 or non-volatile memory 1104 of the computing device 1100 can store instructions (e.g., computer-readable instructions, computer program codes, software, computer program(s), etc.) thereon that are configured, when executed by a processor (e.g., the processing element 1102 of the computing device 1100), to cause the computing device 1100 or an apparatus/system in communication with the computing device 1100, to perform one or more elements or aspects of the method 1300.

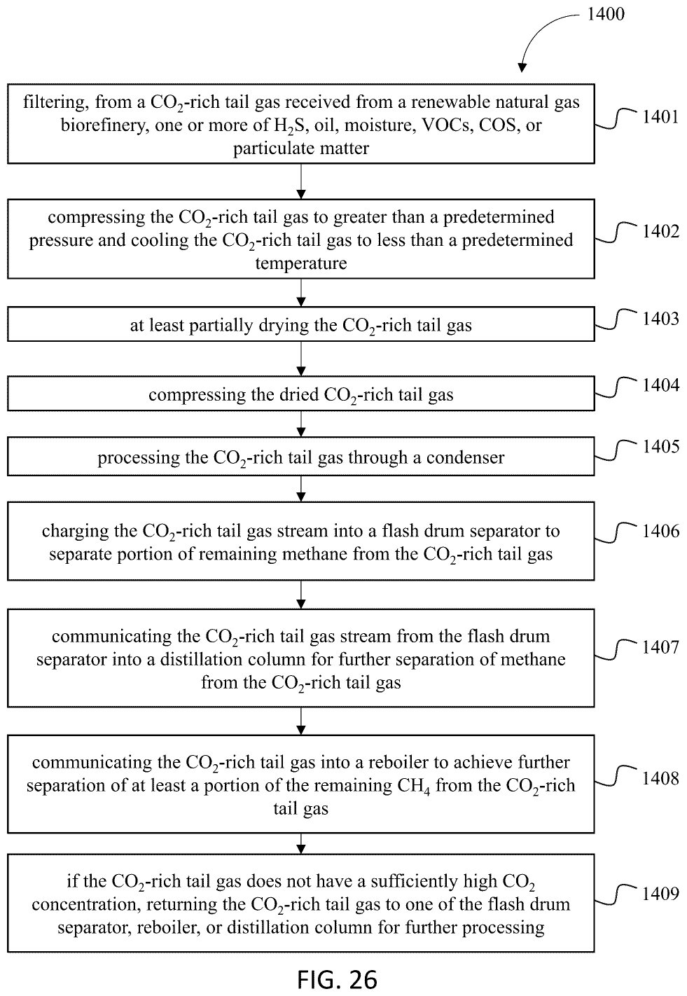

Referring now to FIG. 26, a method 1400 can be carried out to produce a high-purity CO₂. In some embodiments, the method 1400 can comprise filtering, from a CO₂-rich tail gas received from a renewable natural gas biorefinery, one or more of H₂S, oil, moisture, VOCs, COS, or particulate matter, at 1401. In some embodiments, the method 1400 can further comprise compressing the CO₂-rich tail gas to greater than a predetermined pressure and cooling the CO₂-rich tail gas to less than a predetermined temperature, at 1402. In some embodiments, the method 1400 can further comprise at least partially drying the CO₂-rich tail gas, at 1403. In some embodiments, the method 1400 can further comprise compressing the dried CO₂-rich tail gas, at 1404. In some embodiments, the method 1400 can further comprise processing the CO₂-rich tail gas through a condenser, at 1405. In some embodiments, the method 1400 can further comprise charging the CO₂-rich tail gas stream into a flash drum separator to separate portion of remaining methane from the CO₂-rich tail gas, at 1406. In some embodiments, the method 1400 can further comprise communicating the CO₂-rich tail gas stream from the flash drum separator into a distillation column for further separation of methane from the CO₂-rich tail gas communicating the CO₂-rich tail gas stream from the flash drum separator into a distillation column for further separation of methane from the CO₂-rich tail gas, at 1407. In some embodiments, the method 1400 can further comprise communicating the CO₂-rich tail gas into a reboiler to achieve further separation of at least a portion of the remaining CH₄ from the CO₂-rich tail gas, at 1408. In some embodiments, the method 1400 can further comprise if the CO₂-rich tail gas does not have a sufficiently high CO₂ concentration, returning the CO₂-rich tail gas to one of the flash drum separator, reboiler, or distillation column for further processing, at 14010.

In some embodiments, the method 1400 can be carried out by an apparatus or device, such as one comprising, or in communication with, the computing device 1100. For example, the volatile memory 1106 or non-volatile memory 1104 of the computing device 1100 can store instructions (e.g., computer-readable instructions, computer program codes, software, computer program(s), etc.) thereon that are configured, when executed by a processor (e.g., the processing element 1102 of the computing device 1100), to cause the computing device 1100 or an apparatus/system in communication with the computing device 1100, to perform one or more elements or aspects of the method 1400.

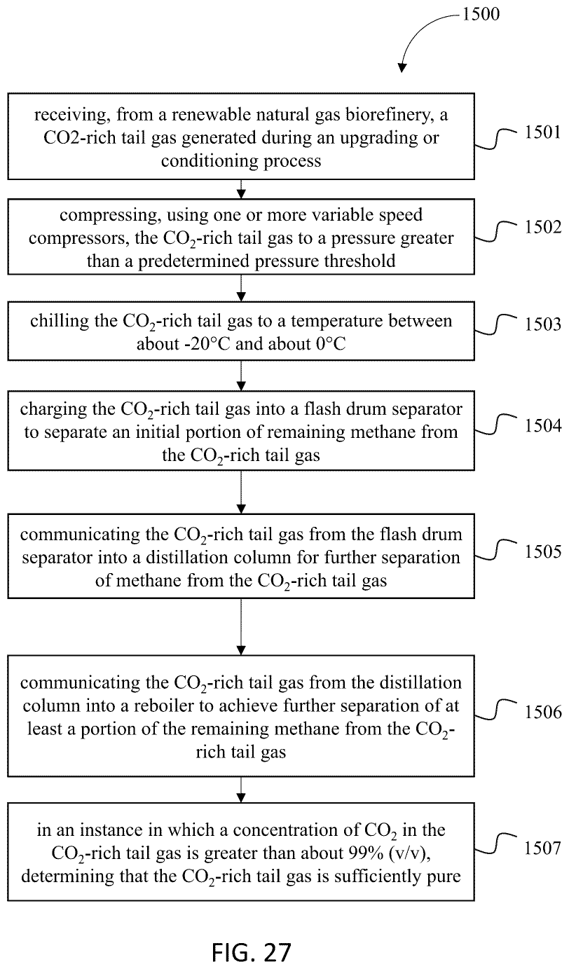

Referring now to FIG. 27, a method 1500 can be carried out to produce high-quality CO₂. In some embodiments, the method 1500 can comprise receiving, from a renewable natural gas biorefinery, a CO₂-rich tail gas generated during an upgrading or conditioning process, at 1501. In some embodiments, the method 1500 can further comprise compressing, using one or more variable speed compressors, the CO₂-rich tail gas to a pressure greater than a predetermined pressure threshold, at 1502. In some embodiments, the method 1500 can further comprise chilling the CO₂-rich tail gas to a temperature between about −20° C. and about 0° C., at 1503. In some embodiments, the method 1500 can further comprise charging the CO₂-rich tail gas into a flash drum separator to separate an initial portion of remaining methane from the CO₂-rich tail gas, at 1504. In some embodiments, the method 1500 can further comprise communicating the CO₂-rich tail gas from the flash drum separator into a distillation column for further separation of methane from the CO₂-rich tail gas, at 1505. In some embodiments, the method 1500 can further comprise communicating the CO₂-rich tail gas from the distillation column into a reboiler to achieve further separation of at least a portion of the remaining methane from the CO₂-rich tail gas, at 1506. In some embodiments, the method 1500 can further comprise in an instance in which a concentration of CO₂ in the CO₂-rich tail gas is greater than about 99% (v/v), determining that the CO₂-rich tail gas is sufficiently pure, at 1507.

In some embodiments, the method 1500 can be carried out by an apparatus or device, such as one comprising, or in communication with, the computing device 1100. For example, the volatile memory 1106 or non-volatile memory 1104 of the computing device 1100 can store instructions (e.g., computer-readable instructions, computer program codes, software, computer program(s), etc.) thereon that are configured, when executed by a processor (e.g., the processing element 1102 of the computing device 1100), to cause the computing device 1100 or an apparatus/system in communication with the computing device 1100, to perform one or more elements or aspects of the method 1500.

As should be appreciated, various embodiments of the present disclosure may also be implemented as methods, apparatuses, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described herein with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for producing high-purity CO₂, the method comprising:
removing, using a coalescence filter, at least a portion of moisture content from a CO₂-comprising gas stream;
compressing the CO₂-comprising gas stream to a first pressure;
reducing a temperature of the CO₂-comprising gas stream to below a predetermined temperature threshold;
removing, using one or more gas scrubbers, from the CO₂-comprising gas stream, one or more contaminants;
compressing the CO₂-comprising gas stream to a second pressure;
removing, using a desiccation system, at least an additional portion of moisture content from the CO₂-comprising gas stream;
compressing the CO₂-comprising gas stream to a third pressure;
reducing the temperature of the CO₂-comprising gas stream to below the predetermined temperature threshold or to below a second predetermined temperature threshold; and
separating, using a distillation column, from the CO₂-comprising gas stream, a CO₂-rich gas stream.

2. The method of claim 1, wherein the predetermined temperature threshold is between about −20° C. and about 0° C.

3. The method of claim 1, wherein the compressing the CO₂-comprising gas stream to one of the first, second, or third pressures comprises:
varying, using one or more variable speed compressors, a compressed flow rate of the CO₂-comprising gas stream based upon one or more of: a mass flow rate of the CO₂-comprising gas stream, a volumetric flow rate of the CO₂-comprising gas stream, a density of the CO₂-comprising gas stream, a temperature of the CO₂-comprising gas stream, a pressure of the CO₂-comprising gas stream, a composition of the CO₂-comprising gas stream, a concentration of CO₂ in the CO₂-comprising gas stream, a concentration of CH₄ in the CO₂-comprising gas stream, or a presence or a concentration of one or more impurities in the CO₂-comprising gas stream.

4. The method of claim 1, further comprising:
filtering, from the CO₂-comprising gas stream, at least a portion of hydrogen sulfide (H₂S) comprised therein.

5. (canceled)

6. The method of claim 1, further comprising:
returning an initial portion of remaining methane separated from the CO₂-comprising gas stream when forming the CO₂-rich gas stream to a product stream or a process stream.

7. The method of claim 1, further comprising:
reducing the temperature of the CO₂-rich gas stream to less than the first temperature threshold, less than the second temperature threshold, or less than a third temperature threshold that is different from the first and second temperature thresholds.

8. The method of claim 1, further comprising:
determining whether the CO₂-rich gas stream has a sufficiently high CO₂ concentration to be provided as a CO₂ product; and
in an instance in which the CO₂-rich gas stream does not have a sufficiently high CO₂ concentration, returning the CO₂-rich gas stream or a portion thereof to a prior operation of the method for producing high-purity CO₂ for further processing or reprocessing.

9. The method of claim 1, wherein the separating the CO₂-rich gas stream from the CO₂-comprising gas stream using the distillation column is performed at a distillation temperature between about −50° C. and about −70° C.

10. The method of claim 1, wherein the CO₂-rich gas stream is food-grade CO₂ or beverage-grade CO₂.

11. The method of claim 1, wherein the CO₂-comprising gas stream comprises at least about 90% CO₂ by volume.

12. The method of claim 1, wherein the CO₂-rich gas stream comprises at least about 99.9% CO₂ by volume.

13. The method of claim 1, wherein the CO₂-comprising tail gas stream comprises at least one of: volatile organic compounds (VOCs), carbonyl sulfide (COS), hydrogen sulfide (H₂S), CH₄, oils, amides, particulates, or moisture.

14. The method of claim 1, wherein a pressure within the distillation column during the separating is maintained below a maximum pressure threshold of between about 300 psi and about 600 psi.

15. A method for producing high-purity carbon dioxide from a CO₂-rich tail gas stream from a renewable natural gas (RNG) biorefinery, the method comprising:
compressing the CO₂-rich tail gas stream to a pressure greater than a predetermined pressure threshold;
reducing a temperature of the CO₂-rich tail gas stream to below a predetermined temperature threshold;
at least partially removing moisture content from the CO₂-rich tail gas stream;
separating, using a flash drum separator, the CO₂-rich tail gas stream into a first recovery stream comprising a first portion of methane (CH₄) from the CO₂-rich tail gas stream and a remainder of the CO₂-rich tail gas stream;
separating, using a distillation column, the remainder of the CO₂-rich tail gas stream into a second recovery stream comprising a second portion of CH₄ from the CO₂-rich tail gas stream and CO₂ bottoms; and
separating, using a reboiler, the CO₂ bottoms into a third recovery stream comprising a third portion of CH₄ from the CO₂-rich tail gas stream and a CO₂ product.

16. The method of claim 15, wherein the predetermined temperature threshold is between about −20° C. and about 0° C.

17. The method of claim 15, wherein the compressing the CO₂-rich tail gas stream comprises:
varying, using one or more variable speed compressors, a compressed flow rate of the CO₂-rich tail gas stream based upon one or more of: a mass flow rate of the CO₂-rich tail gas stream, a volumetric flow rate of the CO₂-rich tail gas stream, a density of the CO₂-rich tail gas stream, a temperature of the CO₂-rich tail gas stream, a pressure of the CO₂-rich tail gas stream, a composition of the CO₂-rich tail gas stream, a concentration of CO₂ in the CO₂-rich tail gas stream, a concentration of CH₄ in the CO₂-rich tail gas stream, or a presence or a concentration of one or more impurities in the CO₂-rich tail gas stream.

18. The method of claim 15, further comprising:
filtering, from the CO₂-rich tail gas stream, hydrogen sulfide (H₂S).

19. (canceled)

20. The method of claim 15, further comprising:
drying or desiccating the CO₂-rich tail gas stream.

21. (canceled)

22. The method of claim 15, further comprising:
reducing a temperature of the CO₂ product to less than the first temperature threshold or a second temperature threshold that is different from the first temperature threshold.

23-31. (canceled)

32. An apparatus configured for producing high-purity carbon dioxide from a CO₂-rich tail gas stream from a renewable natural gas (RNG) biorefinery, the apparatus comprising:
at least one processor; and
at least one memory storing instructions thereon that, when executed by the at least one processor, cause the apparatus to perform at least:
compressing the CO₂-rich tail gas stream to a pressure greater than a predetermined pressure threshold;
reducing a temperature of the CO₂-rich tail gas stream to below a predetermined temperature threshold;
at least partially removing moisture content from the CO₂-rich tail gas stream;
separating, using a flash drum separator, the CO₂-rich tail gas stream into a first recovery stream comprising a first portion of methane (CH₄) from the CO₂-rich tail gas stream and a remainder of the CO₂-rich tail gas stream;
separating, using a distillation column, the remainder of the CO₂-rich tail gas stream into a second recovery stream comprising a second portion of CH₄ from the CO₂-rich tail gas stream and CO₂ bottoms; and
separating, using a reboiler, the CO₂ bottoms into a third recovery stream comprising a third portion of CH₄ from the CO₂-rich tail gas stream and a CO₂ product.

33-190. (canceled)
